(19) United States
(12) Patent Application Publication
(10) Pub. No.: US 2026/0370451 A1
(43) Pub. Date: Nov. 19, 2026

(54) ELECTRONIC APPARATUS FOR HOMOMORPHIC ENCRYPTION-BASED THRESHOLD DIGITAL SIGNATURE, METHOD OF OPERATING THE SAME, AND STORAGE MEDIUM

(71) Applicant: CRYPTO LAB INC., Seoul (KR)

(72) Inventors: Damien Stehle, Seoul (KR); Alain Passelegue, Seoul (KR); Jai Hyun Park, Lyon (FR)

(21) Appl. No.: 19/679,311

(22) Filed: May 15, 2026

(30) Foreign Application Priority Data
May 16, 2025 (KR) 10-2025-0063583
May 13, 2026 (KR) 10-2026-0086673

(51) Int. Cl. H04L 9/00; H04L 9/32

(52) U.S. Cl. CPC H04L 9/008; H04L 9/3247

(57) ABSTRACT

An electronic apparatus including: a communication circuit configured to communicate with at least one external electronic apparatus; processing circuitry; and a memory storing instructions, homomorphically encrypted signature key information, and a partial decryption key, wherein the instructions, when executed individually or collectively by the at least one processor, cause the electronic apparatus to: acquire a first ciphertext corresponding to a commitment by performing a homomorphic operation using the homomorphically encrypted signature key information based on information related to a message to be signed; restore the commitment into plaintext based on a first partial decryption result for the first ciphertext generated based on the partial decryption key and first other partial decryption results received from at least some of the at least one external electronic apparatus through the communication circuit; determine a challenge in a plaintext state based on the restored commitment and the information related to the message; acquire a second ciphertext corresponding to a response through a homomorphic operation based on the challenge determined in the plaintext state and the homomorphically encrypted signature key information; restore the response into plaintext based on a second partial decryption result for the second ciphertext generated based on the partial decryption key and second other partial decryption results received from at least some of the at least one external electronic apparatus through the communication circuit; and generate a signature for the message based on the restored response and the challenge determined in the plaintext state.

### CROSS-REFERENCE TO RELATED APPLICATION(S)

This application claims priority under 35 U.S.C. § 119 to Korean Patent Application No. 10-2025-0063583, filed on May 16, 2025, and Korean Patent Application No. 10-2026-0086673, filed on May 13, 2026 in the Korean Intellectual Property Office, the disclosure of which is incorporated herein by reference in its entirety.

### BACKGROUND

### Field

The present disclosure relates to an electronic apparatus for generating a threshold digital signature for a message through cooperation of participants equal to or greater than a threshold while holding a signature key in a distributed manner among a plurality of participants using a homomorphic encryption technique, a method of operating the same, and a storage medium.

### Description of the Related Art

As communication technologies develop and distribution of electronic apparatuses expands, efforts are continuously being made to maintain communication security between electronic apparatuses. Accordingly, encryption and decryption techniques are used in most communication environments.

As one of encryption techniques, a homomorphic encryption method has recently been actively researched. According to homomorphic encryption, when a result of an operation performed on a ciphertext is decrypted, a value matching a result of a corresponding operation performed on plaintext may be acquired. Accordingly, various operations may be performed in a state in which the ciphertext is not decrypted.

Based on these characteristics, a system for performing homomorphic encryption on data, storing the encrypted data, and retrieving the data in a ciphertext state has been proposed.

### SUMMARY

Embodiments of the present disclosure may solve at least one of the above-described problems and/or disadvantages and may provide advantages described below. Accordingly, the present disclosure provides an electronic apparatus for generating a threshold signature compatible with a verification algorithm of standard Dilithium using a homomorphic encryption technique, a method of operating the same, and a storage medium.

Additional embodiments will be set forth in detailed description provided below, some embodiments will be apparent from detailed description, and other embodiments may also be derived through learning from disclosed embodiments.

According to one or more embodiments of the present disclosure, provided is an electronic apparatus including: a communication circuit configured to communicate with at least one external electronic apparatus; at least one processor including processing circuitry; and a memory storing instructions, homomorphically encrypted signature key information, and a partial decryption key, wherein the instructions, when executed individually or collectively by the at least one processor, cause the electronic apparatus to: acquire a first ciphertext corresponding to a commitment by performing a homomorphic operation using the homomorphically encrypted signature key information based on information related to a message to be signed; restore the commitment into plaintext based on a first partial decryption result for the first ciphertext generated based on the partial decryption key and first other partial decryption results received from at least some of the at least one external electronic apparatus through the communication circuit; determine a challenge in a plaintext state based on the restored commitment and the information related to the message; acquire a second ciphertext corresponding to a response through a homomorphic operation based on the challenge determined in the plaintext state and the homomorphically encrypted signature key information; restore the response into plaintext based on a second partial decryption result for the second ciphertext generated based on the partial decryption key and second other partial decryption results received from at least some of the at least one external electronic apparatus through the communication circuit; and generate a signature for the message based on the restored response and the challenge determined in the plaintext state.

The homomorphically encrypted signature key information may include a homomorphically encrypted pseudo-random function (PRF) key and a homomorphically encrypted secret vector, and the instructions, when executed individually or collectively by the at least one processor, may cause the electronic apparatus to: generate a homomorphically encrypted mask through the homomorphic operation based on the homomorphically encrypted PRF key and the information related to the message; and acquire the first ciphertext corresponding to the commitment based on the homomorphically encrypted mask.

The memory further stores a public matrix, and the instructions, when executed individually or collectively by the at least one processor, may cause the electronic apparatus to: acquire a homomorphically encrypted intermediate value through a homomorphic operation based on the homomorphically encrypted mask and the public matrix; and acquire the first ciphertext corresponding to the commitment by performing a high-bits extraction operation on the homomorphically encrypted intermediate value.

The instructions, when executed individually or collectively by the at least one processor, may cause the electronic apparatus to: perform a homomorphic operation corresponding to a plaintext-ciphertext multiplication between the challenge determined in the plaintext state and the homomorphically encrypted secret vector; and acquire the second ciphertext corresponding to the response based on a result of the homomorphic operation corresponding to the plaintext-ciphertext multiplication and the homomorphically encrypted mask.

The instructions, when executed individually or collectively by the at least one processor, may cause the electronic apparatus to: acquire homomorphically encrypted information corresponding to a plurality of response candidates by performing a plurality of signing attempts in parallel; and acquire the second ciphertext corresponding to the response based on a response candidate satisfying a predetermined condition among the plurality of response candidates.

The instructions, when executed individually or collectively by the at least one processor, may cause the electronic apparatus to: perform an operation corresponding to modular arithmetic by performing a homomorphic operation based on a first homomorphic encryption scheme on the homomorphically encrypted signature key information; and acquire the first ciphertext corresponding to the commitment by converting a result of the homomorphic operation based on the first homomorphic encryption scheme into a form corresponding to a second homomorphic encryption scheme.

The partial decryption key may correspond to one of a plurality of partial decryption keys, the plurality of partial decryption keys may be distributed according to a secret sharing scheme to restore a decryption key for homomorphic encryption based on partial decryption keys equal to or greater than a threshold, and the instructions, when executed individually or collectively by the at least one processor, may cause the electronic apparatus to: restore the commitment or the response into plaintext based on partial decryption results equal to or greater than the threshold.

The instructions, when executed individually or collectively by the at least one processor, may cause the electronic apparatus to: generate at least one of the first partial decryption result and the second partial decryption result based on the partial decryption key and flooding noise.

The instructions, when executed individually or collectively by the at least one processor, may cause the electronic apparatus to: determine the information related to the message before acquiring the message; and acquire the first ciphertext and the first partial decryption result based on the determined information related to the message before acquiring the message.

The instructions, when executed individually or collectively by the at least one processor, may cause the electronic apparatus to: transmit the first partial decryption result to at least some of the at least one external electronic apparatus through the communication circuit; and transmit the second partial decryption result to at least some of the at least one external electronic apparatus through the communication circuit.

According to one or more embodiments of the present disclosure, provided is a method of operating an electronic apparatus, the method including: acquiring a first ciphertext corresponding to a commitment by performing a homomorphic operation using homomorphically encrypted signature key information based on information related to a message to be signed; restoring the commitment into plaintext based on a first partial decryption result for the first ciphertext generated based on a partial decryption key and first other partial decryption results received from at least some of at least one external electronic apparatus; determining a challenge in a plaintext state based on the restored commitment and the information related to the message; acquiring a second ciphertext corresponding to a response through a homomorphic operation based on the challenge determined in the plaintext state and the homomorphically encrypted signature key information; restoring the response into plaintext based on a second partial decryption result for the second ciphertext generated based on the partial decryption key and second other partial decryption results received from at least some of the at least one external electronic apparatus; and generating a signature for the message based on the restored response and the challenge determined in the plaintext state.

The homomorphically encrypted signature key information may include a homomorphically encrypted pseudo-random function (PRF) key and a homomorphically encrypted secret vector, and the acquiring of the first ciphertext corresponding to the commitment may include: generating a homomorphically encrypted mask through the homomorphic operation based on the homomorphically encrypted PRF key and the information related to the message; and acquiring the first ciphertext corresponding to the commitment based on the homomorphically encrypted mask.

The acquiring of the first ciphertext corresponding to the commitment may include: acquiring a homomorphically encrypted intermediate value through a homomorphic operation based on the homomorphically encrypted mask and a public matrix; and acquiring the first ciphertext corresponding to the commitment by performing a high-bits extraction operation on the homomorphically encrypted intermediate value.

The acquiring of the second ciphertext corresponding to the response may include: performing a homomorphic operation corresponding to a plaintext-ciphertext multiplication between the challenge determined in the plaintext state and the homomorphically encrypted secret vector; and acquiring the second ciphertext corresponding to the response based on a result of the homomorphic operation corresponding to the plaintext-ciphertext multiplication and the homomorphically encrypted mask.

The acquiring of the second ciphertext corresponding to the response may include: acquiring homomorphically encrypted information corresponding to a plurality of response candidates by performing a plurality of signing attempts in parallel; and acquiring the second ciphertext corresponding to the response based on a response candidate satisfying a predetermined condition among the plurality of response candidates.

According to one or more embodiments of the present disclosure, provided is a non-transitory computer-readable medium storing instructions, when executed by at least one processor of an electronic apparatus, causing the electronic apparatus to perform operations, wherein the operations include: acquiring a first ciphertext corresponding to a commitment by performing a homomorphic operation using homomorphically encrypted signature key information based on information related to a message to be signed; restoring the commitment into plaintext based on a first partial decryption result for the first ciphertext generated based on a partial decryption key and first other partial decryption results received from at least some of at least one external electronic apparatus; determining a challenge in a plaintext state based on the restored commitment and the information related to the message; acquiring a second ciphertext corresponding to a response through a homomorphic operation based on the challenge determined in the plaintext state and the homomorphically encrypted signature key information; restoring the response into plaintext based on a second partial decryption result for the second ciphertext generated based on the partial decryption key and second other partial decryption results received from at least some of the at least one external electronic apparatus; and generating a signature for the message based on the restored response and the challenge determined in the plaintext state.

### BRIEF DESCRIPTION OF THE DRAWING FIGURES

A more detailed description of embodiments according to the present disclosure and other aspects, features, and effects will become more apparent from the following description provided with reference to the accompanying drawings:

FIG. 1 is a diagram illustrating a structure of a network system according to one or more embodiments of the present disclosure;

FIG. 2 is a block diagram illustrating a configuration of an electronic apparatus according to at least one embodiment of the present disclosure;

FIG. 3 is a flowchart illustrating a method of operating an electronic apparatus according to one or more embodiments of the present disclosure;

FIG. 4 is a flowchart illustrating a method of acquiring a first ciphertext corresponding to a commitment according to one or more embodiments of the present disclosure;

FIG. 5 is a flowchart illustrating a method of acquiring a first ciphertext corresponding to a commitment according to one or more embodiments of the present disclosure;

FIG. 6 is a flowchart illustrating a method of acquiring the second ciphertext corresponding to a response according to one or more embodiments of the present disclosure;

FIG. 7 is a flowchart illustrating a method of acquiring the second ciphertext corresponding to a response according to one or more embodiments of the present disclosure;

FIG. 8 is a flowchart illustrating a method of acquiring a first ciphertext corresponding to a commitment according to one or more embodiments of the present disclosure;

FIG. 9 is a flowchart illustrating an operation of the electronic apparatus according to one or more embodiments of the present disclosure;

FIG. 10 is a flowchart illustrating an operation of the electronic apparatus according to one or more embodiments of the present disclosure;

FIG. 11 is a block diagram illustrating a configuration of an electronic apparatus according to at least one embodiment of the present disclosure;

FIG. 12 is a diagram illustrating an operation of a threshold signature protocol according to one or more embodiments of the present disclosure; and

FIG. 13 is a diagram illustrating an error distribution before threshold decryption according to one or more embodiments of the present disclosure.

### MODE FOR INVENTION

Hereinafter, the present disclosure will be described in detail with reference to the accompanying drawings. An encryption/decryption process may be applied to an information (data) transmission process performed in the present disclosure as necessary, and expressions for describing the information (data) transmission process in the present disclosure and claims should be interpreted as including a case of performing encryption/decryption even when encryption/decryption is not separately mentioned. In the present disclosure, an expression in a form such as “transmitting (delivering) from A to B” or “A receiving from B” includes a case in which transmission (delivery) or reception is performed with another medium interposed therebetween, and does not indicate only direct transmission (delivery) or reception from A to B.

In describing the present disclosure, an order of respective steps should be understood as non-restrictive unless a preceding step in the order of respective steps needs to logically and temporally precede a subsequent step. That is, except for the above exceptional case, the essence of the present disclosure is not affected even when a process described as the subsequent step is performed before a process described as the preceding step, and the scope of the present disclosure should also be defined regardless of the order of the steps. In addition, in the specification, “A or B” may be defined as indicating not only selectively indicating either A or B, but also including both A and B. In addition, a term “including” in the present disclosure may encompass a concept of further including other components in addition to components listed as being included.

The present disclosure only describes essential components necessary for describing the present disclosure, and does not mention components unrelated to the essence of the present disclosure. In addition, it should not be interpreted as an exclusive concept that the present disclosure includes only the mentioned components, and should be interpreted as a non-exclusive concept that the present disclosure may include other components as well.

In addition, in the present disclosure, a “value” is defined as a concept including not only a scalar value but also a vector. In addition, in the present disclosure, expressions such as “derive” and “calculate” may be replaced by an expression indicating generating a result of the corresponding deriving or calculating. In addition, unless otherwise indicated, an operation on ciphertext described below refers to a homomorphic operation. For example, addition on homomorphic ciphertext refers to homomorphic addition on two homomorphic ciphertexts.

Mathematical operations and derivations in respective steps of the present disclosure described below may be implemented as computer operations by a publicly known coding method and/or coding designed to be suitable for the present disclosure to perform the corresponding operation or derivation.

Specific mathematical expressions described below are illustratively provided among various available alternatives, and the scope of the present disclosure should not be interpreted as being limited to the mathematical expressions mentioned in the present disclosure.

For convenience of description, notation is defined in the present disclosure as follows.
a←D: Select an element a based on distribution D.
s₁, s₂∈R: Each of s₁ and s₂ is an element belonging to a set R.
mod(q): Perform a modular operation with respect to an element q.
└⋅┐: Round an internal value.

Hereinafter, various embodiments of the present disclosure are described in detail with reference to the accompanying drawings.

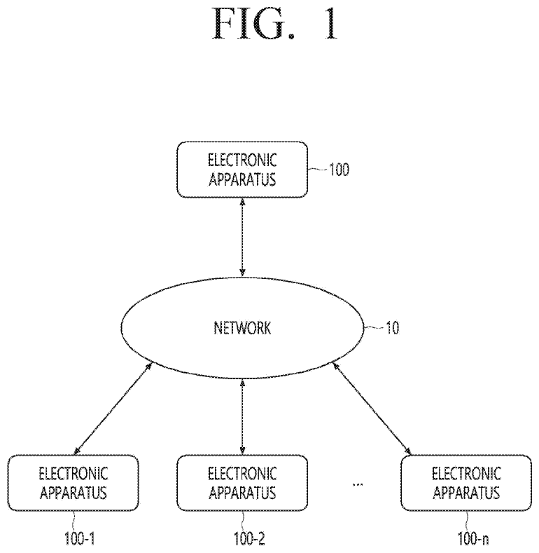

FIG. 1 is a diagram illustrating a structure of a network system according to one or more embodiments of the present disclosure.

Referring to FIG. 1, the network system may include a plurality of electronic apparatuses 100, 100-1, 100-2, . . . , 100-n, and respective components may be connected to each other through a network 10.

The network 10 may be implemented as various types of wired/wireless communication networks, broadcast communication networks, optical communication networks, cloud networks, and the like. Although FIG. 1 illustrates a state in which the respective electronic apparatuses 100, 100-1, 100-2, . . . , 100-n are indirectly connected to each other through the network 10, the present disclosure is not limited thereto, and the respective apparatuses may also be directly connected to each other using a method such as wireless fidelity (Wi-Fi), Bluetooth, and near field communication (NFC) without separate medium.

The electronic apparatuses 100, 100-1, 100-2, . . . , 100-n may be apparatuses participating in a threshold digital signature (or, a threshold signature) according to the present disclosure, and may be apparatuses for cooperatively generating a signature for a message using a homomorphic encryption technique. The electronic apparatuses 100, 100-1, 100-2, . . . , 100-n may be implemented in various forms such as a personal computer (PC), a laptop PC, a smartphone, a tablet PC, a server apparatus, a cloud server, and a kiosk, may be implemented as a single apparatus, or may be implemented through cooperation of a plurality of apparatuses. In addition, the electronic apparatuses 100, 100-1, 100-2, . . . , 100-n may each be implemented in a form of a home appliance to which an internet of things (IoT) function is applied, or may be another server apparatus.

Although FIG. 1 illustrates the electronic apparatus 100 and the other electronic apparatuses 100-1, 100-2, . . . , 100-n separately, such separation is intended for convenience of description, and the respective electronic apparatuses 100, 100-1, 100-2, . . . , 100-n in the network system according to the present disclosure may correspond to threshold signing participants having an equal status. That is, any one electronic apparatus may become a subject of the operating method according to the present disclosure, and in describing the present disclosure, the other electronic apparatuses 100-1, 100-2, . . . , 100-n may be referred to as external electronic apparatuses (or external apparatuses) from a viewpoint of the electronic apparatus 100. In addition, from another viewpoint, the electronic apparatus 100 may also be described as an external electronic apparatus.

The plurality of electronic apparatuses 100, 100-1, 100-2, . . . , 100-n may generate or receive distribution of various keys related to processing of a homomorphic ciphertext (e.g., a secret key, a public key, and an operation key), and may perform a threshold signature operation using a homomorphic encryption scheme.

Here, homomorphic encryption refers to an encryption scheme for converting plaintext into ciphertext while allowing a specific operation on ciphertexts to match a result of a corresponding operation on plaintexts. For example, homomorphic encryption may be referred to as Cheon-Kim-Kim-Song (CKKS) encryption, Brakerski-Fan-Vercauteren (BFV) encryption, Brakerski-Gentry-Vaikuntanathan (BGV) encryption, or the like.

Here, a homomorphic ciphertext refers to a ciphertext generated by encrypting plaintext data (e.g., an integer, a real number, or a vector value) according to the homomorphic encryption scheme, and when an operation result in a ciphertext state is decrypted, a value corresponding to a result of a corresponding operation in a plaintext state may be acquired.

Here, a secret key refers to a private key used for decrypting a homomorphic ciphertext. A public key is a key generated corresponding to the above-described secret key, and is a key used for generating a homomorphic ciphertext. An operation key is an evaluation key used for performing a homomorphic operation, such as rotation or relinearization, in a homomorphic ciphertext state.

In addition, the network system according to the present disclosure may use a Threshold Fully Homomorphic Encryption (ThFHE) scheme. According to the ThFHE scheme, a decryption authority for a homomorphic ciphertext may be distributed to the plurality of electronic apparatuses 100, 100-1, 100-2, . . . , 100-n. That is, a decryption key for homomorphic encryption may be distributed to the plurality of electronic apparatuses 100, 100-1, 100-2, . . . , 100-n according to a secret sharing scheme to restore the decryption key for homomorphic encryption based on partial decryption keys equal to or greater than a threshold. Accordingly, the homomorphic ciphertext may be decrypted only when electronic apparatuses equal to or greater than the threshold cooperate with each other.

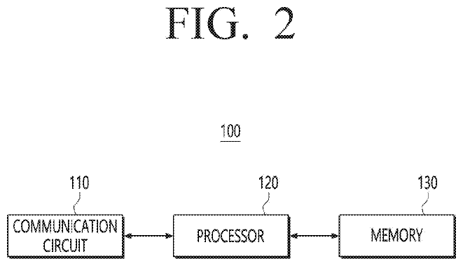

FIG. 2 is a block diagram illustrating a configuration of the electronic apparatus according to at least one embodiment of the present disclosure.

Referring to FIG. 2, the electronic apparatus 100 may include a communication circuit 110, a processor 120, and a memory 130.

The communication circuit 110 is a component for performing communication with various external electronic apparatuses including an external electronic apparatus (e.g., the external electronic apparatuses 100-1, 100-2, . . . , 100-n illustrated in FIG. 1).

The communication circuit 110 may transmit and receive various signals and data to and from external electronic apparatuses using various wired/wireless communication schemes such as wired/wireless local area network (LAN), wide area network (WAN), Ethernet, IEEE 1394, Bluetooth, access point (AP)-based wireless fidelity (Wi-Fi), Zigbee, high-definition multimedia interface (HDMI), universal serial bus (USB), mobile high-definition link (MHL), Audio Engineering Society/European Broadcasting Union (AES/EBU), optical communication, and coaxial communication.

For example, the communication circuit 110 may receive a partial decryption result, a homomorphic ciphertext, and various keys from the external electronic apparatuses 100-1, 100-2, . . . , 100-n illustrated in FIG. 1, and may transmit a partial decryption result generated by the electronic apparatus 100 to the external electronic apparatuses 100-1, 100-2, . . . , 100-n.

The processor 120 is a component for controlling an overall operation of the electronic apparatus 100. The processor 120 may perform various operations based on instructions, programs, data, and the like stored in the memory 130.

The processor 120 may be implemented as a digital signal processor (DSP) processing a digital signal, or a microprocessor. However, the present disclosure is not limited thereto, and the processor 120 may include at least one of a central processing unit (CPU), a micro controller unit (MCU), a micro processing unit (MPU), a controller, an application processor (AP), a communication processor (CP), an advanced RISC machines (ARM) processor, a graphic processing unit (GPU), a neural processing unit (NPU), or an artificial intelligence (AI) processor, or may be defined by a corresponding term. In addition, the processor 120 may be implemented as a system on chip (SoC) having a processing algorithm embedded therein, a large scale integration (LSI), or a field programmable gate array (FPGA).

A central processing unit (CPU) is a general-purpose processor capable of performing not only general operations but also artificial intelligence operations, and may efficiently execute a complex program through a multi-layer cache structure. A central processing unit (CPU) is advantageous for a serial processing scheme enabling an organic connection between a previous calculation result and a next calculation result using sequential calculations.

A GPU is a processor for large-scale operations such as floating-point operations used for graphic processing, and may perform large-scale operations in parallel by integrating a large number of cores. In particular, a GPU may be advantageous for a parallel processing scheme such as a convolution operation compared to a CPU. In addition, a GPU may be used as a co-processor for supplementing a function of a CPU. According to an example, a GPU may be used when performing a homomorphic operation by the electronic apparatus 100 according to the present disclosure, thereby improving a processing speed of the homomorphic operation.

An NPU is a processor specialized for artificial intelligence operations using an artificial neural network, and may implement respective layers included in the artificial neural network as hardware (e.g., silicon). Here, although the NPU is specially designed according to a required specification of a company, and thus has lower flexibility compared to a CPU or GPU, the NPU may efficiently process artificial intelligence operations required by the company. As a processor specialized for artificial intelligence operations, the NPU may be implemented in various forms such as a tensor processing unit (TPU), an intelligence processing unit (IPU), and a vision processing unit (VPU). An artificial intelligence processor is not limited to the above-described examples except for a case in which the artificial intelligence processor is explicitly indicated as the above-described NPU.

In addition, the processor 120 may be implemented as a system on chip (SoC). Here, the SoC may include not only one or more processors 120 but also the memory 130, and may further include a bus for data communication between the memory 130 and the processor 120.

The memory 130 is a component for storing various programs, data, instructions, and the like required for an operation of the electronic apparatus 100. The memory 130 may be implemented as at least one of a dynamic RAM (DRAM), a static RAM (SRAM), a synchronous dynamic RAM (SDRAM), a one-time programmable ROM (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD).

The memory 130 may store various homomorphic ciphertexts received through the communication circuit 110, and operation keys, switching keys, public keys, and the like used for operations therefor. In addition, the memory 130 may store various mathematical expressions, instructions, and the like required for generating a secret key and a public key.

In addition, the memory 130 may store information for the threshold signature according to the present disclosure. According to an example, the memory 130 may store homomorphically encrypted signature key information and a partial decryption key.

Here, the homomorphically encrypted signature key information may refer to information generated by encrypting information corresponding to a signature key of standard Dilithium according to the homomorphic encryption scheme. According to an example, the homomorphically encrypted signature key information may include a homomorphically encrypted pseudo-random function (PRF) key and a homomorphically encrypted secret vector. In addition, the memory 130 may store a public matrix corresponding to a verification key of standard Dilithium.

Here, the partial decryption key may refer to one of fragments acquired by dividing a decryption key for homomorphic encryption according to the secret sharing scheme. According to an example, the partial decryption key may correspond to one of a plurality of partial decryption keys, and the plurality of partial decryption keys may be distributed according to the secret sharing scheme to restore the decryption key for homomorphic encryption based on partial decryption keys equal to or greater than a threshold.

According to one or more embodiments, the processor 120 may acquire a first ciphertext corresponding to a commitment by performing a homomorphic operation using homomorphically encrypted signature key information based on information related to a message to be signed.

Here, the message to be signed may refer to a message to be signed by the threshold signature according to the present disclosure. According to an example, the message to be signed may be a message received from an external electronic apparatus, or may be a message generated by the electronic apparatus 100. The information related to the message is information determined based on the message to be signed, and according to an example, may be a result value acquired by applying a hash function to the message.

Here, the commitment is an intermediate output used in a threshold signature operation according to the present disclosure, and may be information corresponding to a commitment of a standard Dilithium signature algorithm.

According to an example, the processor 120 may generate a homomorphically encrypted mask through a homomorphic operation based on the homomorphically encrypted PRF key and the information related to the message, and may acquire the first ciphertext corresponding to the commitment based on the homomorphically encrypted mask. Here, the mask may be information corresponding to a random value for concealing a secret key in the standard Dilithium signature algorithm.

According to an example, the processor 120 may acquire a homomorphically encrypted intermediate value through a homomorphic operation based on the homomorphically encrypted mask and the public matrix, and may acquire the first ciphertext corresponding to the commitment by performing a high-bits extraction operation on the homomorphically encrypted intermediate value.

According to an example, the processor 120 may use a plurality of homomorphic encryption schemes in combination during a homomorphic operation process. For example, the processor 120 may perform an operation corresponding to modular arithmetic by performing a homomorphic operation based on a BFV homomorphic encryption scheme on homomorphically encrypted signature key information, and may acquire the first ciphertext corresponding to the commitment by converting a result of the homomorphic operation based on the BFV homomorphic encryption scheme into a form corresponding to a CKKS homomorphic encryption scheme.

According to one or more embodiments, the processor 120 may restore the commitment into plaintext based on a first partial decryption result for the first ciphertext generated based on a partial decryption key and first other partial decryption results received from at least some of at least one external electronic apparatus through the communication circuit 110.

Here, the first partial decryption result may refer to a result acquired by partially decrypting the first ciphertext using the partial decryption key stored in the electronic apparatus 100. According to an example, the processor 120 may generate the first partial decryption result based on the partial decryption key and flooding noise.

Here, the first other partial decryption result is a result acquired by partially decrypting the first ciphertext using a partial decryption key stored in at least some of external electronic apparatuses (e.g., at least some of the external electronic apparatuses 100-1, 100-2, . . . , 100-n illustrated in FIG. 1), and may be received from the external electronic apparatuses through the communication circuit 110.

According to an example, the processor 120 may also transmit the first partial decryption result to at least some of at least one external electronic apparatus through the communication circuit 110. That is, the electronic apparatus 100 and the external electronic apparatuses 100-1, 100-2, . . . , 100-n may cooperatively restore the commitment into plaintext by transmitting and receiving partial decryption results to and from each other.

According to an example, the processor 120 may restore the commitment into plaintext based on partial decryption results equal to or greater than a threshold (i.e., the first partial decryption result and first other partial decryption results received from external electronic apparatuses equal to or greater than the threshold). That is, the commitment is incapable of being restored into plaintext only with partial decryption results less than the threshold.

According to one or more embodiments, the processor 120 may determine a challenge in a plaintext state based on the restored commitment and the information related to the message.

Here, the challenge is information used in the threshold signature operation according to the present disclosure, and may be information corresponding to a challenge of the standard Dilithium signature algorithm.

According to an example, the processor 120 may determine the challenge by applying a hash function to the information related to the message and the commitment restored in a plaintext state. As an example, the processor 120 may determine the challenge by applying a security hash algorithm-based hash function to a value acquired by combining the information related to the message with the restored commitment, and then applying a challenge sampling function thereto.

According to the present disclosure, the processor 120 may not evaluate a hash function in a homomorphic operation region by determining the challenge in the plaintext state. Accordingly, inefficiency caused by homomorphic evaluation of the hash function may be avoided.

According to one or more embodiments, the processor 120 may acquire a second ciphertext corresponding to a response through a homomorphic operation based on the challenge determined in the plaintext state and the homomorphically encrypted signature key information.

Here, the response is information used in the threshold signature operation according to the present disclosure, and may be information corresponding to a response of the standard Dilithium signature algorithm.

According to an example, the processor 120 may perform a homomorphic operation corresponding to a plaintext-ciphertext multiplication between the challenge determined in the plaintext state and a homomorphically encrypted secret vector, and may acquire the second ciphertext corresponding to the response based on a result of the homomorphic operation corresponding to the plaintext-ciphertext multiplication and a homomorphically encrypted mask.

According to the present disclosure, as the challenge is in the plaintext state, the homomorphic operation may be performed in a form of plaintext-ciphertext multiplication. The plaintext-ciphertext multiplication may be performed more efficiently than ciphertext-ciphertext multiplication, thereby improving a processing speed of a threshold signature scheme according to the present disclosure.

According to an example, the processor 120 may acquire homomorphically encrypted information corresponding to a plurality of response candidates by performing a plurality of signing attempts in parallel, and may also acquire the second ciphertext corresponding to the response based on a response candidate satisfying a predetermined condition among the plurality of response candidates. Here, the predetermined condition may be a condition corresponding to a rejection sampling condition of the standard Dilithium signature algorithm.

According to one or more embodiments, the processor 120 may restore the response into plaintext based on a second partial decryption result for the second ciphertext generated based on the partial decryption key and second other partial decryption results received from at least some of at least one external electronic apparatus through the communication circuit 110.

Here, the second partial decryption result may refer to a result acquired by partially decrypting the second ciphertext using the partial decryption key stored in the electronic apparatus 100. According to an example, the processor 120 may generate the second partial decryption result based on the partial decryption key and flooding noise.

Here, the second other partial decryption result is a result acquired by partially decrypting the second ciphertext using a partial decryption key stored in the external electronic apparatus, and may be received from the external electronic apparatus through the communication circuit 110.

According to an example, the processor 120 may transmit the second partial decryption result to at least some of at least one external electronic apparatus through the communication circuit 110.

According to one or more embodiments, the processor 120 may generate a signature for the message based on the restored response and the challenge determined in the plaintext state.

Here, the signature is a result of the threshold signature operation according to the present disclosure, and may be information corresponding to a signature of the standard Dilithium signature algorithm. According to an example, the processor 120 may generate the signature based on the restored response, the challenge determined in the plaintext state, and a hint vector.

The signature generated according to the present disclosure may be recognized as a valid signature by a verification algorithm of standard Dilithium. That is, the threshold signature scheme according to the present disclosure may satisfy verification interchangeability with standard Dilithium.

According to an example, the processor 120 may perform a part of the threshold signature operation according to the present disclosure in advance before a message arrives. For example, the processor 120 may determine the information related to the message before acquiring the message, and may acquire the first ciphertext and the first partial decryption result based on the determined information related to the message before acquiring the message. Accordingly, processing time in an online phase after the message arrives may be significantly reduced.

According to the above-described example, the electronic apparatus 100 may generate a threshold signature compatible with a verification algorithm of standard Dilithium using a homomorphic encryption technique. In addition, the electronic apparatus 100 may generate the threshold signature through only two communication rounds, thereby achieving excellent communication efficiency.

In addition, according to the above-described example, the electronic apparatus 100 may avoid evaluation of a hash function in a homomorphic operation region by restoring the commitment into plaintext and then determining the challenge in the plaintext state. Accordingly, time required for generating the threshold signature may be reduced.

In addition, according to the above-described example, the electronic apparatus 100 may perform the threshold signature operation according to the present disclosure by separating the threshold signature operation into an offline phase independent of the message and an online phase dependent on the message. Accordingly, processing time in the online phase after the message arrives may be reduced.

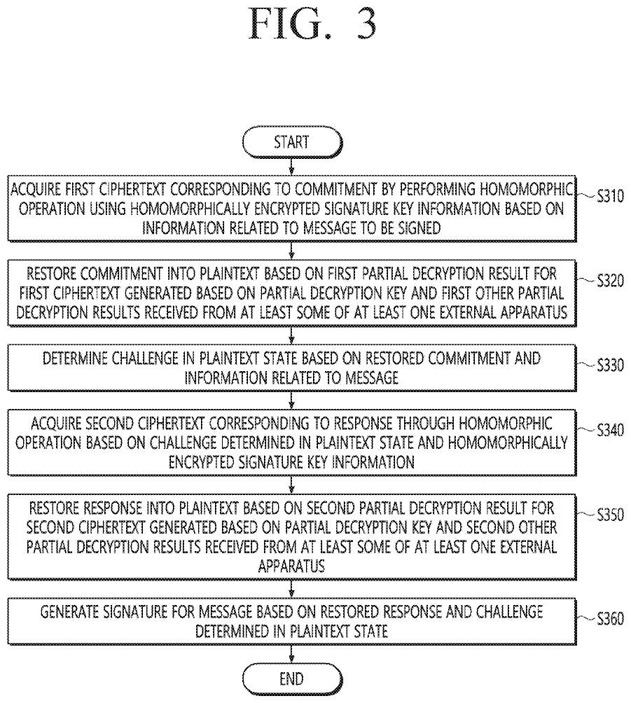

FIG. 3 is a flowchart illustrating an operation of the electronic apparatus according to one or more embodiments of the present disclosure.

Referring to FIG. 3, an operating method according to one or more embodiments may include acquiring a first ciphertext corresponding to a commitment by performing a homomorphic operation using homomorphically encrypted signature key information based on information related to a message to be signed (S310).

According to an example, the electronic apparatus 100 may perform a homomorphic operation based on the information related to the message to be signed using homomorphically encrypted signature key information stored in a memory (e.g., the memory 130 illustrated in FIG. 2). The electronic apparatus 100 may acquire a first ciphertext corresponding to the commitment through the homomorphic operation.

Here, the homomorphically encrypted signature key information may refer to information generated by encrypting information corresponding to a signature key of standard Dilithium according to the homomorphic encryption scheme. According to an example, the homomorphically encrypted signature key information may include a homomorphically encrypted pseudo-random function (PRF) key and a homomorphically encrypted secret vector.

Here, the information related to the message may refer to information determined based on the message to be signed. According to an example, the information related to the message may be a result value acquired by applying a hash function to the message.

Here, the commitment is an intermediate output used in a threshold signature operation according to the present disclosure, and may be information corresponding to a commitment of the standard Dilithium signature algorithm.

For example, the electronic apparatus 100 may generate a homomorphically encrypted mask through the homomorphic operation based on a homomorphically encrypted PRF key and the information related to the message, and may acquire the first ciphertext corresponding to the commitment based on the homomorphically encrypted mask. As an example, the electronic apparatus 100 may acquire a homomorphically encrypted intermediate value through a homomorphic operation based on the homomorphically encrypted mask and a public matrix, and may acquire the first ciphertext corresponding to the commitment by performing a high-bits extraction operation on the homomorphically encrypted intermediate value.

The operating method according to one or more embodiments may include restoring the commitment into plaintext based on a first partial decryption result for the first ciphertext generated based on a partial decryption key and first other partial decryption results received from at least some of at least one external electronic apparatus (S320).

According to an example, the electronic apparatus 100 may generate the first partial decryption result for the first ciphertext based on the partial decryption key stored in the memory. In addition, the electronic apparatus 100 may receive the first other partial decryption results from at least some of at least one external electronic apparatus (e.g., the external electronic apparatuses 100-1, 100-2, . . . , 100-n illustrated in FIG. 1) through a communication circuit (e.g., the communication circuit 110 illustrated in FIG. 2). The electronic apparatus 100 may restore the commitment into plaintext by combining the first partial decryption result with the first other partial decryption result.

Here, the partial decryption key may refer to one of fragments acquired by dividing a decryption key for homomorphic encryption according to the secret sharing scheme. According to an example, the partial decryption key may correspond to one of a plurality of partial decryption keys, and the plurality of partial decryption keys may be distributed according to the secret sharing scheme to restore the decryption key for homomorphic encryption based on partial decryption keys equal to or greater than a threshold.

Here, the first partial decryption result may refer to a result acquired by partially decrypting the first ciphertext using the partial decryption key stored in the electronic apparatus 100. According to an example, the electronic apparatus 100 may generate the first partial decryption result based on the partial decryption key and flooding noise.

Here, the first other partial decryption result may refer to a result acquired by partially decrypting the first ciphertext using a partial decryption key stored in an external electronic apparatus.

According to an example, the electronic apparatus 100 may restore the commitment into plaintext based on partial decryption results equal to or greater than a threshold (i.e., the first partial decryption result and first other partial decryption results received from external electronic apparatuses equal to or greater than the threshold). That is, the commitment is incapable of being restored into plaintext only with partial decryption results less than the threshold.

According to an example, the electronic apparatus 100 may transmit the first partial decryption result to at least some of at least one external electronic apparatus through the communication circuit. That is, the electronic apparatus 100 and the external electronic apparatuses may cooperatively restore the commitment into plaintext by transmitting and receiving partial decryption results to and from each other.

The operating method according to one or more embodiments may include determining a challenge in a plaintext state based on the restored commitment and the information related to the message (S330).

According to an example, the electronic apparatus 100 may determine the challenge based on the commitment restored in the plaintext state and the information related to the message. As an example, the electronic apparatus 100 may determine the challenge by applying a security hash algorithm-based hash function to a value acquired by combining the information related to the message with the restored commitment, and then applying a challenge sampling function thereto.

Here, the challenge is information used in the threshold signature operation according to the present disclosure, and may be information corresponding to a challenge of the standard Dilithium signature algorithm.

According to the present disclosure, the electronic apparatus 100 may not evaluate a hash function in a homomorphic operation region by determining the challenge in the plaintext state. Accordingly, inefficiency caused by homomorphic evaluation of the hash function may be avoided.

The operating method according to one or more embodiments may include acquiring a second ciphertext corresponding to a response through a homomorphic operation based on the challenge determined in the plaintext state and homomorphically encrypted signature key information (S340).

According to an example, the electronic apparatus 100 may acquire the second ciphertext corresponding to the response by performing a homomorphic operation based on the challenge determined in the plaintext state and the homomorphically encrypted signature key information.

Here, the response is information used in the threshold signature operation according to the present disclosure, and may be information corresponding to a response of the standard Dilithium signature algorithm.

For example, the electronic apparatus 100 may perform a homomorphic operation corresponding to a plaintext-ciphertext multiplication between the challenge determined in the plaintext state and the homomorphically encrypted secret vector, and may acquire the second ciphertext corresponding to the response based on a result of the homomorphic operation corresponding to the plaintext-ciphertext multiplication and the homomorphically encrypted mask.

According to the present disclosure, as the challenge is in the plaintext state, the homomorphic operation may be performed in a form of plaintext-ciphertext multiplication. The plaintext-ciphertext multiplication may be performed more efficiently than ciphertext-ciphertext multiplication, thereby improving a processing speed of the threshold signature scheme according to the present disclosure.

According to an example, the electronic apparatus 100 may acquire homomorphically encrypted information corresponding to a plurality of response candidates by performing a plurality of signing attempts in parallel, and may also acquire the second ciphertext corresponding to the response based on a response candidate satisfying a predetermined condition among the plurality of response candidates. Here, the predetermined condition may be a condition corresponding to a rejection sampling condition of the standard Dilithium signature algorithm.

The operating method according to one or more embodiments may include restoring the response into plaintext based on a second partial decryption result for the second ciphertext generated based on a partial decryption key and second other partial decryption results received from at least some of at least one external electronic apparatus (S350).

According to an example, the electronic apparatus 100 may generate the second partial decryption result for the second ciphertext based on the partial decryption key stored in the memory. In addition, the electronic apparatus 100 may receive the second other partial decryption results from at least some of at least one external electronic apparatus through the communication circuit. The electronic apparatus 100 may restore the response into plaintext by combining the second partial decryption result with the second other partial decryption result.

Here, the second partial decryption result may refer to a result acquired by partially decrypting the second ciphertext using the partial decryption key stored in the electronic apparatus 100. According to an example, the electronic apparatus 100 may generate the second partial decryption result based on the partial decryption key and flooding noise.

Here, the second other partial decryption result may refer to a result acquired by partially decrypting the second ciphertext using a partial decryption key stored in an external electronic apparatus.

According to an example, the electronic apparatus 100 may transmit the second partial decryption result to at least some of at least one external electronic apparatus through the communication circuit.

The operating method according to one or more embodiments may include generating a signature for the message based on the restored response and the challenge determined in the plaintext state (S360).

According to an example, the electronic apparatus 100 may generate the signature for the message to be signed based on the response restored in the plaintext state and the challenge determined in the plaintext state.

Here, the signature is a result of the threshold signature operation according to the present disclosure, and may be information corresponding to a signature of the standard Dilithium signature algorithm. According to an example, the electronic apparatus 100 may generate the signature based on the restored response, the challenge determined in the plaintext state, and a hint vector.

The signature generated according to the present disclosure may be recognized as a valid signature by a verification algorithm of standard Dilithium. That is, the threshold signature scheme according to the present disclosure may satisfy verification interchangeability with standard Dilithium.

According to the above-described example, the electronic apparatus 100 may generate the threshold signature through only two communication rounds (i.e., transmission and reception of the first partial decryption result and transmission and reception of the second partial decryption result). Accordingly, the threshold signature scheme according to the present disclosure may achieve excellent communication efficiency.

In addition, according to the above-described example, the electronic apparatus 100 may avoid evaluation of a hash function in a homomorphic operation region by restoring the commitment into plaintext and then determining the challenge in the plaintext state. Accordingly, time required for generating the threshold signature may be reduced.

In addition, according to the above-described example, the threshold signature scheme according to the present disclosure may generate a signature compatible with the verification algorithm of standard Dilithium, thereby achieving a security advantage of the threshold signature without changing a verification environment of standard Dilithium.

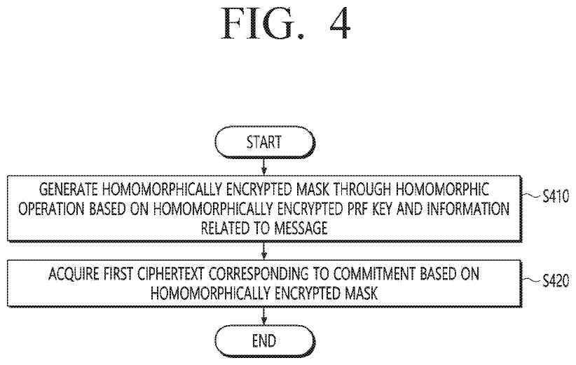

FIG. 4 is a flowchart illustrating a method of acquiring the first ciphertext corresponding to the commitment according to one or more embodiments of the present disclosure.

Referring to FIG. 4, the operating method according to one or more embodiments may include generating a homomorphically encrypted mask through the homomorphic operation based on a homomorphically encrypted pseudo-random function (PRF) key and information related to a message (S410).

According to an example, the electronic apparatus 100 may generate the homomorphically encrypted mask by performing a homomorphic operation based on the homomorphically encrypted PRF key and the information related to the message stored in a memory (e.g., the memory 130 illustrated in FIG. 2).

Here, the homomorphically encrypted PRF key may refer to information generated by encrypting a key used for a pseudo-random function (PRF) according to the homomorphic encryption scheme. The pseudo-random function is a function for generating a pseudo-random output for an input, and according to an example, may be a function for outputting a pseudo-random bit string by applying a key to an input value.

According to an example, the homomorphically encrypted PRF key may be information generated by encrypting a key used for a homomorphic-friendly PRF according to the homomorphic encryption scheme. The homomorphic-friendly PRF may refer to a pseudo-random function designed for efficient evaluation in a homomorphic operation region. For example, the homomorphic-friendly PRF may include a Darkmatter PRF based on a Learning-With-Rounding assumption.

According to the present disclosure, the electronic apparatus 100 may use the homomorphic-friendly PRF instead of a security hash algorithm-based pseudo-random function used for mask generation in the standard Dilithium signature algorithm. Accordingly, efficiency of pseudo-random function evaluation in a homomorphic operation region may be improved.

Here, the information related to the message may refer to information determined based on the message to be signed. According to an example, the information related to the message may be a result value acquired by applying a hash function to the message. As an example, the information related to the message may be a result value acquired by applying a security hash algorithm-based hash function to the message, and may be determined as the same value among a plurality of electronic apparatuses participating in the threshold signature according to the present disclosure.

Here, the homomorphically encrypted mask may refer to information generated by encrypting information corresponding to a random value for concealing a secret key in the standard Dilithium signature algorithm according to the homomorphic encryption scheme. The mask is a random value used for being combined with the secret key to prevent information of the secret key from being exposed.

For example, the electronic apparatus 100 may generate the homomorphically encrypted mask by multiplying the information related to the message by the homomorphically encrypted PRF key according to a predetermined homomorphic operation expression, and then performing a modular reduction operation and a rounding operation on a result thereof. As an example, the electronic apparatus 100 may generate the homomorphically encrypted mask by performing multiplication between the information related to the message and the homomorphically encrypted PRY key, performing a modular reduction operation according to a first modulus on a multiplication result, dividing a modular reduction result by a second modulus, and then performing a rounding operation.

In addition, according to an example, the electronic apparatus 100 may further generate a homomorphically encrypted error term through a homomorphic operation based on the homomorphically encrypted PRF key and the information related to the message. The homomorphically encrypted error term may refer to information generated by encrypting information corresponding to a small noise value capable of being added to the standard Dilithium signature algorithm according to the homomorphic encryption scheme.

The operating method according to one or more embodiments may include acquiring the first ciphertext corresponding to the commitment based on the homomorphically encrypted mask (S420).

According to an example, the electronic apparatus 100 may acquire the first ciphertext corresponding to the commitment based on the homomorphically encrypted mask generated in S410.

Here, the commitment is an intermediate output used in the threshold signature operation according to the present disclosure, and may refer to information corresponding to a commitment of the standard Dilithium signature algorithm.

Here, the first ciphertext may refer to a ciphertext in a form in which information corresponding to the commitment is encrypted according to the homomorphic encryption scheme.

For example, the electronic apparatus 100 may acquire a homomorphically encrypted intermediate value by performing a homomorphic operation based on the homomorphically encrypted mask and a public matrix, and may acquire the first ciphertext corresponding to the commitment by performing a high-bits extraction operation on the homomorphically encrypted intermediate value.

Here, the public matrix is a matrix corresponding to a verification key of standard Dilithium, and may refer to a public matrix shared among a plurality of electronic apparatuses participating in the threshold signature.

Here, the homomorphically encrypted intermediate value may refer to information generated by encrypting information corresponding to a multiplication result between the homomorphically encrypted mask and the public matrix according to the homomorphic encryption scheme.

Here, the high-bits extraction operation may refer to an operation of extracting high bits from a bit representation of an input value.

In addition, according to an example, the electronic apparatus 100 may also acquire a homomorphically encrypted intermediate value through a homomorphic operation based on the homomorphically encrypted mask and the homomorphically encrypted error term. For example, the electronic apparatus 100 may acquire the homomorphically encrypted intermediate value by adding the homomorphically encrypted error term to a multiplication result between the homomorphically encrypted mask and the public matrix.

According to the above-described example, the electronic apparatus 100 may generate the mask in a homomorphic operation region based on the homomorphic-friendly PRY, and may efficiently acquire the first ciphertext corresponding to the commitment based on the generated mask. Accordingly, the threshold signature scheme according to the present disclosure may avoid inefficiency caused by evaluating a security hash algorithm-based pseudo-random function in a homomorphic operation region.

In addition, according to the above-described example, the electronic apparatus 100 may generate all randomness required for the threshold signature only with single PRY evaluation. Accordingly, processing efficiency of the threshold signature scheme according to the present disclosure may be improved.

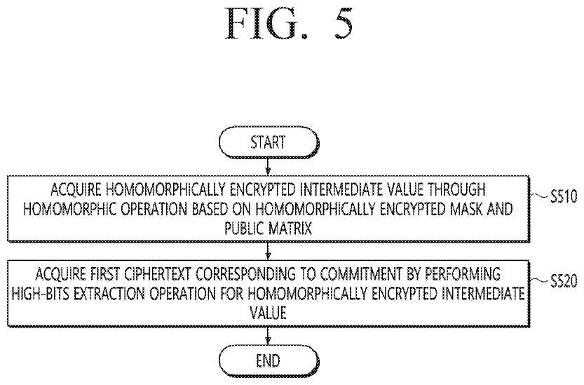

FIG. 5 is a flowchart illustrating a method of acquiring the first ciphertext corresponding to a commitment according to one or more embodiments of the present disclosure.

Referring to FIG. 5, the operating method according to one or more embodiments may include acquiring a homomorphically encrypted intermediate value through a homomorphic operation based on a homomorphically encrypted mask and a public matrix (S510).

According to an example, the electronic apparatus 100 may acquire the homomorphically encrypted intermediate value by performing the homomorphic operation based on the homomorphically encrypted mask and the public matrix stored in a memory (e.g., the memory 130 illustrated in FIG. 2).

Here, the homomorphically encrypted mask may refer to information generated by encrypting information corresponding to a random value for concealing a secret key in the standard Dilithium signature algorithm according to the homomorphic encryption scheme. According to an example, the homomorphically encrypted mask may be information generated through the homomorphic operation based on the homomorphically encrypted pseudo-random function (PRF) key and the information related to the message in S410 of FIG. 4.

Here, the public matrix may refer to a matrix corresponding to a verification key of standard Dilithium. According to an example, the public matrix may be a public matrix shared among a plurality of electronic apparatuses participating in the threshold signature according to the present disclosure. As an example, the public matrix is a matrix generated in a key generation operation of standard Dilithium, and may be distributed to the plurality of electronic apparatuses in a plaintext state.

Here, the homomorphically encrypted intermediate value may refer to information generated by encrypting information corresponding to a multiplication result between the homomorphically encrypted mask and the public matrix according to the homomorphic encryption scheme. According to an example, the homomorphically encrypted intermediate value may be information generated by encrypting a value corresponding to a result of multiplying the mask by the public matrix in the standard Dilithium signature algorithm according to the homomorphic encryption scheme.

For example, the electronic apparatus 100 may acquire the homomorphically encrypted intermediate value by performing a homomorphic operation corresponding to a plaintext-ciphertext multiplication between the homomorphically encrypted mask and the public matrix. Here, the plaintext-ciphertext multiplication may refer to multiplication between information in a plaintext state and information in a ciphertext state.

According to the present disclosure, as the public matrix is in the plaintext state and the mask is in the ciphertext state, the homomorphic operation may be performed in a form of plaintext-ciphertext multiplication. The plaintext-ciphertext multiplication may be performed more efficiently than ciphertext-ciphertext multiplication, thereby improving a processing speed of the threshold signature scheme according to the present disclosure.

In addition, according to an example, the electronic apparatus 100 may also acquire the homomorphically encrypted intermediate value by adding a homomorphically encrypted error term to a multiplication result between the homomorphically encrypted mask and the public matrix. Here, the homomorphically encrypted error term may refer to information generated by encrypting information corresponding to a small noise value capable of being added to the standard Dilithium signature algorithm according to the homomorphic encryption scheme.

In addition, according to an example, the electronic apparatus 100 may also acquire the homomorphically encrypted intermediate value by performing a modular reduction operation on a multiplication result between the homomorphically encrypted mask and the public matrix. Here, the modular reduction operation may refer to an operation of calculating a remainder acquired by dividing an input value by a predetermined modulus. As an example, a modulus used for the modular reduction operation may be a value corresponding to a modulus used in the standard Dilithium signature algorithm.

The operating method according to one or more embodiments may include acquiring the first ciphertext corresponding to the commitment by performing a high-bits extraction operation on the homomorphically encrypted intermediate value (S520).

According to an example, the electronic apparatus 100 may acquire the first ciphertext corresponding to the commitment by performing the high-bits extraction operation on the homomorphically encrypted intermediate value acquired in S510.

Here, the high-bits extraction operation may refer to an operation of extracting high bits from a bit representation of an input value. According to an example, the high-bits extraction operation may be an operation corresponding to a HighBits function of the standard Dilithium signature algorithm.

Here, the commitment is an intermediate output used in the threshold signature operation according to the present disclosure, and may refer to information corresponding to a commitment of the standard Dilithium signature algorithm.

Here, the first ciphertext may refer to a ciphertext in a form in which information corresponding to the commitment is encrypted according to the homomorphic encryption scheme.

According to an example, the electronic apparatus 100 may acquire homomorphically encrypted information in bit units by performing a bit decomposition operation on the homomorphically encrypted intermediate value, and may acquire the first ciphertext corresponding to the commitment based on information corresponding to high bits among the homomorphically encrypted information in bit units.

Here, the bit decomposition operation may refer to an operation of decomposing an input value in bit units. According to an example, the bit decomposition operation may be an operation of converting an integer into a bit string of a binary representation.

In addition, according to an example, the electronic apparatus 100 may also further acquire homomorphically encrypted low-bit information by performing a low-bits extraction operation on the homomorphically encrypted intermediate value. Here, the low-bits extraction operation may refer to an operation of extracting low bits from a bit representation of an input value. According to an example, the low-bits extraction operation may be an operation corresponding to a LowBits function of the standard Dilithium signature algorithm.

The homomorphically encrypted low-bit information may be utilized in a subsequent process (e.g., rejection verification of a response candidate) during the threshold signature operation according to the present disclosure.

According to the above-described example, the electronic apparatus 100 may efficiently perform a homomorphic operation based on the homomorphically encrypted mask and the public matrix, and may acquire the first ciphertext corresponding to the commitment by performing a high-bits extraction operation on a result thereof. Accordingly, the threshold signature scheme according to the present disclosure may efficiently implement a commitment derivation operation of the standard Dilithium signature algorithm in a homomorphic operation region.

In addition, according to the above-described example, the electronic apparatus 100 may improve a processing speed of the homomorphic operation by utilizing plaintext-ciphertext multiplication between the public matrix in a plaintext state and the mask in a ciphertext state.

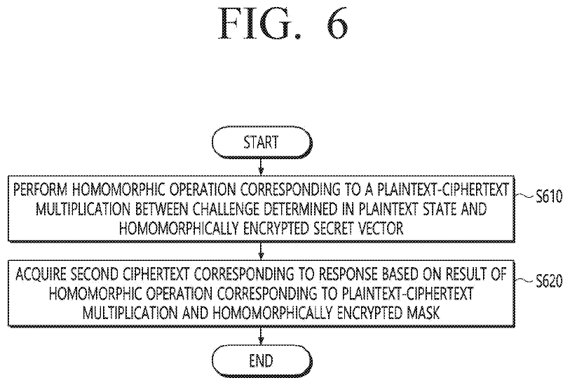

FIG. 6 is a flowchart illustrating a method of acquiring the second ciphertext corresponding to a response according to one or more embodiments of the present disclosure.

Referring to FIG. 6, the operating method according to one or more embodiments may include performing a homomorphic operation corresponding to a plaintext-ciphertext multiplication between the challenge determined in the plaintext state and the homomorphically encrypted secret vector (S610).

According to an example, the electronic apparatus 100 may perform the homomorphic operation corresponding to the plaintext-ciphertext multiplication between the challenge determined in the plaintext state and the homomorphically encrypted secret vector.

Here, the challenge is information used in the threshold signature operation according to the present disclosure, and may refer to information corresponding to a challenge of the standard Dilithium signature algorithm. According to an example, the challenge may be information determined in the plaintext state based on the commitment restored into the plaintext state in S330 of FIG. 3 and the information related to the message.

Here, the homomorphically encrypted secret vector may refer to information generated by encrypting a secret vector corresponding to a secret key of standard Dilithium according to the homomorphic encryption scheme. According to an example, the homomorphically encrypted secret vector may be information included in homomorphically encrypted signature key information stored in a memory (e.g., the memory 130 illustrated in FIG. 2).

Here, the plaintext-ciphertext multiplication may refer to multiplication between information in a plaintext state and information in a ciphertext state. As at least one of inputs is in the plaintext state, the plaintext-ciphertext multiplication may be performed more efficiently than ciphertext-ciphertext multiplication in which all inputs are in the ciphertext state.

According to the present disclosure, as the challenge is determined in the plaintext state and the secret vector is encrypted according to the homomorphic encryption scheme, the homomorphic operation between the challenge and the secret vector may be performed in a form of plaintext-ciphertext multiplication. Accordingly, the threshold signature scheme according to the present disclosure may improve a processing speed of the homomorphic operation.

For example, the electronic apparatus 100 may acquire a result of the homomorphic operation corresponding to the plaintext-ciphertext multiplication by performing a homomorphic operation corresponding to multiplication between each component of the challenge determined in the plaintext state and each component of the homomorphically encrypted secret vector.

Here, the result of the homomorphic operation corresponding to the plaintext-ciphertext multiplication may refer to information generated by encrypting information corresponding to a multiplication result between the challenge and the secret vector according to the homomorphic encryption scheme. According to an example, the result of the homomorphic operation corresponding to the plaintext-ciphertext multiplication may be information generated by encrypting a value corresponding to a multiplication result between the challenge and the secret vector in the standard Dilithium signature algorithm according to the homomorphic encryption scheme.

In addition, according to an example, the homomorphically encrypted signature key information may include a plurality of homomorphically encrypted secret vectors. For example, the homomorphically encrypted signature key information may include a first homomorphically encrypted secret vector corresponding to a first secret vector of standard Dilithium and a second homomorphically encrypted secret vector corresponding to a second secret vector of standard Dilithium. In this case, the electronic apparatus 100 may respectively perform plaintext-ciphertext multiplication between the challenge determined in the plaintext state and the first homomorphically encrypted secret vector, and plaintext-ciphertext multiplication between the challenge determined in the plaintext state and the second homomorphically encrypted secret vector.

The operating method according to one or more embodiments may include acquiring the second ciphertext corresponding to the response based on a result of the homomorphic operation corresponding to the plaintext-ciphertext multiplication and the homomorphically encrypted mask (S620).

According to an example, the electronic apparatus 100 may acquire the second ciphertext corresponding to the response based on the result of the homomorphic operation corresponding to the plaintext-ciphertext multiplication acquired in S610 and the homomorphically encrypted mask.

Here, the homomorphically encrypted mask may refer to information generated by encrypting information corresponding to a random value for concealing a secret key in the standard Dilithium signature algorithm according to the homomorphic encryption scheme. According to an example, the homomorphically encrypted mask may be information generated through a homomorphic operation based on a homomorphically encrypted pseudo-random function (PRF) key and the information related to the message in S410 of FIG. 4.

Here, the response is information used in the threshold signature operation according to the present disclosure, and may refer to information corresponding to a response of the standard Dilithium signature algorithm.

Here, the second ciphertext may refer to a ciphertext in a form in which information corresponding to the response is encrypted according to the homomorphic encryption scheme.

For example, the electronic apparatus 100 may acquire the second ciphertext corresponding to the response by performing a homomorphic operation corresponding to homomorphic addition between the result of the homomorphic operation corresponding to the plaintext-ciphertext multiplication and the homomorphically encrypted mask. According to an example, the homomorphic addition may refer to a homomorphic operation corresponding to addition between information encrypted according to the homomorphic encryption scheme.

In addition, according to an example, the electronic apparatus 100 may check whether the second ciphertext corresponding to the response satisfies a predetermined condition. Here, the predetermined condition may be a condition corresponding to a rejection sampling condition of the standard Dilithium signature algorithm.

For example, the electronic apparatus 100 may check whether an infinity norm of the response represented by the second ciphertext corresponding to the response is less than a predetermined threshold. When the infinity norm of the response is equal to or greater than the predetermined threshold, the electronic apparatus 100 may reject the corresponding response and perform an operation for deriving a new response. When the infinity norm of the response is less than the predetermined threshold, the electronic apparatus 100 may adopt the second ciphertext corresponding to the corresponding response.

Here, the infinity norm may refer to an absolute value of a component having the largest absolute value among components of a vector.

According to the above-described example, the electronic apparatus 100 may efficiently acquire the second ciphertext corresponding to the response by utilizing plaintext-ciphertext multiplication between the challenge in the plaintext state and the homomorphically encrypted secret vector. Accordingly, the threshold signature scheme according to the present disclosure may improve a processing speed of the homomorphic operation.

In addition, according to the above-described example, the threshold signature scheme according to the present disclosure may perform multiplication between the challenge and the secret vector in a form of plaintext-ciphertext multiplication by determining the challenge in the plaintext state. Such multiplication is significantly efficient compared to a case in which the challenge is multiplied by the secret vector in a homomorphically encrypted state (i.e., ciphertext-ciphertext multiplication).

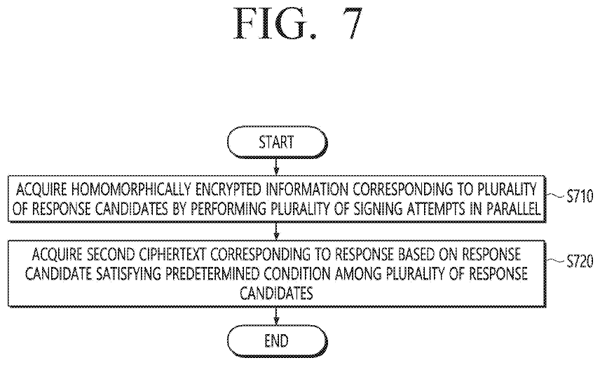

FIG. 7 is a flowchart illustrating a method of acquiring the second ciphertext corresponding to a response according to one or more embodiments of the present disclosure.

Referring to FIG. 7, the operating method according to one or more embodiments may include acquiring homomorphically encrypted information corresponding to a plurality of response candidates by performing a plurality of signing attempts in parallel (S710).

According to an example, the electronic apparatus 100 may acquire the homomorphically encrypted information corresponding to the plurality of response candidates by performing the plurality of signing attempts in parallel.

Here, a signing attempt may refer to a single attempt for deriving a response in the threshold signature operation according to the present disclosure. According to an example, the signing attempt may be an operation corresponding to a single signing attempt accompanying rejection sampling in the standard Dilithium signature algorithm.

Here, the response candidate may refer to a candidate of a response derived according to the signing attempt. According to an example, the response candidate may be adopted or rejected depending on whether a rejection sampling condition is satisfied.

Here, the homomorphically encrypted information corresponding to the response candidate may refer to information generated by encrypting the response candidate according to the homomorphic encryption scheme.

According to an example, the electronic apparatus 100 may simultaneously acquire homomorphically encrypted information corresponding to a plurality of response candidates by performing the plurality of signing attempts in parallel. As an example, the electronic apparatus 100 may perform the plurality of signing attempts in parallel by utilizing a Single Instruction Multiple Data (SIMD) characteristic of homomorphic encryption.

Here, the SIMD characteristic may refer to a characteristic capable of simultaneously performing a homomorphic operation on a plurality of data through a single homomorphic operation instruction. According to an example, the SIMD characteristic may be a characteristic of disposing a plurality of data in slots of a plaintext vector according to the homomorphic encryption scheme and simultaneously performing homomorphic operations on the plurality of data through slot-unit homomorphic operations.

According to the present disclosure, the electronic apparatus 100 may perform the plurality of signing attempts in parallel by utilizing the SIMD characteristic, and may efficiently process a repeated operation according to rejection sampling of the standard Dilithium signature algorithm in a homomorphic operation region.

For example, the electronic apparatus 100 may generate a plurality of homomorphically encrypted masks corresponding to the plurality of signing attempts in parallel through a homomorphic operation based on a homomorphically encrypted pseudo-random function (PRF) key and the information related to the message. In addition, the electronic apparatus 100 may acquire homomorphically encrypted information corresponding to the plurality of response candidates in parallel based on each of the plurality of homomorphically encrypted masks.

In addition, according to an example, the number of the plurality of signing attempts may be determined as a predetermined value. For example, the number of the plurality of signing attempts may be determined based on a pass probability of rejection sampling in the standard Dilithium signature algorithm and processing efficiency of the homomorphic operation.

In addition, according to an example, the electronic apparatus 100 may improve a signature success probability in the threshold signature scheme according to the present disclosure by performing the plurality of signing attempts in parallel. That is, even when a single signing attempt fails, the threshold signature may be successfully generated when another signing attempt is successfully generated, and the threshold signature scheme according to the present disclosure may achieve a significantly higher signature success probability compared to a single signing attempt.

The operating method according to one or more embodiments may include acquiring the second ciphertext corresponding to the response based on a response candidate satisfying a predetermined condition among the plurality of response candidates (S720).

According to an example, the electronic apparatus 100 may acquire the second ciphertext corresponding to the response based on the response candidate satisfying the predetermined condition among the plurality of response candidates acquired in S710.

Here, the predetermined condition may refer to a condition for adopting the response candidate as the response in the threshold signature operation according to the present disclosure. According to an example, the predetermined condition may be a condition corresponding to a rejection sampling condition of the standard Dilithium signature algorithm.

For example, the predetermined condition may include a condition that an infinity norm of the response candidate is less than a predetermined first threshold. In addition, the predetermined condition may further include a condition that an infinity norm of low-bit information corresponding to the response candidate is less than a predetermined second threshold.

Here, the response is information used in the threshold signature operation according to the present disclosure, and may refer to information corresponding to a response of the standard Dilithium signature algorithm.

Here, the second ciphertext may refer to a ciphertext in a form in which information corresponding to the response is encrypted according to the homomorphic encryption scheme.

According to an example, when a plurality of response candidates satisfying the predetermined condition among the plurality of response candidates are present, the electronic apparatus 100 may acquire the second ciphertext corresponding to the response based on a response candidate identified first among the response candidates. That is, the electronic apparatus 100 may adopt a first response candidate satisfying the predetermined condition among the plurality of response candidates as the response, and may discard the other response candidates.

According to the present disclosure, the electronic apparatus 100 may adopt only the response candidate identified first among the plurality of response candidates as the response, thereby allowing only a single signature to be disclosed. Accordingly, a security attack based on an unused response candidate may be prevented.

For example, the electronic apparatus 100 may identify the first response candidate satisfying the predetermined condition among the plurality of response candidates, and may generate a one-hot vector indicating a position corresponding to the identified response candidate. In addition, the electronic apparatus 100 may preserve only the first response candidate and set the other response candidates to zero values through a homomorphic operation based on the generated one-hot vector.

Here, one-hot vector may refer to a vector in which only one component has a value of 1 and the remaining components have values of 0.

In addition, according to an example, when a response candidate satisfying the predetermined condition among the plurality of response candidates is not present, the electronic apparatus 100 may restart the threshold signature operation according to the present disclosure. As an example, the electronic apparatus 100 may re-perform the threshold signature operation according to the present disclosure based on the changed information related to the message after changing the information related to the message.

According to the above-described example, the electronic apparatus 100 may efficiently process the repeated operation according to rejection sampling of the standard Dilithium signature algorithm in a homomorphic operation region by performing the plurality of signing attempts in parallel. Accordingly, the threshold signature scheme according to the present disclosure may process rejection sampling using a scheme suitable for a circuit-based homomorphic operation model.

In addition, according to the above-described example, the electronic apparatus 100 may adopt only the response candidate identified first among the plurality of response candidates as the response, thereby allowing only a single signature to be disclosed. Accordingly, the threshold signature scheme according to the present disclosure may prevent a security attack based on an unused response candidate.

In addition, according to the above-described example, the electronic apparatus 100 may improve processing efficiency of the homomorphic operation by utilizing the SIMID characteristic to perform the plurality of signing attempts in parallel.

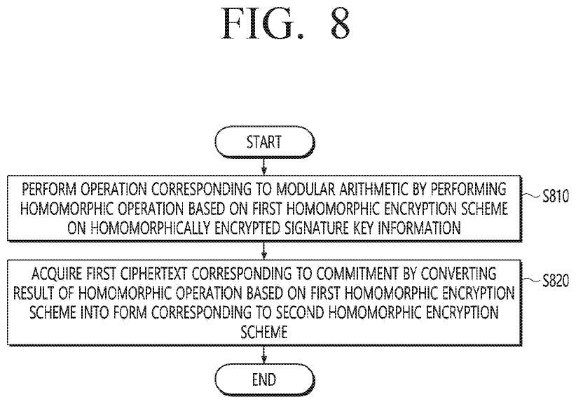

FIG. 8 is a flowchart illustrating a method of acquiring the first ciphertext corresponding to a commitment according to one or more embodiments of the present disclosure.

Referring to FIG. 8, the operating method according to one or more embodiments may include performing an operation corresponding to modular arithmetic by performing a homomorphic operation based on a first homomorphic encryption scheme on the homomorphically encrypted signature key information (S810).

According to an example, the electronic apparatus 100 may perform the homomorphic operation based on the first homomorphic encryption scheme on the homomorphically encrypted signature key information stored in a memory (e.g., the memory 130 illustrated in FIG. 2). According to an example, the homomorphic operation based on the first homomorphic encryption scheme may include the operation corresponding to modular arithmetic.

Here, the homomorphic encryption scheme may refer to an encryption scheme used for a homomorphic encryption operation. According to an example, the homomorphic encryption scheme may refer to an encryption scheme in which an arithmetic operation on plaintext data also derives a corresponding operation result in a ciphertext state.

Here, the first homomorphic encryption scheme may refer to the homomorphic encryption scheme capable of efficiently performing an operation corresponding to integer or modular arithmetic. According to an example, the first homomorphic encryption scheme may include a Brakerski-Fan-Vercauteren (BFV) homomorphic encryption scheme or a Brakerski-Gentry-Vaikuntanathan (BGV) homomorphic encryption scheme.

Here, the modular arithmetic may refer to an arithmetic operation performed on a predetermined modulus. According to an example, the modular arithmetic may refer to an operation of performing addition, subtraction, or multiplication between two input values and then calculating the remainder acquired by dividing a result thereof by the predetermined modulus.

According to the present disclosure, as the standard Dilithium signature algorithm includes an operation corresponding to modular arithmetic, the electronic apparatus 100 may use the first homomorphic encryption scheme capable of efficiently performing the operation corresponding to modular arithmetic.

For example, the electronic apparatus 100 may perform a homomorphic operation corresponding to multiplication between a homomorphically encrypted pseudo-random function (PRF) key and the information related to the message based on the first homomorphic encryption scheme. As an example, the electronic apparatus 100 may perform, based on the BFV homomorphic encryption scheme, a homomorphic operation corresponding to modular multiplication between the homomorphically encrypted PRF key and the information related to the message.

In addition, according to an example, the electronic apparatus 100 may perform a homomorphic operation corresponding to multiplication between a homomorphically encrypted mask and a public matrix based on the first homomorphic encryption scheme. As an example, the electronic apparatus 100 may perform, based on the BFV homomorphic encryption scheme, a homomorphic operation corresponding to modular multiplication between the homomorphically encrypted mask and the public matrix.

The operating method according to one or more embodiments may include acquiring the first ciphertext corresponding to the commitment by converting a result of the homomorphic operation based on the first homomorphic encryption scheme into a form corresponding to a second homomorphic encryption scheme (S820).

According to an example, the electronic apparatus 100 may convert the result of the homomorphic operation based on the first homomorphic encryption scheme acquired in S810 into the form corresponding to the second homomorphic encryption scheme. In addition, the electronic apparatus 100 may acquire the first ciphertext corresponding to the commitment based on the converted result.

Here, the second homomorphic encryption scheme may refer to the homomorphic encryption scheme capable of efficiently performing an operation corresponding to comparison operation or real-number arithmetic. According to an example, the second homomorphic encryption scheme may include a Cheon-Kim-Kim-Song (CKKS) homomorphic encryption scheme.

Here, the comparison operation may refer to an operation of determining a magnitude relationship or an equivalence relationship between input values.

Here, the conversion operation into a form corresponding to the second homomorphic encryption scheme may refer to an operation of converting a ciphertext of the first homomorphic encryption scheme into a ciphertext of the second homomorphic encryption scheme. According to an example, the conversion operation into the form corresponding to the second homomorphic encryption scheme may refer to an operation of converting only a ciphertext format while preserving plaintext.

For example, the electronic apparatus 100 may convert a ciphertext of the BFV homomorphic encryption scheme, which is the result of the homomorphic operation based on the first homomorphic encryption scheme, into a ciphertext of the CKKS homomorphic encryption scheme. As an example, the electronic apparatus 100 may convert the ciphertext of the BFV homomorphic encryption scheme into the ciphertext of the CKKS homomorphic encryption scheme based on a bootstrapping-based format conversion algorithm.

Here, bootstrapping may refer to an operation of increasing a ciphertext modulus of homomorphic encryption to allow an additional homomorphic operation to be performed. According to an example, bootstrapping may refer to a homomorphic operation of increasing the ciphertext modulus while preserving plaintext.

In addition, according to an example, the electronic apparatus 100 may also convert a result of a homomorphic operation based on the second homomorphic encryption scheme into a form corresponding to the first homomorphic encryption scheme. That is, the electronic apparatus 100 may perform bidirectional conversion between the first homomorphic encryption scheme and the second homomorphic encryption scheme.

For example, the electronic apparatus 100 may also convert a ciphertext of the CKKS homomorphic encryption scheme into a ciphertext of the BFV homomorphic encryption scheme. As an example, the electronic apparatus 100 may convert the ciphertext of the CKKS homomorphic encryption scheme into the ciphertext of the BFV homomorphic encryption scheme by homomorphically applying a cleaning map to the ciphertext of the CKKS homomorphic encryption scheme, and then performing a homomorphic discrete Fourier transform (DFT).

Here, the cleaning map may refer to a function for increasing precision of a homomorphically encrypted binary plaintext. According to an example, the cleaning map may be a function for mapping an input value into a form of (3×\hat{ }2−2×\hat{ }3).

According to the present disclosure, the electronic apparatus 100 may utilize the homomorphic encryption scheme suitable for characteristics of each operation by using the first homomorphic encryption scheme, for example, BFV, for an operation corresponding to modular arithmetic and using the second homomorphic encryption scheme, for example, CKKS, for an operation corresponding to comparison operation or real-number arithmetic.

Here, the commitment is an intermediate output used in the threshold signature operation according to the present disclosure, and may refer to information corresponding to a commitment of the standard Dilithium signature algorithm.

Here, the first ciphertext may refer to a ciphertext in a form in which information corresponding to the commitment is encrypted according to the homomorphic encryption scheme.

For example, the electronic apparatus 100 may acquire the first ciphertext corresponding to the commitment by performing a comparison operation or a high-bits extraction operation on a result converted into the form corresponding to the second homomorphic encryption scheme.

In addition, according to an example, the electronic apparatus 100 may apply a combined operation of the first homomorphic encryption scheme and the second homomorphic encryption scheme throughout the threshold signature operation according to the present disclosure. For example, the electronic apparatus 100 may selectively use the first homomorphic encryption scheme or the second homomorphic encryption scheme according to characteristics of each operation, such as a pseudo-random function (PRF) evaluation operation, a mask generation operation, a multiplication operation involving a public matrix, a high-bits extraction operation, or a rejection verification operation.

According to the above-described example, the electronic apparatus 100 may efficiently implement the standard Dilithium signature algorithm in which an operation corresponding to modular arithmetic and a comparison operation are mixed in a homomorphic operation region. Accordingly, the threshold signature scheme according to the present disclosure may achieve improved processing efficiency compared to a case of using only a single homomorphic encryption scheme.

In addition, according to the above-described example, the electronic apparatus 100 may perform bidirectional conversion between the first homomorphic encryption scheme and the second homomorphic encryption scheme, thereby selectively utilizing the homomorphic encryption scheme suitable for characteristics of each operation.

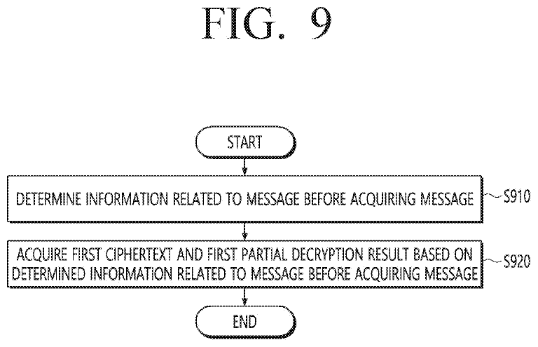

FIG. 9 is a flowchart illustrating an operation of the electronic apparatus according to one or more embodiments of the present disclosure.

Referring to FIG. 9, the operating method according to one or more embodiments may include determining the information related to the message before acquiring the message (S910).

According to an example, the electronic apparatus 100 may determine the information related to a message before acquiring the message to be signed.

Here, the message may refer to a message to be signed by the threshold signature according to the present disclosure. According to an example, the message may be a message to be received from an external electronic apparatus, or may be a message to be generated by the electronic apparatus 100.

Here, the information related to the message may refer to information determined based on the message to be signed. According to an example, the information related to the message may be a result value acquired by applying a hash function to the message.

According to the present disclosure, the electronic apparatus 100 may determine the information related to the message in advance before the message arrives. That is, the information related to the message may not be determined based on actual content of the message, and may be determined in a message-independent manner.

For example, the electronic apparatus 100 may determine the information related to the message based on an identifier agreed among a plurality of electronic apparatuses participating in the threshold signature according to the present disclosure.

Here, the agreed identifier may refer to a unique identifier agreed in advance by the plurality of electronic apparatuses participating in the threshold signature according to the present disclosure. According to an example, the agreed identifier may include a message number, time information, or other contextual data.

As an example, the electronic apparatus 100 may determine, as the information related to the message, a result value acquired by applying a hash function to the message number, the time information, or other contextual data.

In addition, according to an example, the electronic apparatus 100 may also determine the information related to the message by applying a function based on a random oracle to an input agreed by the plurality of electronic apparatuses participating in the threshold signature according to the present disclosure.

Here, the function based on the random oracle may refer to a function for generating a random output for an input. According to an example, the function based on the random oracle may include a security hash algorithm-based hash function.

The operating method according to one or more embodiments may include acquiring the first ciphertext and the first partial decryption result based on the determined information related to the message before acquiring the message (S920).

According to an example, the electronic apparatus 100 may acquire the first ciphertext and the first partial decryption result based on the information related to the message determined in S910 before acquiring the message.

Here, the first ciphertext may refer to a ciphertext in a form in which information corresponding to a commitment is encrypted according to the homomorphic encryption scheme.

Here, the first partial decryption result may refer to a result acquired by partially decrypting the first ciphertext using a partial decryption key stored in the electronic apparatus 100.

According to an example, the electronic apparatus 100 may acquire the first ciphertext based on the information related to the message determined in an offline phase before acquiring the message. In addition, the electronic apparatus 100 may acquire the first partial decryption result for the first ciphertext based on the partial decryption key in the offline phase before acquiring the message.

Here, the offline phase may refer to a phase before the message to be signed arrives. The offline phase may be a phase in which operations independent of content of the message are performed.

Correspondingly, among the threshold signature operations according to the present disclosure, operations dependent on content of the message may be performed in an online phase after the message arrives.

Here, the online phase may refer to a phase after the message to be signed arrives. The online phase may be a phase in which operations dependent on content of the message are performed.

For example, in the online phase, the electronic apparatus 100 may determine a challenge in a plaintext state based on content of the message, acquire the second ciphertext corresponding to a response based on the determined challenge, and acquire a second partial decryption result for the second ciphertext.

According to the present disclosure, the electronic apparatus 100 may perform an operation independent of the message among the threshold signature operations according to the present disclosure in advance in the offline phase. Accordingly, processing time in the online phase after the message arrives may be significantly reduced.

In addition, according to an example, all of the plurality of electronic apparatuses participating in the threshold signature operation according to the present disclosure may perform operations independent of the message in advance in the offline phase. That is, the threshold signature scheme according to the present disclosure may be implemented as a distributed preprocessing scheme.

Here, distributed preprocessing may refer to processing performed in advance in a distributed form by the plurality of electronic apparatuses participating in the threshold signature before the message arrives.

In addition, according to an example, the first partial decryption result acquired in the offline phase among the threshold signature operations according to the present disclosure may be transmitted to an external electronic apparatus after the message arrives.

According to the present disclosure, as the first partial decryption result is transmitted to the external electronic apparatus after the message arrives, the commitment may be prevented from being restored into plaintext before the message arrives. Accordingly, a security attack caused by disclosure of the commitment before the message arrives may be prevented.

According to the above-described example, the electronic apparatus 100 may perform the threshold signature operation according to the present disclosure by separating the threshold signature operation into the offline phase independent of the message and the online phase dependent on the message. Accordingly, the threshold signature scheme according to the present disclosure may significantly reduce processing time in the online phase after the message arrives.

In addition, according to the above-described example, the threshold signature scheme according to the present disclosure may be implemented as the distributed preprocessing scheme, and the plurality of electronic apparatuses participating in the threshold signature may improve a response time in the threshold signature scheme according to the present disclosure by performing operations independent of the message in advance.

In addition, according to the above-described example, the electronic apparatus 100 may prevent a security attack before the message arrives by transmitting the first partial decryption result acquired in the offline phase to the external electronic apparatus only after the message arrives.

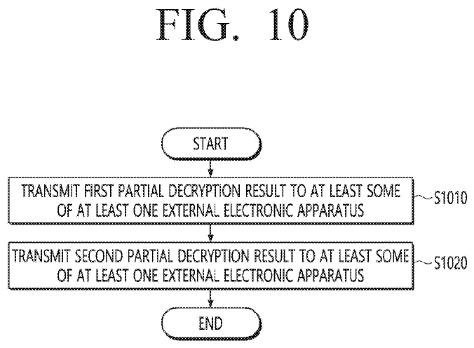

FIG. 10 is a flowchart illustrating an operation of the electronic apparatus according to one or more embodiments of the present disclosure.

Referring to FIG. 10, the operating method according to one or more embodiments may include transmitting the first partial decryption result to at least some of at least one external electronic apparatus (S1010).

According to an example, the electronic apparatus 100 may transmit the first partial decryption result to at least some of at least one external electronic apparatus (e.g., the external electronic apparatuses 100-1, 100-2, . . . , 100-n illustrated in FIG. 1) through a communication circuit (e.g., the communication circuit 110 illustrated in FIG. 2).

Here, the first partial decryption result may refer to a result acquired by partially decrypting the first ciphertext using a partial decryption key stored in the electronic apparatus 100. According to an example, the first partial decryption result may be information generated in S320 of FIG. 3.

Here, the first ciphertext may refer to a ciphertext in a form in which information corresponding to a commitment is encrypted according to the homomorphic encryption scheme. According to an example, the first ciphertext may be information acquired in S310 of FIG. 3.

According to an example, the electronic apparatus 100 may transmit the first partial decryption result to external electronic apparatuses equal to or greater than a threshold participating in the threshold signature according to the present disclosure. That is, the electronic apparatus 100 may share the first partial decryption result with the external electronic apparatuses equal to or greater than the threshold to satisfy a threshold condition of the threshold signature according to the present disclosure.

According to an example, the electronic apparatus 100 may transmit the first partial decryption result in a broadcast manner. That is, the electronic apparatus 100 may transmit the first partial decryption result to a plurality of external electronic apparatuses through a single transmission operation.

Here, the broadcast manner may refer to a scheme of transmitting the same information to a plurality of receiving apparatuses through a single transmission operation.

According to an example, the electronic apparatus 100 may transmit the first partial decryption result to at least some of at least one external electronic apparatus in a first communication round of the threshold signature operation according to the present disclosure.

Here, the first communication round may refer to a phase in which communication for plaintext restoration of the commitment is performed among the threshold signature operations according to the present disclosure. In the first communication round, the first partial decryption result and a first other partial decryption result may be transmitted and received between the plurality of electronic apparatuses participating in the threshold signature according to the present disclosure.

In addition, according to an example, the electronic apparatus 100 may also receive the first other partial decryption results from at least some of at least one external electronic apparatus through the communication circuit. That is, the electronic apparatus 100 may transmit its first partial decryption result to the external electronic apparatus while receiving the first other partial decryption result from the external electronic apparatus.

Here, the first other partial decryption result may refer to a result acquired by partially decrypting the first ciphertext using a partial decryption key stored in the external electronic apparatus.

The operating method according to one or more embodiments may include transmitting the second partial decryption result to at least some of at least one external electronic apparatus (S1020).

According to an example, the electronic apparatus 100 may transmit the second partial decryption result to at least some of at least one external electronic apparatus through the communication circuit.

Here, the second partial decryption result may refer to a result acquired by partially decrypting the second ciphertext using the partial decryption key stored in the electronic apparatus 100. According to an example, the second partial decryption result may be information generated in S350 of FIG. 3.

Here, the second ciphertext may refer to a ciphertext in a form in which information corresponding to a response is encrypted according to the homomorphic encryption scheme. According to an example, the second ciphertext may be information acquired in S340 of FIG. 3.

According to an example, the electronic apparatus 100 may transmit the second partial decryption result to external electronic apparatuses equal to or greater than the threshold participating in the threshold signature according to the present disclosure. That is, the electronic apparatus 100 may share the second partial decryption result with the external electronic apparatuses equal to or greater than the threshold to satisfy the threshold condition of the threshold signature according to the present disclosure.

According to an example, the electronic apparatus 100 may transmit the second partial decryption result to at least some of at least one external electronic apparatus in a second communication round of the threshold signature operation according to the present disclosure.

Here, the second communication round may refer to a phase in which communication for plaintext restoration of the response is performed among the threshold signature operations according to the present disclosure. In the second communication round, the second partial decryption result and a second other partial decryption result may be transmitted and received between the plurality of electronic apparatuses participating in the threshold signature according to the present disclosure.

In addition, according to an example, the electronic apparatus 100 may also receive the second other partial decryption results from at least some of at least one external electronic apparatus through the communication circuit.

Here, the second other partial decryption result may refer to a result acquired by partially decrypting the second ciphertext using a partial decryption key stored in the external electronic apparatus.

According to the present disclosure, the electronic apparatus 100 may generate the threshold signature through only two communication rounds in the threshold signature operation according to the present disclosure. That is, the electronic apparatus 100 may complete the threshold signature through only the first communication round in S1010 and the second communication round in S1020.

This scheme is in contrast to a Multi-Party Computation (MPC)-based threshold signature scheme requiring tens of communication rounds.

In addition, according to an example, the first communication round in S1010 may be performed independently of the message. That is, a homomorphic operation before the first communication round in S1010 may be performed independently of the message, and may be performed in advance in an offline phase before the message arrives. However, the first communication round in S1010 (i.e., transmission of the first partial decryption result) may be performed in an online phase after the message arrives.

According to the present disclosure, as the first partial decryption result is not transmitted to the external electronic apparatus before the message arrives, the commitment may be prevented from being restored into plaintext before the message arrives. Accordingly, a security attack before the message arrives may be prevented.

According to the above-described example, the electronic apparatus 100 may generate the threshold signature through only two communication rounds (i.e., transmission of the first partial decryption result and transmission of the second partial decryption result). Accordingly, the number of communication rounds of the threshold signature scheme according to the present disclosure may be significantly reduced compared to a Multi-Party Computation-based threshold signature scheme.

In addition, according to the above-described example, the electronic apparatus 100 may prevent a security attack before the message arrives by performing the first communication round after the message arrives.

Referring back to FIG. 2, according to one or more embodiments, the processor 120 may perform the threshold signature operation according to the present disclosure based on a partial decryption key distributed according to the secret sharing scheme.

According to an example, the partial decryption key may correspond to one of a plurality of partial decryption keys. As an example, the plurality of partial decryption keys may respectively be distributed to a plurality of electronic apparatuses participating in the threshold signature according to the present disclosure. That is, one of the plurality of partial decryption keys may be stored in the electronic apparatus 100, and another one of the plurality of partial decryption keys may be stored in each of at least one external electronic apparatus (e.g., the external electronic apparatuses 100-1, 100-2, . . . , 100-n illustrated in FIG. 1).

Here, the secret sharing scheme may refer to a scheme of dividing secret information into a plurality of fragments and distributing the plurality of fragments to a plurality of participants. According to an example, the secret sharing scheme may be a scheme for allowing the secret information to be restored only when fragments equal to or greater than a threshold are combined with each other.

Here, the threshold may refer to a minimum number of fragments required to restore the secret information. According to an example, when the number of the plurality of electronic apparatuses participating in the threshold signature according to the present disclosure is n, the threshold may be a positive integer t equal to or less than n.

According to an example, the plurality of partial decryption keys may be distributed according to the secret sharing scheme to restore a decryption key for homomorphic encryption based on partial decryption keys equal to or greater than the threshold. That is, in the threshold signature according to the present disclosure, the decryption key for homomorphic encryption may be restored only when partial decryption keys equal to or greater than the threshold are combined with each other.

According to the present disclosure, as the decryption key for homomorphic encryption is incapable of being restored only with partial decryption keys less than the threshold, the decryption key for homomorphic encryption may be protected even when partial decryption keys of some electronic apparatus are leaked. In addition, according to the present disclosure, as the threshold signature may be generated only when electronic apparatuses equal to or greater than the threshold cooperate with each other, forgery of the threshold signature may be prevented even when partial decryption keys of some electronic apparatus are leaked.

For example, the secret sharing scheme may include a Shamir secret sharing scheme or a linear secret sharing scheme (LSSS) based on Lagrange interpolation.

Here, the Shamir secret sharing scheme may refer to a secret sharing scheme for dividing secret information based on interpolation of a polynomial. According to an example, the Shamir secret sharing scheme may be a scheme of making the secret information correspond to a constant term of a degree t−1 polynomial and distributing other points of the polynomial as fragments.

Here, the linear secret sharing scheme may refer to a secret sharing scheme in which a combining operation of secret information corresponds to a linear operation. According to an example, in the linear secret sharing scheme, the secret information may be restored by a linear combination of fragments equal to or greater than the threshold.

According to an example, the partial decryption key may be distributed according to a distributed key generation (DKG) protocol between the electronic apparatus 100 and at least one external electronic apparatus.

Here, the distributed key generation protocol may refer to a protocol in which a plurality of participants cooperate with each other to divide and distribute secret information without a trusted dealer. According to an example, according to the distributed key generation protocol, an entire form of the secret information may be distributed without being exposed to any single participant.

Alternatively, according to an example, the partial decryption key may be distributed by a trusted dealer.

Here, the trusted dealer may refer to a trusted entity that divides secret information and distributes the secret information to a plurality of participants.

According to an example, the processor 120 may restore a commitment or a response into plaintext based on partial decryption results equal to or greater than the threshold (i.e., a first partial decryption result generated by the electronic apparatus 100 and first other partial decryption results received from external electronic apparatuses equal to or greater than the threshold). That is, the processor 120 may restore the commitment or the response into plaintext only when the partial decryption results equal to or greater than the threshold are combined with each other.

According to the present disclosure, as the commitment or the response is incapable of being restored into plaintext only with partial decryption results less than the threshold, security of the threshold signature scheme according to the present disclosure may be ensured.

In addition, according to an example, the threshold signature scheme according to the present disclosure may operate for an arbitrary threshold and an arbitrary number of participants. That is, in the threshold signature scheme according to the present disclosure, the threshold and the number of participants may be freely set.

In addition, according to an example, the threshold signature scheme according to the present disclosure may minimize an effect caused by a change in the threshold or the number of participants. That is, in the threshold signature scheme according to the present disclosure, even when the threshold or the number of participants is changed, most of the homomorphic operation may be performed as it is without change.

According to one or more embodiments, the processor 120 may generate a first partial decryption result or a second partial decryption result based on the partial decryption key and flooding noise.

Here, the flooding noise may refer to noise added to a partial decryption result. According to an example, the flooding noise may be noise for concealing residual information of the homomorphic operation included in the partial decryption result.

According to the present disclosure, residual information generated in a process of the homomorphic operation may be included in the partial decryption result. The residual information may include information related to a secret key for homomorphic encryption, and the information related to the secret key may therefore be exposed to the outside when the partial decryption result is shared. According to the present disclosure, the processor 120 may prevent the residual information from being exposed to the outside by adding the flooding noise to the partial decryption result.

According to an example, the flooding noise may be noise sampled according to a Gaussian distribution.

Here, the Gaussian distribution may refer to a normal distribution defined by a mean and a standard deviation. According to an example, the flooding noise may be noise sampled according to a Gaussian distribution having a mean of 0 and a predetermined standard deviation.

Alternatively, according to an example, the flooding noise may be noise sampled according to a rounded Gaussian distribution.

Here, the rounded Gaussian distribution may refer to a distribution acquired by rounding a value sampled from a Gaussian distribution to the nearest integer.

According to an example, a magnitude of the flooding noise may be determined based on a magnitude of residual information generated in a processing process of the homomorphic operation. According to an example, a standard deviation of the flooding noise may be set to a value sufficiently greater than an upper limit value of the residual information.

For example, the processor 120 may generate the first partial decryption result by performing a homomorphic operation corresponding to multiplication between the partial decryption key and the first ciphertext and adding the flooding noise to a result thereof. Similarly, the processor 120 may generate the second partial decryption result by performing a homomorphic operation corresponding to multiplication between the partial decryption key and the second ciphertext and adding the flooding noise to a result thereof.

In addition, according to an example, a magnitude of the flooding noise may be determined based on a security analysis based on Rényi divergence.

Here, the Rényi divergence may refer to a measure for measuring a difference between two probability distributions. According to an example, the security analysis based on the Rényi divergence may allow security to be secured even with flooding noise having a smaller magnitude compared to a security analysis based on statistical distance.

According to the present disclosure, the processor 120 may reduce a size of the partial decryption result compared to the security analysis based on the statistical distance by determining a magnitude of the flooding noise based on the security analysis based on the Rényi divergence. Accordingly, a communication amount of the threshold signature scheme according to the present disclosure may be reduced.

According to the above-described example, the processor 120 may perform the threshold signature operation according to the present disclosure using the partial decryption key distributed according to the secret sharing scheme. Accordingly, the threshold signature scheme according to the present disclosure may protect the decryption key for homomorphic encryption and the threshold signature even when partial decryption keys of some electronic apparatus are leaked.

In addition, according to the above-described example, the processor 120 may prevent residual information of the homomorphic operation from being exposed to the outside by adding the flooding noise to the partial decryption result. Accordingly, security of the threshold signature scheme according to the present disclosure may be ensured.

In addition, according to the above-described example, the threshold signature scheme according to the present disclosure may operate for an arbitrary threshold and an arbitrary number of participants, and may be applied to various environments.

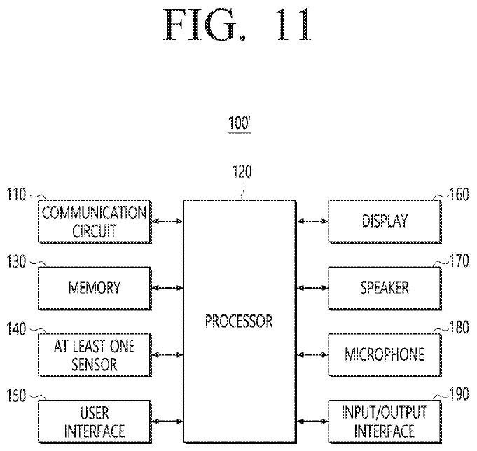

FIG. 11 is a block diagram illustrating a configuration of an electronic apparatus according to at least one embodiment of the present disclosure.

Referring to FIG. 11, an electronic apparatus 100′ may include the communication circuit 110, at least one processor 120, the memory 130, at least one sensor 140, a user interface 150, a display 160, a speaker 170, a microphone 180, and an input/output interface 190. Among components illustrated in FIG. 11, a detailed description of components overlapping with the components illustrated in FIG. 2 will be omitted.

At least one sensor 140 (hereinafter, the sensor) may include a plurality of sensors of various types. The sensor 140 may measure a physical quantity or detect an operating state of the electronic apparatus 100′, and convert measured or detected information into an electrical signal. The sensor 140 may include a camera, and the camera may include a lens for focusing visible light and other optical signals reflected by an object and received onto an image sensor, and an image sensor for detecting visible light and other optical signals. Here, the image sensor may include a two-dimensional (2D) pixel array divided into a plurality of pixels. Alternatively, at least one sensor 140 may include a temperature sensor or an infrared sensor.

The user interface 150 is a component for allowing the electronic apparatus 100′ to perform interaction with a user. For example, the user interface 150 may include at least one of a touch sensor, a motion sensor, a button, a jog dial, a switch, a microphone, or a speaker, and is not limited thereto.

The display 160 may be implemented as a display including a self-emissive element, or a display including a non-self-emissive element and a backlight. For example, the display 160 may be implemented as various types of displays such as a liquid crystal display (LCD), an organic light emitting diode (OLED) display, a light emitting diode (LED), a micro light emitting diode (micro LED), a mini LED, a plasma display panel (PDP), a quantum dot (QD) display, or a quantum dot light-emitting diode (QLED). A driving circuit, a backlight unit, and the like, which may be implemented in a form such as an amorphous silicon (a-si) thin film transistor (TFT), a low temperature poly silicon (LTPS) TFT, or an organic TFT (OTFT), may also be included in the display 160.

The display 160 may be implemented as a touch screen combined with a touch sensor, a flexible display, a rollable display, a three-dimensional (3D) display, a display in which a plurality of display modules are physically connected, and the like. The processor 120 may control the display 160 to output an output image acquired according to the above-described various embodiments. Here, the output image may be a high-resolution image of 4K or 8K or higher. The output image may also be a game image according to one or more embodiments.

According to one or more embodiments, the speaker 170 may include a tweeter for reproducing a high-pitched sound range, a midrange for reproducing a mid-pitched sound range, a woofer for reproducing a low-pitched sound range, a subwoofer for reproducing an ultra-low-pitched sound range, an enclosure for controlling resonance, a crossover network for dividing a frequency of an electrical signal input to the speaker by band, or the like.

According to one or more embodiments, the speaker 170 may output an acoustic signal to the outside of the electronic apparatus 100′. The speaker 170 may output multimedia playback, recording playback, various notification sounds, voice messages, and the like. The electronic apparatus 100′ may include an audio output device such as the speaker 170, or may include an output device such as an audio output terminal. In particular, the speaker 170 may provide acquired information, information processed or generated based on the acquired information, a response result to a user voice, an operation result, and the like in a voice form.

The microphone 180 may refer to a module for acquiring sound and converting the sound into an electrical signal, and may be a condenser microphone, a ribbon microphone, a moving-coil microphone, a piezoelectric element microphone, a carbon microphone, or a micro electro mechanical system (MEMS) microphone. In addition, the microphone 180 may be implemented in an omnidirectional, bidirectional, unidirectional, sub cardioid, super cardioid, or hyper cardioid manner. According to one or more embodiments, the electronic apparatus 100′ may include the microphone 180 and an inner microphone, and the microphone 180 may be a microphone located relatively outside a body. According to an example, the electronic apparatus 100′ may acquire an audio signal including external noise through the microphone 180. According to one or more embodiments, the microphone 180 may be disposed in a direction opposite to a direction in which the speaker 170 emits sound.

According to various embodiments, the electronic apparatus 100′ may perform an operation corresponding to a user voice signal received through the microphone 180.

As an example, the electronic apparatus 100′ may control the display 160 based on a user voice signal received through the microphone 180. For example, when a user voice signal for displaying content A is received, the electronic apparatus 100′ may control the display 160 to display content A.

As another example, the electronic apparatus 100′ may control an external electronic apparatus connected to the electronic apparatus 100′ based on a user voice signal received through the microphone 180. Specifically, the electronic apparatus 100′ may acquire a control signal for controlling the external electronic apparatus to allow an operation corresponding to the user voice signal to be performed by the external electronic apparatus, and may transmit the acquired control signal to the external electronic apparatus. Here, the electronic apparatus 100′ may store a remote control application for controlling the external electronic apparatus. In addition, the electronic apparatus 100′ may transmit the acquired control signal to the external electronic apparatus using at least one communication method among Bluetooth, Wi-Fi, and infrared communication. For example, when a user voice signal for displaying content A is received, the electronic apparatus 100′ may transmit, to the external electronic apparatus, a control signal for controlling content A to be displayed on the external electronic apparatus. Here, the electronic apparatus 100′ may refer to various terminal apparatuses capable of installing a remote control application, such as a smartphone and an artificial intelligence (AI) speaker.

As another example, the electronic apparatus 100′ may use a remote control apparatus to control an external electronic apparatus connected to the electronic apparatus 100′ based on a user voice signal received through the microphone 180. Specifically, the electronic apparatus 100′ may transmit, to the remote control apparatus, a control signal for controlling the external electronic apparatus to allow an operation corresponding to the user voice signal to be performed by the external electronic apparatus. In addition, the remote control apparatus may transmit the control signal received from the electronic apparatus 100′ to the external electronic apparatus. For example, when a user voice signal for displaying content A is received, the electronic apparatus 100′ may transmit, to the remote control apparatus, a control signal for controlling content A to be displayed on the external electronic apparatus, and the remote control apparatus may transmit the received control signal to the external electronic apparatus.

The input/output interface 190 may be any one interface among a high definition multimedia interface (HDMI), a mobile high-definition link (MHL), a universal serial bus (USB), a display port (DP), Thunderbolt, a video graphics array (VGA) port, an RGB port, a d-subminiature (D-SUB), and a digital visual interface (DVI). The input/output interface 190 may input and output at least one of an audio signal or a video signal. According to an implementation example, the input/output interface 190 may include, as separate ports, a port for inputting and outputting only an audio signal and a port for inputting and outputting only a video signal, or may be implemented as one port for inputting and outputting both an audio signal and a video signal. Meanwhile, the electronic apparatus 100′ may transmit at least one of an audio signal or a video signal to an external electronic apparatus (e.g., an external electronic apparatus or an external speaker) through the input/output interface 190. Specifically, an output port included in the input/output interface 190 may be connected to the external electronic apparatus, and the electronic apparatus 100′ may transmit at least one of the audio signal or the video signal to the external electronic apparatus through the output port.

According to the above-described example, the electronic apparatus 100 may achieve a security advantage of a threshold signature without changing a verification environment of standard Dilithium by generating a threshold signature compatible with a verification algorithm of standard Dilithium using a homomorphic encryption technique.

According to the above-described example, the electronic apparatus 100 may significantly reduce the number of communication rounds and a communication amount compared to a Multi-Party Computation (MPC)-based threshold signature scheme by generating a threshold signature through only two communication rounds.

According to the above-described example, the electronic apparatus 100 may avoid evaluation of a hash function in a homomorphic operation region by restoring a commitment into plaintext and then determining a challenge in a plaintext state, and may thus significantly reduce time required for generating a threshold signature.

According to the above-described example, the electronic apparatus 100 may significantly improve a processing speed of a homomorphic operation compared to ciphertext-ciphertext multiplication by utilizing plaintext-ciphertext multiplication between a challenge in a plaintext state and a homomorphically encrypted secret vector.

According to the above-described example, the electronic apparatus 100 may avoid inefficiency caused by evaluating a security hash algorithm-based pseudo-random function in a homomorphic operation region by generating a mask in the homomorphic operation region using a homomorphic-friendly pseudo-random function (PRF).

According to the above-described example, the electronic apparatus 100 may efficiently implement, in a homomorphic operation region, the standard Dilithium signature algorithm in which modular arithmetic and comparison operations are mixed by using a first homomorphic encryption scheme (e.g., BFV) for an operation corresponding to modular arithmetic and using a second homomorphic encryption scheme (e.g., CKKS) for an operation corresponding to a comparison operation.

According to the above-described example, the electronic apparatus 100 may efficiently process, in a homomorphic operation region, a repeated operation according to rejection sampling of the standard Dilithium signature algorithm by performing a plurality of signing attempts in parallel, and may thus improve a success probability of a threshold signature.

According to the above-described example, the electronic apparatus 100 may prevent a security attack based on an unused response candidate by adopting only a response candidate identified first among a plurality of response candidates as a response.

According to the above-described example, the electronic apparatus 100 may protect a decryption key for homomorphic encryption and a threshold signature even when partial decryption keys of some electronic apparatus are leaked by performing a threshold signature operation using a partial decryption key distributed according to the secret sharing scheme.

According to the above-described example, the electronic apparatus 100 may prevent residual information of a homomorphic operation from being exposed to the outside by adding flooding noise to a partial decryption result, and may thus ensure security of a threshold signature.

According to the above-described example, the electronic apparatus 100 may operate for an arbitrary threshold and the number of participants and may minimize an effect caused by a change in the threshold or the number of participants, and may therefore be applied to various environments.

According to the above-described example, the electronic apparatus 100 may significantly reduce processing time in an online phase after a message arrives by performing, in advance in an offline phase before the message arrives, an operation independent of the message among threshold signature operations.

According to the above-described example, as most operations other than a partial decryption operation among homomorphic operations for a threshold signature do not use secret information, the electronic apparatus 100 may delegate the homomorphic operations to an external server, and may thus reduce an amount of software to be protected and increase processing efficiency by utilizing the external server having powerful computational resources.

According to the above-described example, the electronic apparatus 100 may reduce a size of a partial decryption result compared to a security analysis based on statistical distance by determining a magnitude of flooding noise based on a security analysis based on Rényi divergence.

According to the above-described example, the threshold signature scheme according to the present disclosure may perform a plurality of signing attempts in parallel by utilizing a Single Instruction Multiple Data (SIMD) characteristic, and may thus ensure improved processing efficiency of a homomorphic operation.

According to the above-described example, the threshold signature scheme according to the present disclosure may securely construct a threshold signature system without a trusted dealer by distributing partial decryption keys based on a distributed key generation (DKG) protocol.

Hereinafter, technical details, security analysis, and experimental verification results of the threshold signature scheme according to the present disclosure will be described in more detail. These details are intended to support specific implementation examples and effects of the threshold signature scheme according to the present disclosure, and the scope of the present disclosure is not limited to these details.

The present disclosure proposes THED, which is a threshold version of a Dilithium signature scheme, module-lattice-based digital signature algorithm (ML-DSA). A signature issued by a scheme according to the present disclosure is valid for a verification algorithm of standard Dilithium. A signing protocol according to the present disclosure includes two communication rounds, and one of the communication rounds has a form suitable for preprocessing. The scheme according to the present disclosure supports an arbitrary number of participants and an arbitrary threshold parameter.

A configuration according to the present disclosure is based on executing a Dilithium signature algorithm in a Threshold Fully Homomorphic Encryption (hereinafter, ThFHE) region, except that only derivation of a signing challenge is performed in a plaintext domain. Due to types of operations performed, the present disclosure relies on a CKKS scheme for homomorphic operations. However, as a number of challenges remain, the present disclosure develops new tools for solving the challenges. In particular, the present disclosure proposes a CKKS-BFV continuum that assists in modular operations in an environment in which non-arithmetic operations are performed together, a hybrid-format homomorphic comparison for a case in which an encrypted input is a sum of a bit-decomposed integer and a small integer, and a modulus-thrifty homomorphic comparison scheme for a relatively large integer that is not bit-decomposed.

A proof-of-concept implementation for homomorphic encryption components of the signing protocol according to the present disclosure operates in less than 1.3 seconds on an RTX-5090 GPU with a communication amount of 23.6 KB per participant for a National Institute of Standards and Technology (NIST) level-2 Dilithium variant. Most operations may be performed in an offline phase not dependent on a message to be signed, and in this case, an online cost is reduced to less than 0.25 seconds. Except for two decryption steps, these operations are entirely public, and may therefore be delegated to a server having more powerful hardware.

### Section 1. Introduction

As Dilithium/MIL-DSA is adopted by the National Institute of Standards and Technology (NIST) as a main algorithm for post-quantum signatures, Dilithium/ML-DSA is being rapidly introduced into various environments. Similar to all signature schemes, a signature key is particularly sensitive and requires separate protection. A threshold signature is a classical approach for strengthening availability and security of signature issuance by distributing a signature key to a plurality of participants. That is, when too few participants participate in a protocol, a signature passing verification should not be generated, and when a sufficient number of participants cooperate, a valid signature should be generated. For this reason, threshold versions of Dilithium are actively being researched. Considering that Dilithium is standardized, a particularly desirable property in a threshold Dilithium protocol is verification interchangeability with non-threshold Dilithium. That is, a signature generated by the threshold Dilithium protocol should be recognized as a valid signature by a verification algorithm of standard Dilithium.

Dilithium is an optimized version of Lyubashevsky's lattice-based signature scheme. The latter follows a Fiat-Shamir blueprint like a Schnorr signature, and includes a linear step, a challenge generation step based on hash function evaluation, another linear step, and rejection verification. Although a number of threshold signature schemes are constructed by modifying Lyubashevsky's signature scheme, most of the schemes do not handle optimization techniques of Dilithium and do not satisfy verification interchangeability. In addition, some prior arts have restrictions, for example, being limited to an n-of-n case in which all users are required to cooperate to generate a valid signature, or being limited to a case in which the number of participants is 2. Main difficulties in constructing a threshold signature scheme compatible with Dilithium arise from signature compression and verification key compression techniques introduced in [BG14] and [DKL+18].

Several schemes satisfying verification interchangeability have been proposed relatively recently. Using secure Multi-Party Computation (MPC), Dufka et al. acquired a solution for a case in which a threshold and the number of participants are both 2 (t=n=2) [DKLS25]. Similarly, using MPC, Bienstock et al. acquired a solution for an arbitrary threshold t and an arbitrary number of participants n [BdCE+26]. However, tens of communication rounds and a communication amount of megabytes per user are required. A more direct application of ML-DSA was proposed in [BCdP+25], which has an advantage in that only three communication rounds are required. However, the threshold and the number of participants are limited to 6 or less (t, n≤6).

From a theoretical viewpoint, it is known by [BGG+18] that any deterministic signature scheme may be converted into a one-round threshold version. This universal thresholdizer is based on Threshold Fully Homomorphic Encryption (ThFHE). Threshold Fully Homomorphic Encryption is a variant scheme of fully homomorphic encryption (FHE) introduced by [AJL+12, BGG+18], in which decryption authority is distributed to a plurality of participants. That is, participants having decryption authority may open a ciphertext through cooperation in a one-round protocol. According to the threshold signature construction of [BGG+18], all users are provided with an FHE ciphertext of a signature key, and accordingly, when a message to be signed is given, all users may locally derive an FHE ciphertext of a common signature for the message. To generate a plaintext signature, the participants execute a distributed decryption protocol of threshold fully homomorphic encryption. This universal construction generates a signature compatible with an original signature scheme, and may be applied to Dilithium. This approach was reviewed in [ASY22] with a focus on removing rejection sampling for a basic signature scheme of Lyubashevsky. Directly applying the construction of [BGG+18] to Dilithium is challenging in that a Dilithium signature algorithm includes heterogeneous types of operations such as modular operations, integer operations, and bit operations, and Fully Homomorphic Encryption may be inefficient for general operations. In addition, the Dilithium signature algorithm includes a while loop, which is cumbersome to apply to a circuit-based homomorphic operation model.

Contributions. The present disclosure proposes THED, which is the first concrete FHE-based threshold signature scheme satisfying verification interchangeability with Dilithium. Concrete security of the scheme (in a selective and passive model) according to the present disclosure is identical to that of Dilithium. The construction according to the present disclosure is based on the universal thresholdizer of [BGG+18], and includes modification and instantiation techniques for achieving practical efficiency through only two communication rounds.

For efficient homomorphic evaluation of a Dilithium signing operation, the present disclosure introduces the concept of a CKKS-BFV continuum utilizing both CKKS and BFV homomorphic encryption schemes (Section 4.1). Specifically, the present disclosure utilizes the BFV scheme for efficient arithmetic over a Dilithium ring (i.e., a polynomial ring of integer coefficients modulo 8380417 (the polynomial ring having, as a modulus, a polynomial acquired by adding 1 to a 256-th power of X) (Section 4.3)), and utilizes the CKKS scheme for fast arithmetic at various precisions (Section 4.4). From a viewpoint of the CKKS scheme, a plurality of methods for high-precision homomorphic comparison are further introduced. One method is a general method extending [CKK20] and [CCK+24] (Section 4.2), and another one is a method specialized for a Dilithium ring using bit decomposition [KN24] and binary gates.

The present disclosure creates a proof-of-concept implementation for a homomorphic operation part of THED for NIST level-2 Dilithium instantiation based on an implementation [CKKS17] of the CKKS homomorphic encryption scheme provided by Homomorphic Encryption for Arithmetic of Approximate Numbers (HEaaN) library [CRY22]. When a probability of successfully generating a signature is p=0.870, the scheme according to the present disclosure takes 1.240 seconds on an NVIDIA RTX 5090 GPU. A communication amount per participant is 23.6 KB when assuming up to 128 decryption participants in a synchronous environment of [MBH23]. In addition, a first-round operation of the scheme according to the present disclosure may be processed independently of a message, and may therefore be preprocessed, and processing time is reduced to 0.198 seconds when preprocessing is not considered. In addition, all homomorphic operations except for threshold decryption may be performed publicly, and may therefore be delegated to an external server. When the protocol fails to generate a valid signature, the protocol may be restarted. Alternatively, a signature may be generated with a probability arbitrarily close to 1 by executing the protocol several times in parallel.

Comparison. Comparing the scheme according to the present disclosure with other conventional approaches [DKLS25, BdCE+26, BCdP+25] for threshold Dilithium is as follows. The FHE-based solution according to the present disclosure has the following advantages.

First, the scheme according to the present disclosure operates for all threshold values t and numbers of participants n, and scales well for these parameters. The main impact is a decryption modulus appearing in both rounds. That is, the decryption modulus increases operation and communication complexity in a pre-decryption step. This dependency is significantly reduced by [BFM+25], and may be almost entirely removed according to [MBH23] when it is assumed that decryption participants know who the participants are. Most homomorphic operations are independent of the threshold t and the number of participants n, and the number of communication rounds is also the same.

Second, the scheme according to the present disclosure requires only two communication rounds. Such a requirement is compared with 3 rounds of [BCdP+25] and 20 or more rounds of MPC-based approaches [DKLS25, BdCE+26]. Although the latter may benefit from a tradeoff between a communication amount and the number of rounds, the communication amount already reaches megabytes even when the number of rounds is not minimized. In terms of a communication amount, the scheme according to the present disclosure involves communication of tens of KB per participant, which is similar to [BCdP+25] when the threshold t is 3 or less, and is significantly smaller otherwise.

Third, almost all operations may be performed publicly. That is, only a decryption key and a decryption step of Threshold Fully Homomorphic Encryption are secret, and homomorphic operations may thus be delegated to a device having powerful computational resources. Such public execution indicates that an amount of software to be protected is significantly small.

A main disadvantage of the approach according to the present disclosure is high computational cost. However, as mentioned above, most operations are public and may be delegated to powerful computational resources. A main alternative for an arbitrary threshold t and an arbitrary number of participants n is the scheme according to [BdCE+26]. However, high communication amount and round complexity quickly translate into high processing time in an environment in which participants are distributed.

Security Model. The present disclosure focuses on passive security for simplification. However, active security may be achieved by adding zero-knowledge proofs for honest partial decryption of Threshold Fully Homomorphic Encryption consistent with public commitments of distributed decryption key fragments. According to this addition, robustness having identifiable aborts may be provided without an honest majority assumption. Statements to be proved are linear statements having small size constraints as common in lattice-based cryptography, and [BS23, LNP22, NS24, HLSS25] may be referred to for potential instantiations.

In addition, the present disclosure may appear to rely on a trusted dealer in key generation. However, using distributed key generation of Threshold Fully Homomorphic Encryption according to [MHPS25] enables fast CKKS operations, and homomorphic evaluation of a key generation algorithm of Dilithium may be performed. Accordingly, an efficient distributed key generation protocol not relying on a trusted dealer may be provided.

### Section 1.1. Technical Overview

A main difficulty when applying [BGG+18] to convert a signature scheme into a threshold version is finding a method of efficiently implementing various steps of a THED signature algorithm in a homomorphic operation region. From this viewpoint, Dilithium involves a number of difficulties as follows (The following step numbers are step numbers for the Sign algorithm of Algorithm 4, which restates the Dilithium signature scheme).

First, Dilithium uses a SHAKE hash function for expansion of a part of a verification key (Step 1), hashing of a message (Steps 2 and 4), generation of a signing mask (Step 6), and generation of a signing challenge (Step 9).

Second, Dilithium includes rejection sampling. That is, when any one of four rejection verifications (Steps 13 and 17) is not passed, a signing process is required to be restarted.

Third, all rejection verifications are based on comparison operations, and sometimes include comparison operations on integers from which high bits and low bits are extracted (which is performed through HighBits, LowBits, and MakeHint functions of Steps 8, 12, and 16).

Fourth, although a main data type is an integer, some operations include modular operations (Step 7), other operations are operations on an integer ring (Step 11), and yet other operations include comparison operations, as described above.

Hereinafter, although a method for solving the difficulties according to the present disclosure will be described, selection of the homomorphic encryption scheme is first discussed before description of the method. As an amount of data on which homomorphic operations are required to be performed is considerable, homomorphic encryption schemes providing Single Instruction Multiple Data (SIMD) operations, such as BGV [BGV12], BFV [Bra12, FV12], and CKKS [CKKS17], seem more suitable for threshold-version conversion of Dilithium than latency-oriented schemes [CGGI16, DM15]. Among these throughput-oriented schemes, the present disclosure adopts CKKS, because CKKS enables relatively efficient homomorphic comparison according to [CKK20] based on polynomial approximation over real numbers. In contrast, in the case of BFV or BGV, comparison is performed using interpolation over a finite field [IZ21]. In CKKS, the most time-consuming operation is bootstrapping [CHKKS18]. Bootstrapping is an operation of increasing a ciphertext modulus while preserving plaintext. This operation is required to be performed periodically because the ciphertext modulus decreases due to multiplication during homomorphic operations. For efficient CKKS evaluation, an effort is required to be made to minimize the number of bootstrappings, and the design of the present disclosure is motivated by this goal.

Homomorphic evaluation of the SHAKE hash function has been little studied in conventional literature. A conventional state-of-the-art approach [HCLK25] relies on [CGGI16, DM15], and evaluation of a single SHA3 round function takes more than one hour on a single-thread CPU. In addition, data to be hashed to acquire a signing challenge amounts to several kilobytes, and a hashing cost increases linearly in proportion to the amount of data to be hashed. The present disclosure avoids this high cost using several methods as follows. First, it is recognized that some calls to the SHAKE hash function may be performed publicly because the calls do not include a secret value. That is, expansion of a uniform part of a verification key (Step 1) and hashing of a message (Steps 2 and 4) correspond thereto. Second, it is recognized that the SHAKE hash function is used as a pseudo-random function (PRF) in generation of a signing mask (Step 6). As a deterministic signature scheme is considered, a PRF key is a part of a signature key and is provided in an encrypted form. The present disclosure replaces the SHAKE hash function with a PRF more friendly to homomorphic operations, that is, a Learning-With-Rounding Darkmatter PRF according to [BIP+18]. To further improve efficiency of the scheme according to the present disclosure, matrix-vector multiplication is replaced with polynomial ring multiplication. Here, the polynomial ring is selected as the same as the ring of CKKS. Although this change generates a signature different from a signature of standard Dilithium, the change does not prevent achieving verification interchangeability. Finally, the present disclosure generates the signing challenge in a plaintext domain by decrypting an input of the challenge using a distributed decryption algorithm of Threshold Fully Homomorphic Encryption (Step 9). For this reason, the scheme according to the present disclosure has two communication rounds instead of a single round acquired by directly applying [BGG+18].

Use of rejection sampling indicates that a signature algorithm is cumbersome to express as a circuit. When a probability of passing verification is p, a distribution of the number of signing attempts follows a geometric law having parameter p. Such a distribution is difficult to process in a circuit-based homomorphic operation model. This difficulty was avoided in [ASY22, GKS24, dPKM+24, KRT24, EKT24, CATZ24, BKL+25] by completely removing rejection sampling. Although this avoidance is supported by a security proof based on Rényi divergence instead of statistical distance, the avoidance causes an increase in parameters. In addition, this approach requires a parameter change and handles only one of four rejection verifications of Dilithium, and thus seems not to comply with verification interchangeability. The present disclosure adopts a more direct approach. That is, the present disclosure performs a plurality of signing attempts in parallel by utilizing a high dimension of a CKKS plaintext vector. Meanwhile, a plurality of attempts may all be successfully completed. To output only a single signature, the present disclosure preserves only a first successful signature and discards the remaining signatures in a homomorphic operation region. On the other hand, although repetition of the protocol increases a success probability, excessively increasing the number of parallel attempts may impair performance, and the success probability is thus maintained non-negligibly away from 1.

For homomorphic comparison, the present disclosure relies on [CKK20]. A multiplication depth consumed by [CKK20] rapidly increases according to the number of bits of integers to be compared. In CKKS, depth consumption is critical because, when the multiplication depth is large, bootstrapping for increasing a ciphertext modulus again is required, and bootstrapping has a high cost compared to basic homomorphic operations. In a context of the present disclosure, an integer to be compared may have up to 20 bits. According to calculations of the present disclosure, this comparison may require up to four bootstrappings for typical parameters of [CRY22] in which a ring degree is N=2\hat{ }16. The present disclosure simplifies some verifications as follows (For a description of Dilithium, see Algorithm 4).

First, verification of Step 17 is performed on data known to signers in plaintext, which may be seen by rewriting (a value acquired by subtracting (a product of c and s_2) from w) as (a value acquired by subtracting (a product of c and t) from (a product of A and z)), and recognizing that t may be provided to the signers without affecting security.

Second, for the remaining verification (which is a first half of Step 13), it is recognized that an encrypted input is a sum of two integers, one of which is known in a binary decomposition form due to a manner in which the signing mask is generated, and another one of which is a relatively small value. For this case, the present disclosure uses a hybrid comparison scheme based on a tree structure for high bits and based on [CKK20] for low bits.

Here, the remaining comparison of Step 13 remains. For the remaining comparison, a scheme extending [CKK20] in terms of modulus-thrifty is used, and the scheme according to the present disclosure gradually decreases precision during operations. That is, as plaintext becomes closer to 0 or 1, smaller precision is required.

Homomorphic extraction of high/low bits for integers having this number of bits is similarly challenging. To this end, the present disclosure uses an iterative bootstrapping technique according to [KN24] to convert an integer into a radix decomposition form. Next, high/low bits are extracted using modular reduction for two moduli. Processing for a first modulus is easier because binary decomposition of a Dilithium modulus is sparse, and processing for a second modulus is implemented using thrifty comparison.

Here, a method for performing modular multiplication in a context of CKKS ciphertexts will be described. Modular multiplication is required for PRF evaluation (which replaces Step 6 as described above) and for derivation of a value to be input to a hash function generating a signing challenge (Step 7). To this end, the present disclosure recognized that CKKS may be smoothly converted into BFV and vice versa. The present disclosure intends to utilize characteristics of both schemes, because CKKS is suitable for comparison and BFV is more suitable for modular operations. Assume that a CKKS ciphertext (a, b) is given. Here, a degree N of a polynomial is a power of 2, Q is a large integer, and a polynomial ring is (an N-th degree polynomial ring of integer coefficients modulo Q (i.e., a polynomial ring having, as a modulus, a polynomial acquired by adding 1 to an N-th power of X)). In addition, assume that the ciphertext is decrypted into an N/2-dimensional binary vector m. Specifically, the following relationship is satisfied.

That is, a result acquired by adding b to (a product of a and a secret key s) is congruent modulo Q to a result acquired by applying an inverse discrete Fourier transform (DFT\hat{ }−1) to (a value acquired by adding an error term e to a value acquired by multiplying a scale factor Delta by the binary vector m). Here, the secret key s is an element of the polynomial ring, DFT refers to a map from the polynomial ring to an N/2-dimensional complex vector, and an infinity norm of the error term is less than (one fourth of the scale factor). As recognized in [DMPS24], by applying a cleaning map h_1 according to [CKK20] (i.e., a map that maps an input x to (a value acquired by subtracting (a product of 2 and a cube of x) from (a product of 3 and a square of x))), the scale factor may be essentially squared while maintaining the same message m, and the infinity norm of the error term may also be maintained similarly. However, application of the cleaning map h_1 involves a cost of reducing the modulus Q by (a polynomial function of the scale factor). By repeatedly applying the cleaning map h_1, a gap between the error term and the message may be rapidly increased. Next, DFT may be evaluated homomorphically to acquire a pair of new ciphertexts (a′, b′), and here, the following relationship is satisfied for the new ciphertexts. That is, (a value acquired by adding b′ to (a product of a′ and the secret key)) is congruent, modulo a new modulus Q′, to (a value acquired by adding a new error term e′ to a value acquired by multiplying a new scale factor Delta′ by the message m)). Here, the new scale factor Delta′ is significantly greater than the previous scale factor Delta, and an infinity norm of the new error term is significantly smaller than the new scale factor. A ciphertext expressed by the relationship corresponds to a BFV ciphertext of the message m for (the nearest integer to a quotient acquired by dividing the new modulus Q′ by a BFV plaintext modulus t). Effectiveness of the approach may be quantified by (a decrease in the modulus Q relative to an increase in the scale factor). Recently, it has been known in [CKSS25] that (a ratio acquired by dividing Q by Q′) may be made almost equal to (a ratio acquired by dividing Delta′ by Delta) (i.e., a decrease ratio of the modulus and an increase ratio of the scale factor may be made almost identical).

In contrast, for evaluation of the Darkmatter PRF (which replaces Step 6), it is appropriate to start in a BFV format and end in a CKKS format for subsequent operations. The PRF according to the present disclosure is evaluated as follows. That is, an input x is mapped as follows. That is, a result of performing modular reduction on (a product of a PRF key alpha and the input x) with respect to (a product of two small integers p and q, i.e., pq), dividing the result by p, and then rounding the result to the nearest integer. Here, p and q are significantly small integers, and the PRF key alpha is provided in an encrypted form as an element of a polynomial ring modulo pq. In the present disclosure, although it is not necessary to use the same ring as the polynomial ring used for the FHE scheme for the PRF, using the same ring simplifies description and operations. Multiplication modulo pq may be performed in a BFV format, and rounding may then be applied while bootstrapping to a CKKS ciphertext according to [BKSS24]. Accordingly, a signing mask represented by q-ary digits is provided in a state encrypted in a CKKS format. This digit-decomposed representation is itself suitable for acquiring efficient homomorphic implementation of the last rejection verification described above (i.e., the first half of Step 13).

Overall homomorphic operations consume exactly 10 CKKS bootstrappings before a first communication round, and then further consume 3 CKKS bootstrappings. In addition, homomorphic operations up to the first communication round may be processed independently of the message, and may therefore be considered as offline operations.

Security Aspects. Generating the challenge in a plaintext domain reduces a burden on homomorphic evaluation of the signature algorithm. However, the two-round characteristic of the threshold signature protocol causes more security issues compared to direct application of the universal thresholdizer [BGG+18]. In particular, because a plurality of signing attempts are executed in parallel when making a signing query (by utilizing the SIMID characteristic of CKKS), an attacker may see not only challenges of failed signing attempts but also challenges of successful signing attempts discarded in a process of issuing a single signature.

In the security proof, the present disclosure starts from an assumption that deterministic Dilithium is secure when using the Darkmatter PRF for the signing mask (Step 6 of Algorithm 2), and also relies on recent security analysis according to [BdCE+26] (which is inspired by [DFPS23, dPN25]). The latter proves that Dilithium is secure even when an attacker has oracle access to aborted transcripts, that is, even when the attacker may see a commitment of Step 8 for a rejected signature, and both unselected accepted signatures and selected accepted signatures. To this end, the authors of [BdCE+26] modified Dilithium by adding a small error term e to Step 7. This modification does not affect verification interchangeability and does not have a noticeable effect on correctness. The security proof according to the present disclosure then follows the blueprint of [ASY22]. Oracle queries for Round 1 are simulated from aborted transcripts, and oracle queries for Round 2 are simulated using a full signature query (including a full Round-1 transcript). As in [ASY22], the present disclosure relies on Rényi divergence to minimize an amount of noise in decryption of Threshold Fully Homomorphic Encryption.

Implementation Aspects. As mentioned above, the present disclosure relies on the HEaaN library [CRY22] implementing the CKKS scheme. Because small plaintext precision for storing bits and significantly large plaintext precision for combining noise flooding with modular operations having a large number of bits are flexibly used, the present disclosure uses a modified version of the library incorporating the grafting technique of [CCK+24]. To increase precision of binary plaintext, the present disclosure relies on the technique of [CKSS25] that saves modulus consumption. For noise flooding, an upper bound for a noise magnitude of a ciphertext to be decrypted is required. In addition, to avoid an attack of [CCP+24] based on bootstrapping failure, the present disclosure uses sparse secret encapsulation of [BTH22] (note that sparse secret encapsulation is supported by the protocol of [MHPS25]).

Other Related Works. The CKKS-BFV continuum introduced in the present disclosure is related to a series of recent studies. Conventionally, use of a scale factor close to a modulus for bootstrapping exact data was reviewed in [BGGJ20, BCKS24, BKSS24]. In [KN24, AKP25], it was recognized that this approach may be used to perform modular reduction. In [BK25], this approach was used to perform modular multiplication. That is, [BK25] performs multiplication in an integer ring using CKKS encoding of an N/2-dimensional complex vector, converts the result into a polynomial through homomorphic DFT, and then performs modular reduction. This approach is different from the approach of the present disclosure. The present disclosure performs modular operations by considering a CKKS ciphertext having a large scale factor as a BFV ciphertext.

Conversion from CKKS to BFV may seem to contradict [EGM23]. [EGM23] asserts that conversion from CKKS to BGV enables fast bootstrapping of BGV. Although the present disclosure focuses on BFV, a BFV ciphertext may be converted into a BGV ciphertext through scalar multiplication, and vice versa. In fact, no contradiction exists. That is, although the conversion of the present disclosure assumes that the message m is binary, conversion-based BGV bootstrapping of [EGM23] is required to handle a message m having, as entries, integers greater than a BGV plaintext modulus. In the present disclosure, such an integer may be converted into bits and the method according to the present disclosure may be applied. However, the cost of bit extraction is non-negligible compared to CKKS and BGV bootstrappings. Meanwhile, bit extraction was reviewed in [CKSS25] as an alternative path for CKKS bootstrapping.

When conversion from CKKS to BFV is combined with small-integer functional bootstrapping of [BKSS24], CKKS-based bootstrapping for a BFV ciphertext is provided for a small plaintext modulus. This bootstrapping is different from CKKS-based BFV bootstrapping of [KSS24]. Although CKKS-based BFV bootstrapping of [KSS24] operates for an arbitrary plaintext modulus, CKKS-based BFV bootstrapping of [KSS24] relies on high-precision CKKS bootstrapping [BCC+22, CKSS25].

### Section 2. Preliminaries

Due to space constraints, this section focuses on main definitions. Additional definitions and preliminaries are discussed in Appendix A. In particular, a definition of Fully Homomorphic Encryption and a method of converting the same into a threshold version in a context of threshold signatures (using Rényi divergence instead of statistical distance for noise flooding) are discussed.

A Hamming weight of a binary vector h is denoted by HW(h). For a positive real number eta, a one-dimensional Gaussian function rho_eta is defined as follows. That is, for an input x, the Gaussian function is (a function acquired by multiplying (a value acquired by dividing 1 by eta) by (an exponentiation of a natural constant e, where an exponent is (a value acquired by multiplying negative pi by (a square of an absolute value of x)) divided by (a square of eta)))). When a random variable X over real numbers follows a Gaussian distribution having a standard deviation eta and a center c (where c is a real number), the Gaussian distribution is denoted by D_(eta, c). That is, a density function of the Gaussian distribution is a function mapping an input x to (the Gaussian function rho_eta for (a value acquired by subtracting c from x)). The definition may be extended to an N-degree polynomial. That is, D_(N, eta, c) refers to a distribution of an N-degree polynomial in which an i-th coefficient is sampled from D_(eta, c_i), where c_i is an i-th coefficient of c.

### Section 2.1. Threshold Signatures

A definition of threshold signatures is revisited. Intuitively, a t-of-n threshold signature distributes a signature key to n participants, thus allowing a subset of participants equal to or greater than a threshold t to cooperatively sign any message, while preventing a subset of participants smaller than the threshold t from issuing a valid signature. The present disclosure focuses on a threshold signature having two communication rounds in a semi-honest model.

Definition 1. A two-round threshold signature scheme is a tuple of Probabilistic Polynomial-Time (PPT) algorithms including KeyGen, PartSign1, Combine1, PartSign2, Combine2, and Verify, and is defined as follows.

The KeyGen algorithm receives, as inputs, a security parameter lambda, the number of participants n, and a threshold t, and outputs public parameters pp, a verification key vk, and partial signature keys sk_i for each of n participants.

The PartSign1 algorithm receives, as inputs, the public parameters pp, a partial signature key sk_i of an i-th participant, and a message M, and outputs a round-1 contribution out_(1, i).

The Combine1 algorithm is a deterministic algorithm, receives, as inputs, the public parameters pp and t round-1 contributions, and outputs a round-2 input message out_1.

The PartSign2 algorithm receives, as inputs, the public parameters pp, the partial signature key sk_i, the round-2 input message out_1, and the message M, and outputs a round-2 contribution out_(2, i).

The Combine2 algorithm is a deterministic algorithm, receives, as inputs, the public parameters pp and t round-2 contributions, and outputs a signature sigma.

The Verify algorithm receives, as inputs, the verification key vk, the message M, and the signature sigma, and outputs a bit b of 0 or 1.

Correctness. For a positive real number epsilon, when, for any message M and any two subsets S_1 and S_2 having a size corresponding to the threshold t among n participants, a probability that the Verify algorithm outputs 1 is equal to or greater than (a value acquired by subtracting epsilon from 1), the scheme according to the present disclosure is known to be epsilon-correct. Here, the public parameters, the verification key, and the partial signature keys are generated by the KeyGen algorithm, the round-1 contributions are derived by the PartSign1 algorithm for all participants belonging to the subset S_1, the round-2 input message is a result acquired by applying the Combine1 algorithm to the round-1 contributions of the subset S_1, the round-2 contributions are derived by the PartSign2 algorithm for all participants belonging to the subset S_2, and the signature is a result acquired by applying the Combine2 algorithm to the round-2 contributions of the subset S_2. In addition, the probability is taken over random coins of the KeyGen, PartSign1, and PartSign2 algorithms.

Compactness. When a polynomial p exists, and when, for any message M and any two subsets S_1 and S_2 having a size equal to or greater than the threshold t, using the same notation for correctness, bit sizes of the verification key and the signature are equal to or less than (a value of the polynomial p for the security parameter lambda), the scheme according to the present disclosure is known to satisfy compactness.

Threshold Unforgeability. For any PPT attacker A, when a probability that an output of a security game Exp_A\hat{ }thuf is 1 (i.e., an advantage Adv\hat{ }thuf(A) of the attacker is negligible), the scheme according to the present disclosure is known to satisfy threshold unforgeability. Here, the security game Exp_A\hat{ }thuf is defined as Algorithm 1.

Algorithm 1: Definition of Security Experiment Exp_A\hat{ }thuf

```
Exp_A\hat{ }thuf (lambda, n, t):
1. L <- empty set
2. W <- empty set
3. S_cor <- A(1\hat{ }lambda); provided that S_cor is a subset of [n]
  A. |S_cor| =t - 1
4. (pp, vk, (sk_i)_{i in [n]}) <- KeyGen(1\hat{ }lambda, 1\hat{ }n, 1\hat{ }t)
5. (sigma*, M*) <- A\hat{ }{O.PartSign1, O.PartSign2}
    1. (pp, vk, (sk_i)_{i in S_cor})
6. return (Verify(vk, M*, sigma*) = 1)
      and ((M*, sigma*) is not included in L)
PartSign1 (i, M):
    1. if i belongs to S_cor then return bot
    2. out_(1, i) <- PartSign1(pp, sk_i, M)
    3. for j in S_cor: out_(1, j) <- PartSign1(pp, sk_j, M)
    4. out 1 <- Combine1(pp, (out_(1, j))_{j in the union of S_
    cor and {i}})
    5. W <- union of W and {(M, out_1)}
    6. return out_(1, i)
PartSign2 (i, out_1, M):
    (1) if (i belongs to S_cor) or ((M, out_1) does not belong to W)
    then return bot
    (2) out_(2, i) <- PartSign2(pp, sk_i, out_1, M)
    (3) for j in S_cor: out_(2, j) <- PartSign2(pp, sk_j, out_1, M)
    (4) sigma <- Combine2(pp, (out_(2, j))_{j in the union of S_
    cor and {i}})
    (5) L <- union of L and {(M, sigma)}
    (6) return out_(2, i)
```

(Algorithm 1 is an algorithm specification for the security experiment Exp_A\hat{ }thuf. Here, the attacker A receives the security parameter lambda and selects a set S_cor of t−1 corrupted participants, the challenger executes the key generation algorithm to generate the public parameters, the verification key, and the partial signature keys, and the attacker has access to partial signing oracles and generates a forgery (M*, sigma*). When verification is successful and the forged message-signature pair is not included in an oracle response list, the security game outputs 1).

### Section 2.2. CKKS

CKKS [CKKS17] is a Fully Homomorphic Encryption scheme based on ring-LWE [LPR10, SSTX09], in which plaintext is represented as an N/2-dimensional real vector. Here, N is a degree of a polynomial ring R\hat{ }FHE. A ciphertext for plaintext m has a form of a pair of two components (a, b), and the following relationship is satisfied (Equation 1).

That is, a result acquired by adding b to (a product of a and a secret key s) is the same, with respect to a modulus Q, as (a value acquired by adding an error term e to (a value acquired by multiplying a scale factor Delta by (a result acquired by applying plaintext m to an inverse discrete Fourier transform (DFT\hat{ }−1)))). Here, the secret key s is an element of the polynomial ring R\hat{ }FHE, the error term e has small coefficients, the scale factor Delta determines numerical precision, and DFT is a map that maps an element p of the polynomial ring R\hat{ }FHE to an N/2-dimensional complex vector (i.e., a tuple of values acquired by evaluating p at roots of unity zeta_i). Here, N/2 roots of unity zeta_i are N/2 roots selected from N roots of a polynomial acquired by adding 1 to (an N-th power of X), with no pair that is equal to or conjugate to each other.

CKKS essentially supports slot-wise homomorphic addition, slot-wise homomorphic multiplication, and a slot rotation operation by an arbitrary amount.

Homomorphic multiplication is performed by tensoring two input ciphertexts to acquire a triple element of the polynomial ring R\hat{ }FHE, and then converting the triple element back into a double element (i.e., relinearization). Due to these two steps, the scale factor increases from Delta to (a square of Delta). The scale factor is mapped back to Delta by a rescaling step. The rescaling step is performed by dividing the ciphertext by Delta and rounding the result, thereby reducing the ciphertext modulus by a factor of Delta. In contrast, homomorphic addition and slot rotation operations preserve the ciphertext modulus Q.

When the ciphertext modulus becomes significantly small as several homomorphic multiplications are sequentially performed, no further multiplication may be performed. A purpose of CKKS bootstrapping (BTS) [CHKKS18] is to allow additional homomorphic operations to be performed by increasing the ciphertext modulus again while preserving plaintext. Because bootstrapping is significantly costly compared to basic homomorphic operations, minimizing the number of bootstrappings is important for efficiency.

A basic encoding scheme for encoding plaintext into a ciphertext using DFT\hat{ }−1 as in Equation (1) is referred to as slot encoding. Another encoding scheme, i.e., coefficient encoding, is a scheme that does not apply DFT\hat{ }−1 in Equation (1). In this case, plaintext m belongs to an N-dimensional real vector. Although the coefficient encoding scheme is not suitable for slot-wise homomorphic multiplication, the coefficient encoding scheme enables homomorphic convolution operations. To convert from slot encoding (or coefficient encoding) to coefficient encoding (or slot encoding), DFT (or DFT\hat{ }−1) may be evaluated homomorphically. These operations are respectively referred to as S2C and C2S.

In the present disclosure, exact data is frequently encoded in both slots and coefficients. When plaintext m is binary and slot-encoded, any binary gate may be performed homomorphically. According to evaluation of a binary gate, the error term e relatively increases compared to the scale factor Delta, and accordingly plaintext entries become less clear. As presented in [DMPS24], accuracy of bits may be recovered again by homomorphically applying a cleaning map h_1 (i.e., a map that maps an input x to (a value acquired by subtracting (a product of 2 and a cube of x) from (a product of 3 and a square of x))). In addition, the cleaning map h_1 may also be used for pre-flooding cleaning. Meanwhile, as presented in [BCKS24], bootstrapping for binary plaintext may be significantly improved (which is referred to as Bits BTS). Based on [BGGJ20], this bootstrapping was extended to small integers in [BKSS24], and combined with arbitrary slot-wise lookup tables (which is referred to as Small integers BTS).

### Section 3. The THED Threshold Signature Scheme

This section describes a method of combining Dilithium with Threshold Fully Homomorphic Encryption to acquire an efficient two-round threshold signature scheme. First, a high-level description of the scheme according to the present disclosure is provided, and this construction is then described in detail, while modifications applied to Dilithium to improve efficiency of homomorphic operations (without impairing verification interchangeability) are described. In addition, the scheme according to the present disclosure is analyzed by modifying the analysis of [ASY22] to fit the two-round environment of the present disclosure. Most details for efficiently performing homomorphic operations are discussed in a separate section, Section 4.

### Section 3.1. Description

The present disclosure follows the blueprint of [BGG+18]. That is, a signature scheme is converted into a threshold version by homomorphically executing the signature scheme using an encrypted signature key and by allowing each signer to disclose partial decryption information for an encrypted signature. The underlying signature scheme is required to be deterministic (i.e., each signer is required to evaluate the same signature/ciphertext), and the present disclosure thus chooses to convert a deterministic variant of Dilithium into a threshold version.

The present disclosure faces the following two difficulties. First, a challenge is derived by evaluating SHAKE-256, which is a hash function particularly difficult to evaluate homomorphically. Second, when the signature algorithm is executed homomorphically, it is not possible to determine when awhile loop is required to terminate. The present disclosure avoids these difficulties as follows. First, the present disclosure adds one communication round, which allows signers to decrypt a commitment w_1 and perform evaluation of the hash function in a plaintext domain. Specifically, the signers decrypt w_1 after Step 8 of the Sign algorithm of Algorithm 4, and execute Steps 9 and 10 in the plaintext domain. Second, the present disclosure sets an upper bound L on the number of loop iterations to be executed and returns a first valid signature derived during all these iterations. Even when two or more successful iterations occur, only the first valid signature is disclosed.

In addition, similarly to the first difficulty, homomorphic sampling of a random value y is also a challenging task (Step 6). The reason is that SHAKE-256 is required to be homomorphically executed. To avoid this problem, the present disclosure adjusts random value generation by relying on a homomorphic-friendly pseudo-random function (PRF) based on [BIP+18]. This modification affects only an internal randomness distribution to thus preserve verification interchangeability, and does not affect security under an assumption that pseudo-randomness of the PRF holds. Details of the PRF design according to the present disclosure are provided in Section 3.2.

Accordingly, the threshold signature algorithm according to the present disclosure has the following structure.

L commitments w_1\hat{ }(i) (where i is from 1 to L) are homomorphically sampled.

L related challenges c\hat{ }(i) (where i is from 1 to L) are derived in the plaintext domain.

L corresponding responses z\hat{ }(i) (where i is from 1 to L) are homomorphically derived.

During homomorphic evaluation, the signers decrypt the result of (1) and execute (2) in the plaintext domain. Next, (3) is performed homomorphically, and only the result is decrypted. In addition, the homomorphic evaluation according to the present disclosure preserves only a first valid response, and accordingly only a single valid signature is disclosed. The two communication rounds according to the present disclosure correspond to two points in time at which the signers communicate partial decryption information, that is, end points of (1) and (3).

In the present disclosure, it should be noted that homomorphic operations from a start of the signing protocol until before the first communication round (excluding the first communication round) may be performed offline because dependency on the message may be removed. This operation may be preprocessed under an assumption that the signers agree on a value to be input to the PRF. For simplification, although the present disclosure uses the message as a default value, the value may be any unique identifier agreed by the signers. The identifier may be a message number, time, or other contextual data. According to this modification, the construction according to the present disclosure may be modified into a threshold signature having a preprocessing function. In this environment, it is emphasized that threshold decryption of the commitment is required to be disclosed only in an online phase after the message is known, because the commitment is not bound to the message to be signed. When the commitment is decrypted before the message is known, a random inhomogeneity in an overdetermined Solvable system (ROS) attack [BLLOR22] may become possible even in the semi-honest model.

In addition, it is noted that homomorphic operations (1) and (3) according to the present disclosure are deterministic and include only public information, may therefore be delegated to a server, and only partial decryption is required to be performed by the signers.

### Section 3.2. Construction

Here, the two-round threshold signature protocol according to the present disclosure is described in detail. An exact specification thereof is provided in Algorithm 2. This protocol is an instantiation of the above-described high-level idea with a number of modifications for improving efficiency. Hereinafter, these modifications and effects thereof are described at the end of this section. In addition, the present disclosure relies on a modification introduced in [BdCE+26], which is a modification allowing security of Dilithium to be proved even when an incomplete signature is disclosed by adding small noise to a commitment w.

Key Generation. The key generation algorithm samples Fully Homomorphic Encryption keys and distributes a decryption key to n participants. In addition, signature keys are sampled, and a signature key (which includes a PRF key used to deterministically derive randomness) is encrypted using the Fully Homomorphic Encryption scheme. The verification key is exactly the same as a verification key of the underlying signature scheme.

Distributed Signing. For signing a message M, the signers homomorphically evaluate a first part (Steps 1 to 8) of the signature scheme of Algorithm 4 using the encrypted signature key, and partially decrypt a resulting ciphertext (which encrypts L commitments w_1\hat{ }(i), where i is from 1 to L). Assuming that t different signers participate, their partial decryption information may be combined to restore L commitments, and L challenges c\hat{ }(i) (where i is from 1 to L) may be derived in the plaintext domain (Steps 9 and 10 of Algorithm 4). Finally, at least t signers homomorphically evaluate a second part (Steps 11 to 19) of the signature scheme of Algorithm 4, and partially decrypt a resulting ciphertext. Again, assuming that t different signers participate, partial decryption information may be combined. This time, the result is a signature. More precisely, the present disclosure considers the following signing protocol having two communication rounds.

Round 1. For a message M to be signed, the signers homomorphically evaluate Steps 1 to 8 of Algorithm 4 L times in parallel using the encrypted signature key, and partially decrypt a resulting ciphertext. The signers broadcast partial decryption information.

Round 2. After receiving the partial decryption information, each signer executes Combine1. Combine1 restores L commitments w_1\hat{ }(i) (where i is from 1 to L) by evaluating FinDec on t different pieces of partial decryption information. The latter information allows the signers to locally derive, in the plaintext domain, a challenge (i.e., a result acquired by applying a hash function H to a value acquired by concatenating M and an i-th commitment w_1\hat{ }(i)—a result acquired by applying the hash function H to a value acquired by concatenating the message M and the i-th commitment w_1\hat{ }(i)), and accordingly avoids hash function evaluation in a homomorphic operation region. Next, the signers homomorphically execute Steps 11 to 19 of Algorithm 4 to derive a ciphertext encrypting L responses z\hat{ }(i), preserve only the first valid response, and partially decrypt the same. The signers broadcast the partial decryption information.

Finalization. After receiving the partial decryption information of Round 2, the signers combine t different partial decryption information using FinDec to restore a valid response z\hat{ }(k) (i.e., a response that is not invalid, under an assumption that signing is successful). Here, Combine2 returns (z\hat{ }(k), h\hat{ }(k), c~\hat{ }(k)) as a signature for the message M.

A detailed protocol is described in Algorithm 2. As seen above, the present disclosure slightly modifies steps of the original Dilithium signature algorithm (Algorithm 4). This modification is intended for performance improvement and improved security analysis. That is, the present disclosure modifies sampling of y (Step 6 of Algorithm 4), adds noise to derivation of w (Step 7 of Algorithm 4), modifies rejection sampling based on r_0 (Steps 12 to 14 of Algorithm 4), and delays derivation of MakeHint (Step 16 of Algorithm 4). Here, these changes are described in more detail.

Sampling of y and e. Using ExpandMask as a pseudo-random function (PRF) for generating y (Step 6 of Algorithm 4) is not efficient when derived in an encrypted state. The present disclosure replaces this PRF with a ring variant of a Darkmatter PRF according to [BIP+18]. For a given PRF key k_PRF and a polynomial m(X) (where m(X) is an element of an N-th degree polynomial ring of integer coefficients modulo 64), the Darkmatter PRF is output as follows (Equation 2).

That is, after (a product of m(X) and k_PRF(X)) is modularly reduced with respect to 64, the Darkmatter PRF is output as a result acquired by dividing the modular reduction result by 8 and rounding the divided value to the nearest integer. This output includes 3N random bits, from which y\hat{ }(k) and e\hat{ }(k) are extracted. Here, e refers to an error term added by the Dilithium modification according to [BdCE+26]. When N is (2\hat{ }16), this instantiation of the Learning-With-Rounding Darkmatter PRF achieves security significantly greater than 128-bit security against the best known attack (which may be verified using a lattice estimator [APS15]). This change is reflected in Steps 4 and 5 of PartSign1 of Algorithm 2. The present disclosure actually samples an error term e having 3-bit coefficients, slightly larger than [BdCE+26], which does not impair security, whereas correctness may be impaired. However, no noticeable effect on correctness was observed in experiments according to the present disclosure.

Rejection of z and r_0. The original rejection sampling for z (Steps 12 to 14 of Algorithm 4) requires high-precision comparison, which is inefficient when derived in an encrypted state. The present disclosure does not change this step, and may perform this comparison by utilizing encrypted comparison of small precision and binary decomposition of y. For comparison on r_0 (Step 13 of Algorithm 4), the present disclosure derives r′_0. Here, r′_0 is a result acquired by applying a LowBits_q function to w. The present disclosure emphasizes that this change has no effect. That is, the following two verifications have the same response.

Condition 1: A case in which an infinity norm of (a result acquired by applying a LowBits_q function (LowBits with respect to 2 multiplied by gamma_2) to (a value acquired by subtracting a product of c and s_2 from w)) is equal to or greater than (a value acquired by subtracting beta from gamma_2).

Condition 2: A case in which an infinity norm of (a value acquired by subtracting (a product of c and s_2) from (a result acquired by applying a LowBits_q function to w)) is equal to or greater than (a value acquired by subtracting beta from gamma_2).

The second verification is a verification actually executed in a public NIST submission implementation of Dilithium, and the first verification is a verification described in the specification. The two verifications have the same response. This change is reflected in Step 6 of PartSign2 of Algorithm 2. Derivation of r′_0 is performed immediately after deriving w in Step 7 of PartSign1 of Algorithm 2.

Rejection of Hint. Rejection sampling related to MakeHint (Step 17 of Algorithm 4) may also cause operation overhead during homomorphic signing. As recognized in [BdCE+26], rejection verification based on a hint vector h rarely fails in Dilithium (i.e., only about 2% of signatures passing without this verification are rejected). In addition, this verification does not serve any function in security. That is, h exists only to enable compression of a verification key. The present disclosure delays this verification, first generates a pre-signature z passing all other verifications, decrypts z, and then checks in the plaintext domain whether z passes this verification. It is noted that the hint vector h may be derived from z, w, t, and c through the following relationship. That is, (a value acquired by subtracting (a product of c and s_2) from w) is equal to ((a value acquired by subtracting (a product of c and t) from (a product of A and z))) (Equation 3).

Accordingly, the signers do not even need to derive h homomorphically, and after decrypting z, may derive h in the plaintext domain and check whether h passes verification. In 98% of cases, the hint vector h passes verification, and the signers may return (z, h, c~). In the remaining 2% of cases, the protocol is required to be restarted. Because the signing protocol is deterministic, signing for the message M is first attempted for a value acquired by concatenating (M, star, 0) (where star is a special symbol). Next, despite determinism, in the case of failure, signing for M may be attempted again using a value acquired by concatenating (M, star, 1) as an input.

Distributed Key Generation. In the above-described protocol and Algorithm 2, the present disclosure describes a key generation algorithm for threshold signatures under an assumption of a trusted dealer. However, it is noted that this assumption may be removed when there is a Distributed Key Generation (DKG) protocol for a Threshold Fully Homomorphic Encryption scheme. When the latter is provided, a DKG protocol may be executed to distribute (pk, evk, sk_1, . . . , sk_n), and each participant may encrypt randomness to homomorphically generate a seed, and then use the seed to homomorphically execute a KeyGen algorithm of Dilithium, thereby deriving ciphertexts of [[s_1]], [[s_2]], [[k_PRF]] and a verification key vk. A 4-round DKG protocol for CKKS was recently proposed in [MHPS25] (a more costly variant having fewer rounds was also proposed). Basically, although restoration of the verification key may require an additional round, the restoration may be performed without adding a communication round during DKG execution of [MHPS25].

Algorithm 2. THED Threshold
Dilithium Signature Protocol

```
KeyGen (1\hat{ }lambda, 1\hat{ }n, 1\hat{ }t):
1. (vk, sk) <- Dilithium.KeyGen
2. parse vk as (rho, t_1), and
3. parse sk as (rho, K, tr, s_1, s_2, t_0)
4. k PRF <- PRF.KeyGen(1\hat{ }lambda)
5. (pk, evk, sk_fhe) <- FheKeyGen(1\hat{ }lambda)
6. (sk_i)_{i in [n]} <- Share(sk_fhe, n, t)
7. ciphertext of Enc(s_1) <- Enc(pk, s_1)
8. ciphertext of Enc(s_2) <- Enc(pk, s_2)
9. ciphertext of Enc(k_PRF) <- Enc(pk, k_PRF)
10. pp <- (pk, evk,
  1. Enc(s_1), Enc(s_2), Enc(k_PRF),
  2. rho, tr, t_0, t_1)
11. return (pp, vk, (sk_i)_{i in [n]})
PartSign1 (pp, sk_i, M):
1. A <- ExpandA(rho)
2. mu <- H(concatenation of tr and M)
3. for k in [L]:
4. [HOM] Enc(y\hat{ }(k)) and Enc(e\hat{ }(k)) <-
  1. a value acquired by dividing, by 8,
    (1) a value acquired by modularly reducing,
    with respect to 64, a product of
    H(concatenation of mu and k) and
Enc(k_PRF),
    (2) and then rounding the divided value to the
    nearest integer
5. [HOM] Enc(w\hat{ }(k)) <- value acquired by adding
        i. Enc(e\hat{ }(k)) to a product of A and
        Enc(y\hat{ }(k))
      B. (modular reduction with respect to q)
6. [HOM] Enc(w_1\hat{ }(k)) <- HighBits(Enc
(w\hat{ }(k)),
        i. 2 multiplied by gamma_2)
7. [HOM] Enc(r′_0?(k)) <- LowBits_q(Enc(w?(k)),
        i. 2 multiplied by gamma_2)
8. Enc(r′_0) <- Enc(r′_0\hat{ }(1), ... , r′_0\hat{ }(L))
9. Enc(w_1) <- Enc(w_1\hat{ }(1), ... , w_1\hat{ }(L))
10. p_(w_1, i) <- PartDec(sk_i, Enc(w_1))
11. return out_(1, i) = (Enc(r′_0), Enc(y), Enc(w_1),
  p_(w_1, i))
Combine1 (pp, (out_(1, j))_{j in [n]}):
1. for j in [n]:
2. parse out_(1, j) as (Enc(r′_0), Enc(y), Enc(w_1),
  1. p_(w_1,j))
3. (w_1\hat{ }(k))_{k in [L]} <- FinDec(Enc(w_1),
        i. (p_(w_1, j))_{j in [n]})
4. return out_1 = (Enc(r′_0), Enc(y),
        i. (w_1\hat{ }(k))_{k in [L]})
PartSign2 (pp, sk_i, out_1, M):
1. parse out_1 as (Enc(r′_0), Enc(y), (w_1?(k))_{
k in [L]})
2. for k in [L]:
3. c_tilde\hat{ }(k) <- H(concatenation of M and
w_1\hat{ }(k))
4. c\hat{ }(k) <- SampleInBall(c_tilde?(k))
5. [HOM] Enc(z\hat{ }(k)) <- value acquired by adding
        i. a product of c\hat{ }(k) and Enc(s_1)
        ii. to Enc(y\hat{ }(k))
6. [HOM] if (an infinity norm of Enc(z\hat{ }(k))
        i. is equal to or greater than (gamma_1-
beta))
    (2) or (infinity norm of a value acquired by
  vsubtracting
          1. a product of c\hat{ }(k) and Enc(s_2)
          from Enc(r′_0\hat{ }(k))
          2. is equal to or greater than (gamma_
          2-beta))
    (3) then
7. Enc(z\hat{ }(k)) <- Enc(bot)
8. else if (infinity norm of a product of c\hat{ }(k) and
t_0
        i. is equal to or greater than gamma_2)
  2. then
9. Enc(z\hat{ }(k)) <- Enc(bot)
10. set Enc(k_0) to a value of first k for which z k
is not bot
11. ; if there is no such k, set Enc(k_0) = phi
12. for k in (set acquired by excluding {k_0}
from [L]):
13. Enc(z\hat{ }(k)) <- Enc(bot)
14. Enc(z) <- Enc(z\hat{ }(1), ..., z\hat{ }(L))
15. p_(z, i) <- PartDec(sk_i, Enc(z))
16. return out_(2, i) = (Enc(z), (c_tilde\hat{ }(k)),
(c\hat{ }(k)),
      A. p_(z, i))
Combine2 (pp, (out_(2, j)) {j in [n]}):
1. for j in [n]:
2. parse out_(2, j) as
      A. (Enc(z), (c_tilde\hat{ }(k)), (c\hat{ }(k)), p_(z, j))
3. (z_k)_{k in [L]} <- FinDec(Enc(z),
        i. (p_(z, j))_{j in [n]})
4. if (z\hat{ }(k) is not bot for some k belonging to [L])
    then
5. sigma = (z\hat{ }(k), c\hat{ }(k))
6. h <- MakeHint_q
      A. (value acquired by reversing a sign of (a
      product of c\hat{ }(k) and t_0),
      B. value acquired by subtracting (a product
      of c\hat{ }(k)a nd t)
      C. from (a product of A and z_k)
      D. and adding (a product of c\hat{ }(k) and t_0),
      E. 2 multiplied by gamma_2)
7. if (Hamming weight HW(h) of h is equal to or
less than omega)
    then
8. return (z\hat{ }(k), h, c_tilde\hat{ }(k))
9. else return bot
Verify (vk, M, sigma):
1. return Dilithium. Verify(vk, M, sigma)
```

### Section 3.3. Analysis

Correctness follows from correctness of Dilithium and correctness of the underlying Fully Homomorphic Encryption scheme. Compactness is also satisfied, because the verification key and the signature returned by the scheme according to the present disclosure are exactly the same as those of Dilithium, and accordingly verification interchangeability is also guaranteed. In addition, the present disclosure proves the following security claim.

Theorem 2. Let q_sig be an upper bound of the number of signing queries by an attacker, N be a ring degree, and B_eval be an upper bound of a homomorphic operation error term of a ciphertext to be decrypted. Then, assuming that the underlying Fully Homomorphic Encryption scheme is perfectly correct and Indistinguishability under Chosen-Plaintext Attack (IND-CPA) secure, assuming that a threshold flooding parameter eta satisfies the following inequality—that is, eta is equal to or greater than (a value acquired by multiplying B_eval by (a square root of (a value acquired by multiplying 10 by N and q_sig)))—and assuming security of Dilithium using the Darkmatter PRF instantiation of Equation (2), the threshold signature scheme described in Algorithm 2 satisfies threshold unforgeability.

The proof is adapted from [ASY22], and is described in detail in Appendix B. The proof relies on security of Dilithium in a state in which incomplete signatures are disclosed, as shown in [BdCE+26], and security of the underlying Fully Homomorphic Encryption scheme.

### Section 4. Homomorphic Operations

Here, a method of performing homomorphic operations of Algorithm 2 is described. First, components that may have broader applicability are provided, and each step is then described.

### Section 4.1. A CKKS-BFV Continuum

Implementing Steps 4 and 5 of PartSign1 of Algorithm 2 using intrinsic CKKS homomorphic operations appears to be costly. The reason is modular multiplication with respect to 64 in Step 4 and modular multiplication with respect to q in Step 5. For homomorphic modular multiplication, BFV or BGV is generally relied on. However, having a CKKS ciphertext of the output [[y]] of Step 4 is more suitable for performing the first comparison in Step 6 of PartSign2 of Algorithm 2.

Conversion from a BFV ciphertext format into a CKKS ciphertext format for small bit-length integers may be achieved using a bootstrapping-based format conversion algorithm according to [BGGJ20]. As shown in [BKSS24], this conversion may be combined with function evaluation and bit extraction, and accordingly bits of y may be acquired in CKKS slots of a high-level ciphertext.

Here, a method of converting a CKKS ciphertext for bits into a BFV ciphertext is described. Let (a, b) be a pair of two components of a polynomial ring R\hat{ }FHE (i.e., an N-th degree polynomial ring of integer coefficients modulo Q). Assume that the following relationship is satisfied (Equation 4).

That is, a result acquired by adding b to (a product of a and a secret key s) is the same, with respect to modulus Q, as a result acquired by applying DFT\hat{ }−1 to a value acquired by adding an error term e to a value acquired by multiplying a scale factor Delta by plaintext m. Here, s is a secret key, and gamma is defined as a value acquired by dividing (an infinity norm of the error term) by (the scale factor Delta), and is less than ¼. Because the present disclosure considers a high-level CKKS ciphertext, the modulus Q is large and the scale factor Delta is significantly small compared to Q. Specifically, the scale factor Delta is generally about 20 to 30 bits, and the modulus Q is about hundreds of bits. The goal of the present disclosure is to convert (a, b) into a new pair (a′, b′) as follows (Equation 5).

That is, a result acquired by adding b′ to (a product of a′ and the secret key s) is the same, with respect to a new modulus Q′, as a value acquired by adding a new error term e′ to a value acquired by multiplying a new scale factor Delta′ by plaintext m. Here, the new scale factor Delta′ is (a value acquired by rounding, to the nearest integer, a value acquired by dividing the new modulus Q′ by a BFV plaintext modulus t), and a norm of the new error term e′ is significantly smaller than the new scale factor Delta′. A smaller value acquired by dividing an infinity norm of the new error term by the new scale factor, referred to as a new ratio gamma′, is more advantageous. The reason is that a smaller ratio gives more room for performing several BFV operations.

To map Equation (4) to Equation (5), first, the cleaning map h_1 (i.e., a map that maps an input x to (a value acquired by subtracting (a product of 2 and a cube of x) from (a product of 3 and a square of x))) is homomorphically evaluated on the input ciphertext. The cleaning map has been used in [DMPS24] to increase precision of binary plaintext. More precisely, when b is 0 or 1 and an absolute value of epsilon is sufficiently small, a result acquired by applying h_1 to (b+epsilon) is the same as (a value acquired by adding, to b, (a small value of a square order of epsilon)). When the cleaning map h_1 is homomorphically applied to (a, b) without rescaling (i.e., when homomorphic multiplication is performed only through tensor product and relinearization), a new pair (a_1, b_1) may be acquired, and the following relationship is satisfied.

That is, a result acquired by adding b_1 to (a product of a_1 and the secret key s) is the same, with respect to modulus Q, as (a result acquired by applying DFT\hat{ }−1 to (a value acquired by adding a new error term e_1 to (a value acquired by multiplying (a fourth power of the scale factor, that is, a fourth power of Delta) by plaintext m)))). Here, a new ratio gamma_1 (i.e., a value acquired by dividing (a norm of the new error term) by (the fourth power of Delta)) is almost the same as (a square of the previous ratio gamma). It is noted that evaluation of the cleaning map h_1 has multiplication depth of 2, and Delta is thus raised to the fourth power. Here, anew pair (a′_1, b′_1) may be acquired by rescaling with (a product of (a cube of Delta) and gamma). Here, a new modulus Q_1 is almost the same as (a value acquired by dividing the previous modulus Q by (a product of (a cube of Delta) and gamma)), and the following relationship is satisfied.

That is, a result acquired by adding b′_1 to (a product of a′_1 and the secret key s) is the same, with respect to a new modulus Q_1, as (a result acquired by applying DFT\hat{ }−1 to (a value acquired by adding another new error term e′_1 to (a value acquired by multiplying a new scale factor Delta_1 by plaintext m)))). Here, the new scale factor Delta_1 is (a value acquired by dividing the previous scale factor Delta by the previous ratio gamma), and (a value acquired by dividing (a norm of the new error term) by the new scale factor) is almost the same as gamma_1.

When the operation is repeated k times, it may be seen that a k-th ratio gamma_k increases to (the 2\hat{ }k-th power of the previous ratio gamma), a k-th scale factor Delta_k increases almost the same as (a value acquired by dividing the previous scale factor Delta by gamma_k), and a k-th modulus Q_k decreases almost the same as (a value acquired by dividing (a value acquired by multiplying Q by (the 2\hat{ }k-th power of gamma)) by (the 3k-th power of Delta)). It is noted that a precise approach saving more modulus consumption (i.e., having a larger Q_k) was recently proposed in [MHIPS25]. Overall, the scale factor increases as the ciphertext modulus decreases, and the error term is maintained similarly. When Delta_k becomes close to Q_k, homomorphic DFT is performed. When appropriately adjusted, the result has a new scale factor Delta′ (which is a value acquired by rounding, to the nearest integer, (a value acquired by dividing the current modulus Q′ by the BFV plaintext modulus t)). The current ciphertext (a′, b′) satisfies Equation (5), where a norm of the new error term is significantly small compared to the new scale factor Delta′.

This conversion allows a vector [[y]], having coordinates stored in CKKS ciphertexts in bit units in Step 5, to be converted into bits of BFV ciphertexts. Next, by multiplying entries by powers of 2, [[y]] storing coordinates as integers modulo Dilithium q may be acquired. Step 6 then includes BFV multiplication between a plaintext matrix and a ciphertext vector.

### Section 4.2. Thrifty Comparison

In CKKS-based comparison, a conventional state-of-the-art approach is an iterative method introduced in [CKK20]. This method gradually increases precision of comparison by iteratively evaluating low-degree polynomials. The low-degree polynomials may be selected using a multi-interval Remez algorithm [LLKN22].

In the present disclosure, modulus consumption of the technique is optimized by flexibly changing the scale factor. The optimization may be conveniently performed using the grafting technique of [CCK+24]. The encrypted input of the comparison according to the present disclosure is an integer of about 20.5 bits, and the output is a single bit. It is noted that each low-degree polynomial serves to gradually reduce high bits. This technique allows the scale factor to be slightly decreased across evaluation of the low-degree polynomials, and reduces overall modulus consumption. For example, during homomorphic comparison for modular reduction with respect to (2 multiplied by gamma_2), the present disclosure starts from a 40.4-bit scale factor and gradually decreases to 23.5 bits.

### Section 4.3. Operations Over the Dilithium Ring

Underlying polynomial rings R\hat{ }FHE of CKKS and BFV are different from a polynomial ring R\hat{ }SIG of Dilithium. Specifically, the present disclosure uses the following. That is, R\hat{ }FHE is (a polynomial ring of integer coefficients having ((X\hat{ }N)+1) as a modulus), and N is 2\hat{ }16. In contrast, R\hat{ }SIG is (a polynomial ring of integer coefficients having ((Y\hat{ }N′)+1) as a modulus), and N′ is (2\hat{ }8, that is, 256). It is noted that R\hat{ }SIG is a subring of R\hat{ }FHE, and in R\hat{ }FHE, Y corresponds to (a 256-th power of X). In particular, R\hat{ }FHE is a module of dimension ((2\hat{ }16) divided by (2\hat{ }8), that is, 2\hat{ }8) over R\hat{ }SIG.

For homomorphic operations over R\hat{ }SIG, the present disclosure uses coefficient-encoded BFV-CKKS. Assume that two polynomials f(X) and f(X) are given as elements of R\hat{ }FHE as follows. That is, for i equal to or greater than 0 and less than 256, both polynomials have a form of adding terms acquired by multiplying (m_i(Y) or m′_i(Y)) by an i-th power of X. Here, m_i and m′_i are elements of R\hat{ }SIG. A product of the two polynomials, that is, a product of f and f, may then be expressed as follows.

That is, for i equal to or greater than 0 and less than 256, the product is expressed in a form of adding terms acquired by multiplying, by an i-th power of X, (a sum of products of m_j and m′(i−j) for j equal to or greater than 0 and less than 256). Here, when j is greater than i (i.e., when a negative index occurs, for 1<i<256), m(−i) is defined as (a value acquired by reversing a sign of m_i, that is, −m_i). The reason is that R\hat{ }FHE is a module over R\hat{ }SIG. The product results in 256 Dilithium ring elements being output in parallel. That is, the result has a form of (a sum of products of m_j and m′(i−j) for j equal to or greater than 0 and less than 256), where i is equal to or greater than 0 and less than 256. According to the recognition, Dilithium arithmetic operations may be implemented homomorphically. For example, when a Dilithium dimension is set to (k, ell)=(4, 4) and the number of parallel repetitions is set to L=8, for s (which is a 4-dimensional vector of R\hat{ }SIG, where s_=(s_(, j))(0≤j<4)) and 8 elements (c_t)(0≤t<8) of R\hat{ }SIG, a product of c and s_(i.e., a product of c_t and s_* for t equal to or greater than 0 and less than 8) is derived by the following multiplication over R\hat{ }FHE.

That is, the result is acquired by multiplying (a sum of terms acquired by multiplying a j-th component s_(, j)(Y) of s_ by an (8j)-th power of X for j equal to or greater than 0 and less than 4) and (a sum of terms acquired by multiplying a t-th component c_t(Y) of c by a (32t)-th power of X for t equal to or greater than 0 and less than 8). The result may be used to derive a product of c and s_1 and a product of c and s_2 during homomorphic signing.

The same approach is also possible for homomorphically deriving a product of A and y with respect to q. For a polynomial y(X) storing 3 (random) bits in each coefficient and a Dilithium verification key A, L=8 vectors w may be derived in parallel using 4 multiplications (i.e., k=4) over R\hat{ }FHE. The result is output as 4 module-Learning With Errors (LWE)-format ciphertexts [BGV12, LS15] having a module of dimension 32 and degree 2048. The 4 module-LWE-format ciphertexts may be combined into one BFV-CKKS ciphertext using format conversion according to [BCK+23].

### Section 4.4. Large Modular Arithmetic

A decomposition step of Dilithium includes modular arithmetic with respect to modulus q and (2 multiplied by gamma_2). In particular, congruent elements equal to or greater than 0 and less than q are exactly required for modulus q, and congruent elements greater than (−gamma_2) and equal to or less than gamma_2 are exactly required for (2 multiplied by gamma_2). The present disclosure uses bit representation to perform these large modular arithmetic operations. More precisely, for a given input x (i.e., x may be represented as (a sum of products of b_i and (2\hat{ }i))), first, modular reduction of x with respect to k is approximately derived as (a sum of products of b_i and (modular reduction of (2\hat{ }i) with respect to k)), and then adjusted to be equal to or greater than 0 and less than k using a binary circuit or thrifty comparison.

For bit decomposition, the present disclosure adopts an iterative Most Significant Bit (MSB) extraction technique according to [KN24]. Precisely, 6-bit small-integer bootstrapping is repeated 5 times to acquire 28 ciphertexts (b_i)_(0≤i<28) decrypted into respective bits. That is, x is represented as (a sum of products of b_i and (2\hat{ }i) for i equal to or greater than 0 and less than 28). In the protocol according to the present disclosure, an input of modular arithmetic has a form in which (a product of q and an integer vector I) is added to (a product of A and y). Each element of I belongs to a range from (−hwt/2) to (hwt/2), inclusive. Here, hwt is a Hamming weight of a sparse secret key (e.g., hwt=31 when sparse secret encapsulation [BTH22] is used).

In reduction with respect to modulus q, it is noted that x_q (i.e., (a sum of products of b_i and (modular reduction of 2\hat{ }i with respect to q) for i equal to or greater than 0 and less than 28)) belongs to a range equal to or greater than 0 and less than 2q. Then, modular reduction of x with respect to q, which is equal to or greater than 0 and less than q, may be acquired by comparing x_q with q and subtracting q when necessary. Because q is (a value acquired by subtracting 2\hat{ }13 from 2\hat{ }23 and adding 1), x_q and q may be compared using a binary circuit having depth of 7 and receiving b_i as inputs. Meanwhile, in reduction with respect to (2 multiplied by gamma_2), first, (a sum of products of b_i and (modular reduction of 2 with respect to (2 multiplied by gamma_2)) for i equal to or greater than 0 and less than 28) is derived, and the sum belongs to a range equal to or greater than (−4 multiplied by gamma_2) and equal to or less than (4 multiplied by gamma_2). Next, by comparing the sum with each multiple of (2 multiplied by gamma_2) using the thrifty comparison of Section 4.2, exact modular reduction of x with respect to (2 multiplied by gamma_2), which is greater than (−2 multiplied by gamma_2) and equal to or less than (2 multiplied by gamma_2), is acquired. Input precision is almost the same as (a logarithm to base 2 of (a product of 16 and gamma_2), that is, log_2(16 multiplied by gamma_2))

### Section 4.6. Overall Protocol

Here, exact homomorphic operations performed by THED are described. Steps not specified below are performed in the plaintext domain.

Homomorphic Ring-Darkmatter (Algorithm 2, Step 4 of PartSign1). Homomorphic evaluation of the Darkmatter PRF has the following two steps: (1) modular multiplication with respect to 64, and (2) extraction of 3 most significant bits. To this end, the CKKS-BFV continuum (Section 4.1) and small-integer functional bootstrapping [BKSS24] are respectively used. At the end of the step, 6 CKKS ciphertexts each decrypted into an N/2-dimensional pseudo-random binary vector are acquired. The present disclosure views the bit strings as bit representations of L=8 different (values acquired by adding (gamma_1−1) to y) and (values acquired by adding 4 to e). It is noted that the 6 ciphertexts output more random bits than required for 8 signing attempts.

Derivation of w (Algorithm 2, Step 5 of PartSign1). Derivation of w (i.e., a result acquired by modularly reducing, with respect to q, (a value acquired by adding e to (a product of A and y))) has the following two steps: (1) cleaning random bits y and e, and (2) deriving (a result acquired by modularly reducing, with respect to q, (a value acquired by adding e to (a product of A and y))). The first step increases precision of bits to allow y and e to be accurately binary-recombined into integers, and to enable accurate multiplication with A and noise flooding. The precision increase is achieved by repeatedly applying the cleaning map h_1 in a thrifty manner described in [CKSS25]. The second step may be achieved using the approach introduced in Section 4.3.

It is noted that although an output ciphertext of the procedure stores (a result acquired by modularly reducing (a product of A and y) with respect to q), the output ciphertext does not guarantee that coordinates are within a range equal to or greater than 0 and less than q. Therefore, post-processing for deriving HighBits and LowBits is required.

HighBits and LowBits (Algorithm 2, Steps 6 and 7 of PartSign1). For a given coordinate w of w (i.e., a product of A and y), except for a case in which w is congruent to (−gamma_2) with respect to q, the following equations are satisfied.

That is, LowBits(w) is equal to (a value acquired by subtracting (gamma_2−1) from (a result acquired by modularly reducing, with respect to (2 multiplied by gamma_2), (a value acquired by subtracting 1 from (a result acquired by modularly reducing (w+gamma_2) with respect to q))))). In addition, HighBits(w) is equal to (a value acquired by multiplying (1 divided by (2 multiplied by gamma_2)) by (a value acquired by subtracting (LowBits(w)+gamma_2) from (a result acquired by modularly reducing (w+gamma_2) with respect to q)))). Here, [x]_k refers to a residue equal to or greater than 0 and less than k as a result of modularly reducing x with respect to k. When w is congruent to (−gamma_2) with respect to q, LowBits is required to be (−gamma_2), whereas the above equation outputs gamma_2. However, LowBits of (+gamma_2) or (−gamma_2) are both rejected. The reason is that an absolute value of (a value acquired by subtracting (a product of c and s_2) from (+gamma_2 or −gamma_2)) is equal to or greater than (gamma_2−beta). Therefore, when HighBits and LowBits are derived using the above equation, exactly the same result as in Dilithium is acquired. Large modular arithmetic may be performed using the approach introduced in Section 4.4.

Rejection based on the infinity norm of z (Algorithm 2, Step 6 of PartSign2). The present disclosure rejects a signature when the infinity norm of z, that is, (the infinity norm of (a sum of y and (a product of c and s_1))), is equal to or greater than (gamma_1−beta). Because each bit of (a value acquired by adding gamma_1 to y and subtracting 1) is acquired after homomorphic PRF evaluation (Step 5), comparison may be divided into the following two parts. That is, high-bit comparison and low-bit comparison. In particular, because an infinity norm of (a product of c and s_1) is equal to or less than beta, (an infinity norm of (a sum of y and (a product of c and s_1)) being equal to or greater than (gamma_1−beta)) is a necessary and sufficient condition for either one of the following two conditions to be satisfied.

Condition 1: A case in which (a quotient acquired by dividing (a value acquired by adding gamma_1 to y and subtracting 1) by 256, that is, a floored value) is 0, and simultaneously (a value acquired by adding (a product of c and s_1) to (a result acquired by modularly reducing, with respect to 256, (a value acquired by adding gamma_1 to y and subtracting 1)))) is equal to or less than beta.

Condition 2: A case in which (a quotient acquired by dividing (a value acquired by adding gamma_1 to y and subtracting 1) by 256, that is, a floored value) is 1023, and simultaneously (a value acquired by adding (a product of c and s_1) to (a result acquired by modularly reducing, with respect to 256, (a value acquired by adding gamma_1 to y and subtracting 1)))) is equal to or greater than (255−beta).

Here, [x]_k refers to a residue equal to or greater than 0 and less than k as a result of modularly reducing x with respect to k. The high-bit comparison may be performed using an AND-tree, and the low-bit comparison may be performed using the thrifty comparison described in Section 4.2. For the low-bit comparison, precision of log_2(4 multiplied by 256) bits is sufficient.

Rejection based on the infinity norm of r′_0 (Algorithm 2, Step 6 of PartSign2). The rejection may also be performed using the thrifty comparison algorithm. A comparison having precision of log_2(8 multiplied by gamma_2) bits is required.

Disclosure of Signature (Algorithm 2, Step 14 of PartSign2). Before disclosing a signature, a first signature that is not rejected is required to be (homomorphically) selected (to avoid a simple attack based on an unused but derived signature). To this end, [BCKS24] is used to bootstrap bits corresponding to verification results, and a one-hot vector indicating a selected sample is then generated and then cleaned by repeating the cleaning map h_1. Due to the processing, only the first z that passed is preserved, and all other z are set to 0. Encryption of z previously derived for rejection verification is not reused, because the previous derivation was performed at low precision that does not allow cleaning. That is, the previous derivation was performed at low precision to minimize modulus consumption in comparison. Accordingly, as described in Section 4.3, (a product of c and s_1) is homomorphically derived again with a larger scale factor, and after cleaned bits of y are added, precision becomes sufficiently high to enable noise flooding. The result is prepared for distributed decryption.

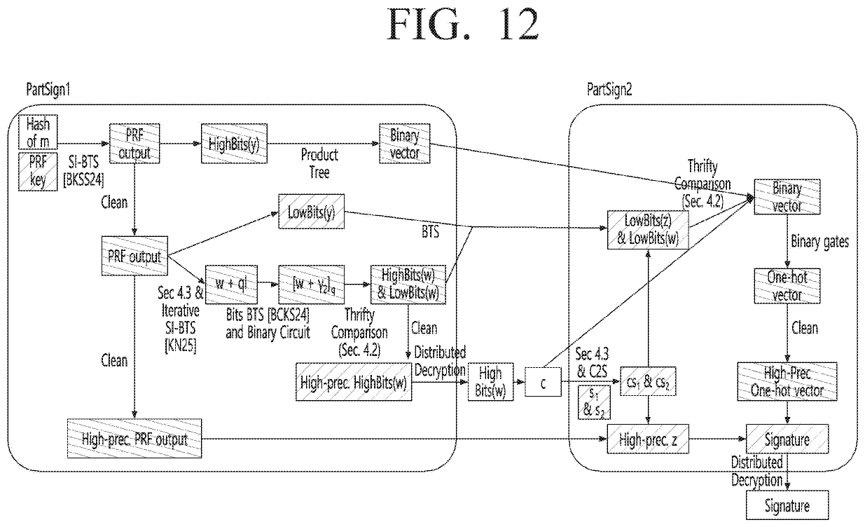

FIG. 12 provides an overview of the entire procedure.

(FIG. 12: Overview of a signing procedure in threshold Dilithium. Encrypted integer values are indicated by dark boxes, encrypted binary values are indicated by green checkered boxes, and plaintext values are indicated by white boxes).

### Section 5. Implementation and Experimental Results

Here, a proof-of-concept implementation of THED is described. Experiments according to the present disclosure were performed using a modified version of the HEaaN library [CRY22] on an NVIDIA GeForce RTX 5090 GPU. The present disclosure did not use RNS (Residue Number System)-CKKS [CHKKS18b], and used grafting CKKS [CCK+24] providing improved flexibility for a scale factor.

### Section 5.1. Security Aspects

For CKKS, the present disclosure uses a ring degree N=2\hat{ }16 and a maximum ciphertext modulus PQ satisfying log_2(PQ)=1533. A Hamming weight of the secret key is 256. For bootstrapping, by using a sparse secret encapsulation technique according to [BTH22] with a secret key having Hamming weight 31 at modulus log_2(PQ)=116, a bootstrapping failure probability due to polynomial evaluation in an EvalMod step is made 0. The zero failure probability makes the attack of [CCP+24] inapplicable. The used parameters achieve 128-bit security against known attacks [APS15].

For the Darkmatter PRF, the present disclosure relies on a Ring Learning With Rounding assumption, and uses a ring degree N=2\hat{ }16, a large modulus q=64, and a small modulus p=8. According to a security estimate according to the present disclosure, which is based on a lattice estimator [APS15] and recent analysis of [BHBS26], these parameters provide security significantly greater than 128 bits. The present disclosure uses these parameters because single Darkmatter evaluation is sufficient to generate all required randomness, and accordingly, reducing security does not greatly improve performance.

Security also requires sufficient noise flooding. This aspect is discussed in Appendix D.1.

### Section 5.2. Communication Cost

Among 100 signing attempts, the present disclosure experimentally verified that the above parameters are compatible with 60-bit noise flooding and that all participants may restore a signature (under an assumption that signing is successful).

### Section 5.3. Computation Cost

All signatures pass standard Dilithium verification code. Among 1000 repetitions, 870 repetitions were successful in signing. This matches a theoretical rejection probability of Dilithium. Each execution of the protocol according to the present disclosure performs 8 signatures in parallel, and outputs only the first signature when at least one of 8 parallel signing processes are successful. Table 1 shows an overview of experimental results. More detailed experimental results are reported in Appendix D.2.

The present disclosure experimentally observed that, in output ciphertexts, there is a gap of 98.77 bits and 79.37 bits in coefficients between messages and errors for each round. As described in detail in Appendix D.1, this gap is strictly greater than 90 bits and 75 bits, which are conservative upper bounds of a gap for noise flooding.

TABLE 1
Overview of Costs

| | | | Signing | Communication |
|---|---|---|---|---|
| | | | Success | Amount per |
| | | | Probability | Participant |
| | Average | Worst | (Sign | (Comm. per |
| Phase | Latency | Precision | prob.) | party) |
| PartSign1 | 1041.2 ms | 98.8 bits | — | 19.5 KB |
| PartSign2 | 198.41 ms | 79.4 bits | 0.870 | 4.10 KB |

(Table 1 includes the following columns: Phase (PartSign1, PartSign2), Average Latency, Worst Precision, Signing Success Probability (Sign Prob.), and Communication Amount per Participant (Comm. per Party)).

PartSign1: Average Latency 1041.2 ms, Worst Precision 98.8 bits, Sign prob.—(not applicable), Comm. per party 19.5 KB.

PartSign2: Average Latency 198.41 ms, Worst Precision 79.4 bits, Sign prob. 0.870, Comm. per party 4.10 KB. It is noted that time excludes operations in the plaintext domain such as MakeHint and distributed decryption. Latency is average latency, and precision is the worst precision among 1000 experiments.

Reduction of Online Cost. As reported in Table 1, a cost of PartSign2 is significantly smaller than a cost of PartSign1. This advantages may be utilized as follows to improve performance. PartSign1 may be performed independently of a message to be signed. Although PartSign1 appears to receive message M as an input in FIG. 12, a seed mu may actually be selected independently of M. That is, the seed merely needs to be the same among the signers, and may thus be set as an output of a random oracle for an input agreed by the signers. According to this modification, all operations of PartSign1 (excluding threshold decryption, which are required to be performed only after the message M to be signed is disclosed) may be executed in an offline phase, and an online phase is reduced to threshold decryption of PartSign1 and PartSign2.

### REFERENCES

(Reference items are left as they are without separate notation, and are cited in the text in an abbreviation format such as [ASY22] and [BGG+18]. Citation mapping of the present disclosure is as follows).
[1] Agrawal, Stehli, Yadav. ICALP 2022.->[ASY22]
[2] Alagic et al. NIST standardization report. 2022.->[Ala+22]
[3] Albrecht, Player, Scott. J. Math. Cryptol. 2015.->[APS15]
[4] Alexandru, Kim, Polyakov. CRYPTO 2025.->[AKP25]
[5] Alkadri, Dφttling, Pu. ACNS 2024.->[AlD+24]
[6] Asharov, Jain, Lσpez-Alt, Tromer, Vaikuntanathan, Wichs. EUROCRYPT 2012.->[AJL+12]
[7] Bae, Cheon, Cho, Kim, Kim. CCS 2022.->[BCC+22]
[8] Bae, Cheon, Kim, Park, Stehli. CRYPTO 2023.->[BCK+23]
[9] Bae, Cheon, Kim, Stehli. EUROCRYPT 2024.->[BCKS24]
[10] Bae, Kim, Suvanto, Stehli. ASIACRYPT 2024.->[BKSS24]
[11] Bai et al. CRYSTALS-Dilithium specification v3.1.->[BDK+21]
[12] Bai, Galbraith. CT-RSA 2014.->[BG14]
[13] Baudrin, Heim-Boissier, Standaert. IACR eprint 2026/250.->[BHBS26]
[14] Benhamouda, Lepoint, Loss, Orr, Raykova. J. Cryptol. 2022.->[BLLOR22]
[15] Beullens, Seiler. CRYPTO 2023.->[BS23]
[16] Bienstock, de Castro, Escudero, Polychroniadou, Takahashi. USENIX Security 2026.->[BdCE+26]
[17] Boneh et al. CRYPTO 2018.->[BGG+18]
[18] Boneh, Ishai, Passel gue, Sahai, Wu. TCC 2018.->[BIP+18]
[19] Boneh, Kim. CRYPTO 2025.->[BK25]
[20] Borin, Celi, del Pino, Espitau, Niot, Prest. IACR eprint 2025/1166.->[BCdP+25]
[21] Boschini et al. S&P 2025.->[BKL+25]
[22] Bossuat, Troncoso-Pastoriza, Hubaux. ACNS 2022.->[BTH22]
[23] Boura, Gama, Georgieva, Jetchev. J. Math. Cryptol. 2020.->[BGGJ20]
[24] Brakerski. CRYPTO 2012.->[Bra12]
[25] Brakerski, Friedman, Marmor, Mutzari, Spiizer, Trieu. IACR eprint 2025/712.->[BFM+25]
[26] Brakerski, Gentry, Vaikuntanathan. ITCS 2012.->[BGV12]
[27] Brandγo, Peralta. NIST report on the call for multi-party threshold schemes. 2025.->[BP25]
[28] Chairattana-Apirom, Tessaro, Zhu. ASIACRYPT 2024.->[CATZ24]
[29] Chen. CRYPTO 2023.->[Che23]
[30] Cheon, Choe, Kang, Kim, Kim, Mono, Noh. CCS 2024.->[CCK+24]
[31] Cheon, Choe, Passel gue, Stehli, Suvanto. CCS 2024.->[CCP+24]
[32] Cheon, Han, Kim, Kim, Song. EUROCRYPT 2018.->[CHKKS18]
[33] Cheon, Han, Kim, Kim, Song. SAC 2018.->[CHKKS18b]
[34] Cheon, Kim, Kim, Song. ASIACRYPT 2017.->[CKKS17]
[35] Cheon, Kim, Kim. ASIACRYPT 2020.->[CKK20]
[36] Chillotti, Gama, Georgieva, Izabach ne. ASIACRYPT 2016.->[CGGI16]
[37] Choe, Kim, Suvanto, Stehh. CCS 2025.->[CKSS25]
[38] Cozzo, Smart. IMACC 2019.->[CS19]
[39] CryptoLab. HEaaN Library. https://heaan.it/.->[CRY22]
[40] Damgεrd, Orlandi, Takahashi, Tibouchi. PKC 2021.->[DOTT21]
[41] del Pino, Katsumata, Maller, Mouhartem, Prest, Saarinen. EUROCRYPT 2024.->[dPKM+24]
[42] Desmedt, Frankel. CRYPTO 1989.->[DF89]
[43] Devevey, Fallahpour, Passel gue, Stehlt. CRYPTO 2023.->[DFPS23]
[44] Drucker, Moshkowich, Pelleg, Shaul. J. Cryptol. 2024.->[DMPS24]
[45] Ducas, Kiltz, Lepoint, Lyubashevsky, Schwabe, Seiler, Stehlι. TCHES 2018.->[DKL+18]
[46] Ducas, Micciancio. EUROCRYPT 2015.->[DM15]
[47] Dufka, Kravtsenko, Laud, Snetkov. IACR eprint 2025/675.->[DKLS25]
[48] Eldefrawy, Genise, Manohar. PQCrypto 2023.->[EGM23]
[49] Espitau, Katsumata, Takemure. CRYPTO 2024.->[EKT24]
[50] Fan, Vercauteren. IACR eprint 2012/144.->[FV12]
[51] Gur, Katz, Silde. PQCrypto 2024.->[GKS24]
[52] Hong, Choi, Lee, Kim. FC 2025.->[HCLK25]
[53] Hwang, Lee, Seo, Song. CCS 2025.->[HLSS25]
[54] Iliashenko, Zucca. POPET 2021.->[IZ21]
[55] Katsumata, Reichle, Takemure. CRYPTO 2024.->[KRT24]
[56] Kim, Noh. IACR Commun. Cryptol. 2024.->[KN24]
[57] Kim, Seo, Song. CCS 2024.->[KSS24]
[58] Langlois, Stehlι. Des. Codes Cryptogr. 2015.->[LS15]
[59] Langlois, Stehlι, Steinfeld. EUROCRYPT 2014.->[LSS14]
[60] Laud, Snetkov, Vakarjuk. IACR eprint 2022/644.->[LSV22]
[61] Lee, Lee, Kim, No. IEEE Access 2022.->[LLKN22]
[62] Lyubashevsky. ASIACRYPT 2009.->[Lyu09]
[63] Lyubashevsky. EUROCRYPT 2012.->[Lyu12]
[64] Lyubashevsky, Nguyen, Planηon. CRYPTO 2022.->[LNP22]
[65] Lyubashevsky, Peikert, Regev. EUROCRYPT 2010.->[LPR10]
[66] Min, Hanrot, Passel gue, Stehh. IACR eprint 2025/2057.->[MHPS25]
[67] Mouchet, Bertrand, Hubaux. J. Cryptol. 2023.->[MBH23]
[68] Nguyen, Seiler. CRYPTO 2024.->[NS24]
[69] Passel gue, Stehlι. ASIACRYPT 2024.->[PS24]
[70] Del Pino, Niot. PKC 2025.->[dPN25]
[71] Snetkov, Vakarjuk, Laud. Discov. Comput. 2024.->[SVL24]
[72] Stehlι, Steinfeld, Tanaka, Xagawa. ASIACRYPT 2009.->[SSTX09]
[73] Tang, Pang, Chen, Zhang. IEEE TIFS 2023.->[TPCZ23]
[74] Vakarjuk, Snetkov, Willemson. Entropy 2021.->[VSW21]

### Open Science

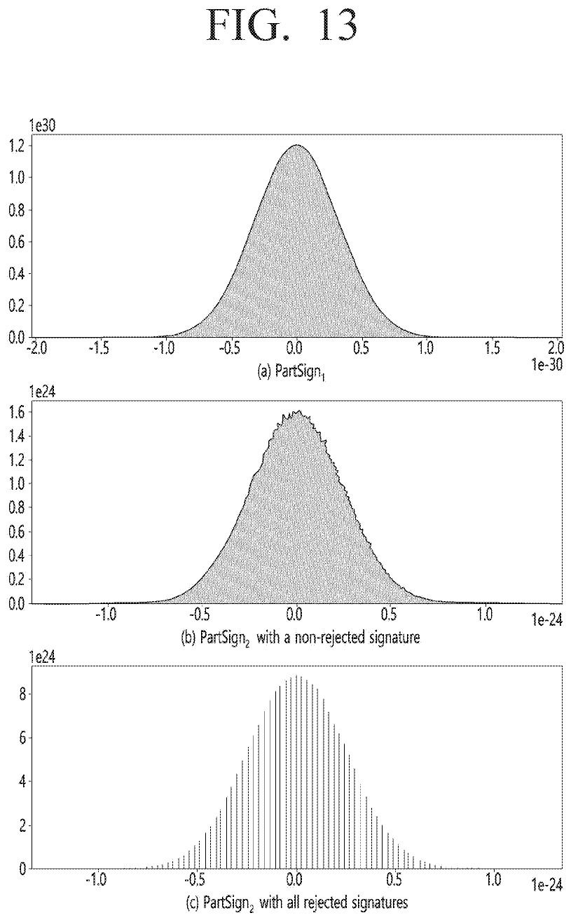

The implementation of THED depends on the HEaaN library [CRY22]. Due to license restrictions, the code is incapable of being provided. A binary is provided to reviewers at the following URL. https://anonymous.4open.science/r/THED-BE22/. The present disclosure also provides a Python script used to analyze a noise term in an output ciphertext and generate FIG. 13.

### Generative AI Usage

Spelling and grammar of this submitted manuscript were edited using Grammarly and AI Assist of Overleaf. The above-described Python script was written with assistance from Gemini 3 and Claude Sonnet v4.6.

### APPENDIX A. ADDITIONAL DEFINITIONS

### A.1. Rényi Divergence

The definition of Rényi divergence and its properties are revisited.

Definition 4. Let a be a real number greater than 1 and less than infinity. Let P and Q be two probability distributions, and let P be absolutely continuous with respect to Q. Rényi divergence between P and Q of order a is defined as follows (assuming existence thereof). That is, R_a(P∥Q) is equal to (a 1/(a−1)-th power of (a value acquired by integrating, with respect to P, ((an (a−1)-th power of ((dP/dQ)(x))) over a support of P))). Rényi divergence of infinite order is defined as follows. That is, R_infinity(P∥Q) is an essential supremum of ((dP/dQ)(x)) over the support of P.

Lemma 5. Let X and Y be two random variables following probability distributions P_X and P_Y, respectively, and let a support of P_X be a subset of a support of P_Y. For any order a (where 1<a<infinity), the following properties hold.

First, Log. Positivity. R_a(P_X∥P_Y) is equal to or greater than R_a(P_X P_X) (i.e., 1).

Second, Data Processing Inequality. For any function f, R_a(P_f(X)∥P_f(Y)) is equal to or less than R_a(P_X∥P_Y). Here, P_f(Z) refers to a distribution of f(Z) when Z is X or Y.

Third, Multiplicativity. Let X=(X_1, X_2) and Y=(Y_1, Y_2). Let P_(X_1) and P_(Y_1) be probability distributions of X_1 and Y_1, respectively, and let P_(X_2|X_1=x) and P_(Y_2|Y_1=x) be distributions of X_2 and Y_2 conditioned on X_1=x and Y_1=x. When X_1 and X_2 are independent, and Y_1 and Y_2 are also independent, R_a(P_X∥P_Y) is equal to (a product of R_a(P_(X_1)∥P_(Y_1)) and R_a(P_(X_2)∥P_(Y_2))). Otherwise, R_a(P_X∥P_Y) is equal to or less than (a product of R_infinity(P_(X_1)∥P_(Y_1)) and (a maximum value of R_a(P_(X_2|X_1=x)∥P_(Y_2|Y_1=x)) for x belonging to a support of P_(X_1))).

Fourth, Probability Preservation. For any event E belonging to a support of P_Y, P_Y(E) is equal to or greater than (a value acquired by dividing (an (a/(a−1))-th power of P_X(E)) by R_a(P_X∥P_Y)).

In addition, Rényi divergence is non-decreasing as a function of order a (where 1≤a≤infinity), and is continuous while its value is finite.

Finally, the following result regarding Rényi divergence of two shifted Gaussian distributions having the same standard deviation is revisited (which is adopted from [LSS14, Lemma 4.2]).

Lemma 6. Let eta be a positive real number and c be a real number. For any a (where 1<a<infinity), R_a(D_(eta, c)∥D_eta) is equal to or less than (an exponential value whose exponent is (a value acquired by dividing (a product of a, pi, and (a square of c)) by (a square of eta))). From the foregoing, for any positive integer N, the following inequality holds by multiplicativity. That is, R_a(D_(N, eta, c)∥D_(N, eta)) is equal to or less than (an exponential value whose exponent is (a value acquired by dividing (a product of N, a, pi, and (a square of c)) by (a square of eta))).

### A.2. Fully Homomorphic Encryption

The definition of Fully Homomorphic Encryption (FHE) is revisited.

Definition 7. Fully Homomorphic Encryption is a tuple of PPT algorithms including KeyGen, Enc, Dec, and Eval, and is defined as follows.

The KeyGen algorithm receives a security parameter lambda as an input, and outputs a public key pk, an evaluation key evk, and a secret key sk.

The Enc algorithm receives the public key pk and plaintext M as inputs, and outputs a ciphertext ct.

The Eval algorithm receives the evaluation key evk, a circuit C, and a tuple of k ciphertexts (ct_i) as inputs (where k is the number of input wires of the circuit C), and outputs a ciphertext ct.

The Dec algorithm receives the secret key sk and the ciphertext ct as inputs, and outputs plaintext M′_.

Correctness. For any key pair (pk, evk, sk) generated from the KeyGen algorithm, any circuit C, and any plaintext tuple (M_i) (where i is from 1 to k), when a result acquired by inputting the secret key and an evaluation result to the Dec algorithm (i.e., Dec(sk, Eval(evk, C, (ct_i)))) is the same as a result acquired by inputting the plaintext tuple to the circuit C (i.e., C((M_i))), the scheme according to the present disclosure is known to be perfectly correct. Here, each ciphertext ct_i is acquired by inputting the public key pk and the corresponding plaintext M_i to the Enc algorithm.

Security. For any PPT attacker A, when an IND-CPA advantage Adv\hat{ }indcpa(A) is negligible, the scheme according to the present disclosure is known to be IND-CPA secure. Here, the IND-CPA advantage is defined as follows. That is, the IND-CPA advantage is an absolute value of a value acquired by multiplying, by 2, a probability that the attacker correctly guesses a bit b randomly selected by a challenger in a game with the challenger and subtracting 1. Here, the game includes: generating, by the KeyGen algorithm, a key pair; receiving, by the attacker, the public key and the evaluation key and outputting two plaintexts (M_0, M_1); sampling, by the challenger, the bit b from a uniform distribution of 0 or 1; and receiving, by the attacker, a ciphertext for a b-th plaintext M_b and outputting b′.

The threshold signature according to the present disclosure relies on converting a Fully Homomorphic Encryption scheme into a threshold version by distributing the secret key and separating a decryption operation into two steps (i.e., PartDec and FinDec). This approach follows the structure of Threshold Fully Homomorphic Encryption according to [AJL+12, BGG+18]. The present disclosure may rely on a Threshold Fully Homomorphic Encryption scheme in a black-box manner. However, the present disclosure adopts a method relying on Rényi divergence in security analysis to acquire smaller decryption shares.

Converting a Fully Homomorphic Encryption Scheme into a Threshold Version. The present disclosure relies on a Fully Homomorphic Encryption scheme in which a ciphertext has a form of two components (a, b) and satisfies the following relationship. That is, a result acquired by combining a secret key s with the two components of the ciphertext (i.e., a result acquired by adding b to (a product of a and the secret key)) is congruent modulo q to a value acquired by adding a small error term e to a value acquired by multiplying plaintext M by a scale factor Delta. Here, the secret key s is an element of a polynomial ring R\hat{ }FHE, M is plaintext, e is an error term having an infinity norm equal to or less than a certain upper bound B_eval, and Delta is the scale factor.

The present disclosure converts a decryption operation into a threshold version by distributing the secret key s in a form of sk_i. Here, the distribution is performed by a t-of-n linear secret sharing scheme Share (see Definition 9).

For simplification, the present disclosure focuses on an n-of-n case (i.e., a case in which all participants are required to cooperate). However, this configuration may be extended to a t-of-n environment with ordinary technical adjustments according to [BGG+18, MBH23]. In this environment, the secret key s may be expressed as a sum of secret key fragments of all participants (i.e., s=sk_1+ . . . +sk_n). Next, the partial decryption algorithm PartDec is defined as follows. That is, PartDec receives, as inputs, a secret key fragment sk_i of an i-th participant and a ciphertext (a, b), and returns, as partial decryption information p_i, (a value acquired by adding flooding noise e_i to (a product of a and sk_i)). Here, the flooding noise e_i is an error term sampled from a distribution D_flood.

In addition, the final decryption algorithm FinDec is defined as follows. That is, FinDec receives, as inputs, the ciphertext (a, b) and partial decryption information (p_i) of all participants, and outputs a value acquired by adding, to b, (a sum of all partial decryption information). This value is the same as a value acquired by adding (a sum of all flooding noise) to a value acquired by adding, to b, (a product of a and the secret key s).

It should be noted that flooding noise may overwrite plaintext when plaintext precision (i.e., a ratio between the scale factor and a noise magnitude) is not sufficient. Instead of using high plaintext precision throughout operations, the present disclosure performs operations with precision sufficient to acquire final plaintext when the final plaintext is binary, and then prepares for flooding through a cleaning process. A purpose of cleaning is to increase plaintext precision.

The present disclosure allows flooding noise distribution D_flood to be set to D_(N, eta) according to security based on Rényi divergence. Here, a threshold flooding parameter eta is set to satisfy the following inequality. That is, eta is equal to or greater than a value acquired by multiplying (an upper bound B_eval of an error term) by (a square root of (a value acquired by multiplying 10 by a ring degree N and an upper bound q_sig of the number of signing queries by the attacker)). In contrast, when relying on a Threshold Fully Homomorphic Encryption scheme in a black-box manner, the flooding parameter becomes an order of (a value acquired by multiplying B_eval by 2\hat{ }(lambda/2)), and performance deteriorates. This fact was already recognized in [ASY22].

### A.3. Digital Signatures

The definition of digital signatures is revisited.

Definition 8. A digital signature scheme is a tuple of PPT algorithms including (KeyGen, Sign, Verify), and is defined as follows.

The KeyGen algorithm receives a security parameter lambda as an input, and outputs public parameters pp, a verification key vk, and a signature key sk.

The Sign algorithm receives, as inputs, the public parameters pp, the signature key sk, and a message M, and outputs a signature sigma.

The Verify algorithm receives, as inputs, the verification key vk, the message M, and the signature sigma, and outputs a bit b of 0 or 1.

Correctness. For a positive real number epsilon, when, for any message M, a probability that the Verify algorithm outputs 1 is equal to or greater than (a value acquired by subtracting a negligible function negl(lambda) from 1), the scheme according to the present disclosure is known to be epsilon-correct. Here, the public parameters, the verification key, and the signature key are generated by the KeyGen algorithm, and the signature is a result acquired by applying the Sign algorithm to the public parameters, the signature key, and the message. In addition, the probability is taken over random coins of the KeyGen and Sign algorithms.

Strong Unforgeability. For any PPT attacker A, when a probability that an output of a security game Exp_A\hat{ }uf is 1 (i.e., an advantage Adv\hat{ }uf(A) of the attacker) is negligible, the scheme according to the present disclosure is known to satisfy strong unforgeability. Here, the security game Exp_A\hat{ }uf is defined as Algorithm 3.

### Algorithm 3. Definition of Security Experiment Exp_A\hat{ }uf

(Algorithm 3 is an algorithm specification for the security experiment Exp_A\hat{ }uf. The attacker A receives the security parameter lambda, the challenger executes the KeyGen algorithm to generate the public parameters, the verification key, and the signature key, and the attacker has access to a signing oracle OSign and generates a forgery (M*, sigma*). When verification is successful and the forged message-signature pair is not included in a response list L, the security game outputs 1. The OSign oracle receives a message M as an input, executes the Sign algorithm to derive a signature sigma, adds (M, sigma) to the response list L, and then returns sigma).

### A.4. Threshold Linear Secret Sharing Schemes

The definition of a threshold Linear Secret Sharing Scheme (LSSS) over a ring R is revisited.

Definition 9. A Linear Secret Sharing Scheme LSSS includes PPT algorithms (Share, Combine), and is defined as follows.

The Share algorithm receives, as inputs, a secret s (where s is an element of R), the number of participants n (where the participants are denoted by P_i), and a threshold t (where t is equal to or less than n), and outputs shares sh_i (where i is from 1 to n).

The Combine algorithm receives, as an input, a subset {sh_i} of shares (where i belongs to a subset S), and outputs a value s′ (where s′ is an element of R).

For any n≥t>0 and any subset S from 1 to n, when a size of S is t, S is known to be valid, and otherwise is known to be invalid. In addition, the following properties are required to hold.

Correctness. For any secret s (where s is an element of R) and shares sh_i derived by the Share algorithm, for any valid subset S, Combine({sh_i} (where i belongs to S))=s holds.

Linearity. When the Combine algorithm is a linear function, the scheme according to the present disclosure is known to be linear.

Privacy. For any secrets s and s′ (both of which are elements of R) and any invalid subset S, the following two distributions are the same. That is, a subset {sh_i} (where i belongs to S) of shares derived by Share(s, n, t) and a subset {sh′_i} (where i belongs to S) of shares derived by Share(s′, n, t) are the same.

### A.5. Dilithium

An exact description of a deterministic version of Dilithium is revisited in Algorithm 4 [BDK+21]. The present disclosure uses the same notation and basic functions as the Dilithium document [BDK+21], and for definitions thereof, refer to the Dilithium document. In the signature algorithm Sign, w_1 of Step 8 is referred to as a commitment, c of Step 10 is referred to as a challenge, and z of Step 11 is referred to as a response.

Algorithm 4. Deterministic Dilithium

```
Dilithium.KeyGen:
2. zeta <- sampled from a 256-bit uniform distribution U
({0, 1}\hat{ }256)
3. (rho, rho′, K) <- H(zeta)
4. A <- ExpandA(rho); A is an element of
(R_q\hat{ }SIG)\hat{ }(k_x ell)
5. (s_1, s_2) <- ExpandS(rho′); s_1 is an element of S_e
ta\hat{ }ell,
        i. s_2 is an element of S_eta\hat{ }k
6. t <- value acquired by adding s_2 to a product of A and
s_1 (modular reduction with
  respect to q)
7. (t_0, t_1) <- Power2Round_q(t, d)
8. tr <- concatenation of rho and t_1; tr is an element of
{0, 1}\hat{ }384
9. return vk = (rho, t_1),
  1. sk =(rho, K, tr, s_1, s_2, t_0)
Dilithium.Sign (sk, M):
1. A <- ExpandA(rho)
2. mu <- H(concatenation of tr and M)
3. kappa <- 0; (z, h) <- bot
4. rho′ <- H(concatenation of K and mu)
5. while (z, h) = bot do
6. y <- ExpandMask(rho′, kappa); y is an element of S_
(gamma_1 - 1)\hat{ }ell
7. w <- product of A and y (modular reduction with
respect to q)
8. w_1 <- HighBits(w, 2 multiplied by gamma_2)
9. c_tilde <- H(concatenation of mu and w_1); c_tilde is
an element of {0, 1}\hat{ }256
10. c <- SampleInBall(c_tilde); c is an element of B tau
11. z <- value acquired by adding a product of c and s_1
to y
12. r 0 <- LowBits_q(value acquired by subtracting a
product of c and s_2 from w,
      A. 2 multiplied by gamma_2)
13. if (infinity norm of z is equal to or greater than gamma_
1 - beta)
  1. or (infinity norm of r_0 is equal to or greater than
  gamma_2 - beta)
    then
14. (z, h) <- bot
15. else
16. h <- MakeHint_q
        i. (value acquired by reversing a sign of a
        product of c and t_0,
      B. value acquired by subtracting a product of c and
      s_2f rom w
        i. and adding a product of c and t_0,
      C. 2 multiplied by gamma_2)
17. if (infinity norm of a product of c and t_0 is equal to or
greater than gamma_2)
    (1) or (Hamming weight HW(h) of h exceeds omega)
  2. then (z, h) <- bot
18. kappa <- value acquired by adding ell to kappa
19. return sigma = (z, h, c_tilde)
Dilithium. Verify (vk, M, sigma = (z, h, c_tilde)):
1. A <- ExpandA(rho)
2. mu <- H(concatenation of H(concatenation of rho and
t_1) and M)
3. c <- SampleInBall(c_tilde)
4. w′ 1 <- UseHint_q(h,
  1. value acquired by subtracting,
      A. from a product of A and z,
      B. a value acquired by multiplying a product of c
      and t_1 by 2\hat{ }d
  2. 2 multiplied by gamma_2)
5. return (infinity norm of z is less than gamma_1 - beta)
  1. and (c_tilde = H(concatenation of mu and w′_1))
  2. and (Hamming weight HW(h) of h is equal to or less
  than omega)
```

### APPENDIX B. PROOF OF THEOREM 2

First, it is discussed that modifying the signing scheme according to the present disclosure to perform verification on the Hamming weight of the hint vector h only after decryption (Algorithm 2, Steps 6 to 8) does not impair security. This modification indicates that the present disclosure performs rejection slightly insufficiently (i.e., about 2% of derived signatures do not pass this verification). In addition, this modification indicates that an invalid signature rejected in Dilithium is disclosed to an attacker. However, such a disclosure is not actually a problem. That is, the hint does not serve any function in security of Dilithium. The hint is provided in Dilithium because t_0 is not known to a verifier. Accordingly, to discuss security of the configuration according to the present disclosure, the present disclosure may rely on unforgeability of a Dilithium variant without verification key compression. In this variant, a vector t is public and the hint h is not present. Nevertheless, the verification key may be compressed, and the hint h may be derived from the signature using Equation (3). Accordingly, any attacker against the threshold scheme according to the present disclosure may lead to an attacker against unforgeability of the Dilithium variant without verification key compression. As a result, the present disclosure discusses security of the scheme according to the present disclosure by relying on unforgeability of a deterministic variant of Dilithium without verification key compression.

For simplification, the present disclosure focuses on a case in which t=n. That is, this case corresponds to a case in which an FHE decryption key s satisfies sk_1+ . . . +sk_n. The proof extends beyond this environment with ordinary technical adjustments (e.g., see [BGG+18, MBH23]).

The threshold signature according to the present disclosure has the following structure.

PartSign1(pp, sk_i, M) homomorphically evaluates Sign1. At an end of this first step, a ciphertext (a, b) encrypting a commitment w_1=(w_1\hat{ }(1), . . . , w_1\hat{ }(L)) is acquired. This ciphertext has a form in which (a result acquired by adding b to (a product of a and the secret key s)) satisfies (a value acquired by adding a small operation error e_eval to (a value acquired by multiplying the scale factor Delta by w_1)). Here, an infinity norm of e_eval is equal to or less than a certain upper bound B_eval. Next, partial decryption out_(1, i) of (a, b) for a key fragment sk_i is defined and returned as follows. That is, out_(1, i):=(a value acquired by adding e_(1, i) to (a product of a and sk_i)). Here, e_(1, i) is Gaussian noise sampled from a distribution D_(N, eta).

When all partial decryptions (out_(1, 1), . . . , out_(1, n)) of (a, b) are given, shares may be combined to restore w_1. The following relationship holds. That is, (a value acquired by adding e to (a value acquired by multiplying the scale factor by w_1)) is equal to (a value acquired by adding, to b (which is a sum of all partial decryptions)). Here, a decryption error term e is (a value acquired by adding (a sum of all e_(1, i)) to e_eval).

Similarly, PartSign2(pp, sk_i, out_1, M) homomorphically evaluates Sign2 to acquire a ciphertext (a′, b′) encrypting a response z:=(z\hat{ }(1), . . . , z\hat{ }(L)). This ciphertext has a form in which (a result acquired by adding b′ to (a product of a′ and the secret key)) satisfies (a value acquired by adding a small operation error e′eval to (a value acquired by multiplying the scale factor by z)). Here, an infinity norm of e′eval is equal to or less than B_eval. Partial decryption out(2, i) of (a′, b′) using the key fragment sk_i is defined and returned as follows. That is, out(2, i):=(a value acquired by adding e_(2, i) to (a product of a′ and sk_i)). The following relationship holds. That is, (a value acquired by adding e′ to (a value acquired by multiplying the scale factor by z)) is equal to (a value acquired by adding, to b′, (a sum of all partial decryptions out_(2, i))). Here, e′ is (a value acquired by adding (a sum of all e_(2, i)) to e′_eval).

Here, security analysis for the threshold signature scheme is provided.

Let A be an attacker against unforgeability of the threshold signature scheme according to the present disclosure described with reference to FIG. 12. Let S_cor be a set of n−1 participants corrupted by A. For simplification, assume that A queries OPartSign1 and OPartSign2 only for a case in which i does not belong to S_cor. This assumption loses no generality, because A knows a corresponding secret key fragment sk_j and may directly respond to any query for j belonging to S_cor. The goal of the present disclosure is to prove unforgeability based on security (and correctness) of the FHE scheme and security of Dilithium. The present disclosure relies on the Dilithium analysis of [BdCE+26], which proves that Dilithium is secure given aborted transcripts. That is, unforgeability of Dilithium holds even when an attacker has oracle access to OSign1. OSign1 may be queried with a message M, and returns L aborted transcripts, that is, commitments (w_1\hat{ }(1), . . . , w_1\hat{ }(L)). The attacker may also access a standard signing oracle OSign, which returns a valid signature. Because the present disclosure relies on a deterministic variant of Dilithium (without verification key compression), a valid Dilithium signature is a pair (c, z), which is a first signature passing rejection verification. According to the verification algorithm, a corresponding commitment w_1 may be restored, and therefore, by matching w_1 with an aborted transcript, an index i corresponding to the first successful signature (where i is from 1 to L) may be known (because a match exists as the scheme is deterministic).

Here, security analysis of the present disclosure proceeds through a series of hybrid games defined as follows.

Hyb_0: This game is the threshold unforgeability game described in Algorithm 1.

Hyb_1: In this hybrid game, a method by which the challenger responds to signing queries for OPartSign1 and OPartSign2 is changed.

When A makes an OPartSign1(i, M) query, the challenger performs the following. First, the challenger executes the Dilithium signing protocol L times (in the plaintext domain) to restore ((w_1\hat{ }(1), c\hat{ }(1), z\hat{ }(1)), . . . , (w_1\hat{ }(L), c\hat{ }(L), z\hat{ }(L))). Next, the challenger homomorphically derives a ciphertext (a, b) as follows. Recall that an expected output of PartSign1(pp, sk_i, M) is partial decryption out_(1, i) of (a, b) by participant Pi. Because it is assumed that i does not belong to S_cor, an output of OPartSign1(i, M) is sufficient for the attacker to restore w_1:=(w_1\hat{ }(1), . . . w_1\hat{ }(L)).

Recall that (a, b) satisfies a relationship in which (a value acquired by adding (a product of a and the secret key s) to b) is the same as (a value acquired by adding e_eval to (a value acquired by multiplying the scale factor by w_1)). Here, e_eval is an underlying noise term, s is the FHE secret key, and the following relationship holds. That is, s is the same as (a value acquired by adding sk_i and (a sum of sk_j for j belonging to S_cor)).

Then, in Hyb_1, the challenger responds to the OPartSign1(i, M) query as follows. The challenger derives (a, b) as above, and samples e_fl from the distribution D_(N, eta). Next, the challenger samples out_(1, i) as follows (Equation 6).

That is, out_(1, i)<-(a value acquired by subtracting (a sum of products of a and sk_j for j belonging to S_cor) and subtracting b from (a value acquired by multiplying the scale factor by w_1), and adding e_fl).

Similarly, when A makes an OPartSign2(i, out_1, M) query, the challenger first executes the deterministic Dilithium signing protocol (in the plaintext domain) to restore ((w_1\hat{ }(1), c\hat{ }(1), z\hat{ }(1)), . . . , (w_1\hat{ }(L), c\hat{ }(L), z\hat{ }(L))). Next, the challenger derives a ciphertext (a′, b′) to be partially decrypted during this step. (a′, b′) satisfies a relationship in which (a value acquired by adding (a product of a′ and s) to b′) is the same as (a value acquired by adding e′_eval to (a value acquired by multiplying the scale factor by z)). Finally, the challenger samples e′fl from the distribution D(N, eta) and returns the following (Equation 7).

That is, out_(2, i)<-(a value acquired by subtracting (a sum of products of a′ and sk_j for j belonging to S_cor) and subtracting b′ from (a value acquired by multiplying the scale factor by z), and adding e′_fl).

Lemma 10. Assuming perfect correctness of the threshold FHE scheme, when a success probability of an attacker breaking unforgeability in Hyb_0 is epsilon, a success probability of the attacker in Hyb_1 is equal to or greater than (a value acquired by dividing (a square of epsilon) by 2).

Proof. The only difference between Hyb_0 and Hyb_1 is that, because the present disclosure simulates a partial decryption query based on a result of decryption, an operation error e_eval generated from homomorphic evaluation of a first step (or second step) of the underlying signing scheme is missing from a partial decryption share. Specifically, in Hyb_1, out_(1, i) is set to (a value acquired by subtracting (a sum of products of a and sk_j for j belonging to S_cor) and subtracting b from (a value acquired by multiplying the scale factor by w), and adding e_fl), whereas in Hyb_0, out_(1, i) is the same value additionally added with e_eval.

For simplification, public parameters, a verification key, and corrupted partial secret keys {sk_j} (where j belongs to S_cor, are ignored in the analysis). This omission is possible because these keys are fixed before the attacker makes any query. However, messages queried by the attacker to his oracle and responses received by the attacker are not fixed, and may adaptively depend on previous queries. Let D_b be a distribution in Hyb_b (where b is 0 or 1).

Let Q_j be a random variable corresponding to an input of a j-th query, which may be a query to OPartSign1 or OPartSign2, and let Q_(b, j) be its distribution in Hyb_b (where b is 0 or 1).

Similarly, let E_j be a random variable corresponding to an error term corresponding to a j-th ciphertext derived and partially decrypted in the j-th query, and let E_(b, j) be its distribution in Hyb_b (where b is 0 or 1). According to definitions of Hyb_0 and Hyb_1, E_(1, j)=D_(N, eta) and E_(0, j)=D_(N, eta, e_eval, j). Here, e_eval, j is an operation error of a ciphertext partially decrypted in the j-th query.

Let q_sig be a total number of queries made by the attacker. Then, D_b is (E_(b, q_sig), Q_(b, q_sig), . . . , E_(b, 1), Q_(b, 1)) (where b is 0 or 1), and the goal of the present disclosure is to measure R_a(D_0∥D_1).

By the multiplicativity property of Rényi divergence (Lemma 5), the following holds.

R_a(D_0∥D_1) is equal to or less than (a value acquired by multiplying (a maximum value, for x belonging to X, of R_a(E_(0, q_sig)|X=x∥E_(1, q_sig)|X=x)) by R_a(Q_(0, q_sig), . . . , E_(0, 1), Q_(0, 1)∥Q_(1, q_sig), . . . , E_(1, 1), Q_(1, 1))). In addition, this value is equal to or less than (a value acquired by multiplying the same R_a term by (an exponential value whose exponent is (a value acquired by dividing (a product of N, a, pi, and (a square of B_eval)) by (a square of eta)))).

Here, the last inequality follows from Lemma 6 and the infinity norm of e_eval being equal to or less than B_eval. Indeed, the following relationship holds. That is, R_a(E_(0, q_sig)∥E_(1, q_sig))=R_a(D_(N, eta, e_eval, q_sig)∥D_(N, eta)), which is equal to or less than (an exponential value whose exponent is (a value acquired by dividing (a product of N, a, pi, and (a square of e_eval, q_sig)) by (a square of eta))), and the exponential value is again equal to or less than (an exponential value whose exponent is (a value acquired by dividing (a product of N, a, pi, and (a square of B_eval)) by (a square of eta))).

Here, Q_(q_sig) is an adaptive query by the attacker given all previous information, and is thus a function of E_(q_sig−1), Q_(q_sig−1), . . . , E_1, Q_1. By the data processing inequality (Lemma 5), the following holds.

R_a(Q_(0, q_sig), E_(0, q_sig−1), . . . , E_(0, 1), Q_(0, 1)∥ Q_(1, q_sig), E_(1, q_sig−1), . . . , E_(1, 1), Q_(1, 1)) is equal to or less than R_a(E_(0, q_sig−1), . . . , E_(0, 1), Q_(0, 1)∥E_(1, q_sig), . . . , E_(1, 1), Q_(1, 1)).

Using recursion, the following is acquired (Equation 8).

That is, R_a(D_0∥D_1) is equal to or less than (an exponential value whose exponent is (a value acquired by dividing (a product of N, a, pi, (a square of B_eval), and q_sig) by (a square of eta))).

When eta is set to (a value acquired by multiplying B_eval by (a square root of (a value acquired by multiplying 10 by N and q_sig))), R_a(D_0∥D_1) is equal to or less than (an exponential value whose exponent is (a value acquired by dividing (a product of a and pi) by 10)). By the probability preservation property of Rényi divergence, the claim of the present disclosure is acquired by setting a=2. That is, the following holds.

The probability that A wins in Hyb_1 is equal to or greater than (a value acquired by multiplying (a square of the probability that A wins in Hyb_0) by (an exponential value whose exponent is (a negative value acquired by dividing (a product of 2 and pi) by 10))).

Because the exponential value whose exponent is (the negative value acquired by dividing (the product of 2 and pi) by 10) is equal to or greater than ½, the claim of the present disclosure is established.

Hyb_2: This game is defined as Hyb_1, except that shares of the FHE secret key are here replaced with shares of 0. That is, {sk_i} (where i is from 1 to n) is set to Share(0). According to privacy of the secret sharing scheme (Definition 9), the two games are perfectly indistinguishable.

Hyb_3: In this game, the encrypted signature key, including the PRF key, is replaced with an encryption of 0. It is noted that this change is possible because the challenger here simulates partial decryption from a Dilithium signature derived in the plaintext domain. Due to IND-CPA security of the FHE scheme, games Hyb_2 and Hyb_3 are computationally indistinguishable.

Here, the security proof for the signature of the present disclosure may be completed by proving the following lemma.

Lemma 11. When a success probability of an attacker A breaking unforgeability in Hyb_3 is epsilon, there exists an attacker having oracle access to aborted transcripts for Dilithium, and the attacker breaks unforgeability with a success probability epsilon with an execution time essentially identical to an execution time of A.

Proof. Let A be an attacker successfully breaking unforgeability in Hyb_3. An attacker B against unforgeability of Dilithium having oracle access to aborted transcripts is configured as follows. The attacker B receives a signature verification key vk from a challenger of the attacker B. B generates an FHE public key and secret key pair, and derives an encryption of 0 for the encrypted signature key and the encrypted PRF key. In addition, B generates {sk_i} (where i is from 1 to n)<-Share(0). Next, B executes A. When the latter sends a corruption target set S_cor, B delivers public parameters to A, and also delivers a partial signature key sk_j for a case in which j belongs to S_cor. Next, when A makes a query to OPartSign1 (or OPartSign2) for a certain message M in a case in which i does not belong to S_cor, the attacker B makes a signing query with the message M to an oracle OSign1 (or OSign) for aborted transcripts. The attacker B acquires, as a response, (w_1\hat{ }(1), . . . , w_1\hat{ }(L)) or (c, z), and responds to A by deriving the requested partial decryption using the simulation described in Equation (6) (or Equation (7)). In the latter case, B first restores an index I (where i is from 1 to L) corresponding to the response by comparing a commitment w_1 induced by the response z with an aborted commitment acquired from OSign1 for the same message. When A terminates with a forgery (M*, sigma*), B also terminates together.

The foregoing completes the proof of Theorem 2.

Concrete Selection for Flooding Parameter eta. The above proof sets eta to a value acquired by multiplying B_eval by a square root of a value acquired by multiplying 10 by N and q_sig, which is sufficient to make the proof proceed in a theoretical sense. Here, a method by which eta is concretely set for practical deployment is described. To this end, return to Equation (8) in the proof of Lemma 10.

Define epsilon_b=Pr[A wins Hyb_b] (where b is 0 or 1). By the probability preservation property of Rényi divergence, the following holds. That is, (a (a/(a−1))-th power of epsilon_0) is equal to or less than (a value acquired by multiplying epsilon_1 by R_a(D_0∥D_1)). Then, from Equation (8), the following is acquired. That is, (a (a/(a−1))-th power of epsilon_0) is equal to or less than (a value acquired by multiplying epsilon_1 by (an exponential value whose exponent is (a value acquired by dividing (a product of N, a, pi, (a square of B_eval), and q_sig) by (a square of eta))))).

Raise both sides of the above inequality to the ((a−1)/a)-th power, and define eta as follows. That is, eta=(a value acquired by multiplying B_eval by (a square root of (a product of N, pi, q_sig, natural logarithm ln(2), and x))), where x is a positive real number. Then, the following holds. That is, epsilon_0 is equal to or less than (a value acquired by multiplying (a ((a−1)/a)-th power of epsilon_1) by (a ((a−1)/x)-th power of 2)).

The goal of the present disclosure is to make T_0/epsilon_0 equal to or greater than 2\hat{ }128. The goal is achieved under an assumption that T_1/epsilon_1 is slightly higher than 2\hat{ }128. Here, T_b is an execution time of the attacker in Hyb_b (where b is 0 or 1). It is noted that T_0=T_1, and only epsilon_b changes in transition between Hyb_0 and Hyb_1. Define E_b=−log_2(epsilon_b) (where b is 0 or 1). Then, by passing the above inequality through log_2, the following is desired. That is, (a value acquired by subtracting ((a−1)/x) from (a value acquired by multiplying E_1 by ((a−1)/a)))) is equal to or less than E_0. The equality holds when x is (a value acquired by dividing (a product of a and (a−1)) by (a value acquired by subtracting (a product of E_0 and a) from (a product of E_1 and (a−1))))). The goal of the present disclosure is to minimize x for a>1 and a given E_1, and the minimization of x is to minimize eta. The minimization is achieved by setting a to (a value acquired by dividing (a square root of E_1) by (a value acquired by subtracting (a square root of E_0) from (the square root of E_1)))), and consequently x becomes (a value acquired by dividing 1 by (a square of (a value acquired by subtracting (a square root of E_0) from (a square root of E_1))))). The following is acquired.

log_2(eta) is equal to (a value acquired by subtracting log_2(a value acquired by subtracting (a square root of E_0) from (a square root of E_1)) from log_2(a value acquired by multiplying B_eval by (a square root of (a product of N, pi, q_sig, and natural logarithm ln(2))))).

When N=2\hat{ }16 and q_sig=2\hat{ }64, because log_2(a square root of (a product of pi and natural logarithm ln(2))) is about 0.56, the following holds.

log_2(eta) is approximately equal to log_2(B_eval)+40.56−log_2(a value acquired by subtracting (a square root of E_0) from (a square root of E_1)).

Assuming that E_1 is equal to or greater than E_0+1 (i.e., at most 1 bit of security is lost between Hyb_0 and Hyb_1), it may be verified that −log_2(a value acquired by subtracting (a square root of E_0) from (a square root of E_1)) is equal to or less than 5 for every E_1<256. Therefore, to limit security loss to 1 bit, for any security level less than 256 bits, it is sufficient to set eta to (a value acquired by multiplying 2\hat{ }46 by B_eval). Finally, it is noted that a Gaussian polynomial e having N=2\hat{ }16 coordinates and sampled according to D_eta satisfies an infinity norm equal to or less than (6 multiplied by eta) with a probability equal to or greater than (a value acquired by subtracting 2\hat{ }−128 from 1). The probability is sufficient for flooding with Gaussian error, which is Gaussian error at most 49 bits larger than B_eval.

### APPENDIX D. ADDITIONAL IMPLEMENTATION ASPECTS

### D.1. Error Analysis and Noise Flooding

The present disclosure analyzed errors of ciphertexts in units of coefficients. More precisely, first, deviations from the nearest integers of decrypted slot values were measured and decoded, and then errors of coefficients to be used during threshold decryption were extracted (multiples of 4 from 0 to (N/2−1) in Round 1 and all multiples of 64 in Round 2). These deviations indicate noise in coefficients normalized by the scale factor Delta. These measurements were used to set a size of noise flooding.

After Round 2, an output ciphertext includes a valid signature when signing is successful, and includes a zero vector when signing fails. The present disclosure analyzed each case separately. It is noted that, when a ciphertext is decrypted into a zero vector, each error of coefficients is an integer divided by the scale factor. Therefore, as verified in experiments of the present disclosure, these errors are discrete.

FIG. 13 illustrates error distributions before threshold decryption during PartSign1, PartSign2 when signing is successful, and PartSign2 when all samples are rejected. All error distributions follow a Gaussian distribution or a rounded Gaussian distribution, and p-values of the Kolmogorov-Smirnov test (K-S test) are 0.79, 0.92, and 0.68, respectively. It is noted that kurtosis of error distributions of Round 1 and Round 2 before decryption is all 3.00.

Worst errors in coefficients among 1000 repetitions were (2\hat{ }−98.77), (2\hat{ }−79.37), and (2\hat{ }−79.44), respectively, and standard deviations sigma were (2\hat{ }−101.26), (2\hat{ }−81.72), and (2\hat{ }−81.73), respectively.

The present disclosure added 60-bit flooding noise above conservative error bounds. Here, the conservative error bounds are (2\hat{ }−90) and (2\hat{ }−75) in Round 1 and Round 2, respectively. The upper bounds correspond to (2447.49 multiplied by sigma) and (105.64 multiplied by sigma), respectively, and (105.77 multiplied by sigma) for rejected ciphertexts. Assuming that an error distribution is Gaussian, a probability that an error occurs in a tail is significantly smaller than (2\hat{ }−8000). The probability guarantees that, with a probability greater than (a value acquired by subtracting (2\hat{ }−128) from 1), any ciphertext decrypted during signing does not include a slot having an abnormal error. According to the theoretical analysis of Section 3.3 and the concrete discussion at the end of Appendix B, the probability allows q_sig=(2\hat{ }64) signature issuances to be supported.

(FIG. 13: Error distributions before threshold decryption in each round. (a) is for PartSign1 and includes 65,536,000 error values acquired through 1000 repetitions. (b) is for PartSign2 including non-rejected signatures and includes 57,933,824 error values acquired from 884 samples. (c) is for PartSign2 in which all signatures are rejected and includes 7,602,176 error values acquired from 116 samples).

### D.2. Detailed Experimental Results

In Tables 2 and 3, the present disclosure lists main steps performed homomorphically. For each step, input and output ciphertext moduli and scale factors, and time consumed by the corresponding step are provided.

During the cleaning step, the scale factor Delta and the error term are amplified in each repetition of the cleaning map h_1 (i.e., a map that maps an input x to a value acquired by subtracting a product of 2 and a cube of x from a product of 3 and a square of x). A rescaling operation of CKKS is used to suppress errors. In particular, the present disclosure conservatively sets a rescaling amount to be large, allowing a dominant error component after rescaling to originate from the rescaling procedure itself, and not from an error accumulated before rescaling. Specifically, after each evaluation of the cleaning map h_1, the present disclosure performs rescaling by a number of bits greater than log(14 multiplied by a square root of a value acquired by dividing N by 24 multiplied by hwt). Here, hwt is a Hamming weight of the secret key, and the hwt term corresponds to CKKS encoding.

TABLE 2
Homomorphic Operations for PartSign1

| | Input (log q, | Output (log q, | |
|---|---|---|---|
| Step | log Delta) | log Delta) | Latency |
| Small-Integer BTS | (38, 32.0) | (821, 38.0) | 71.4 ms |
| Bit Extraction | (813, 30.0) | (663, 31.0) | 37.2 ms |
| Random Bit Cleaning | (654, 22.0) | (613, 25.0) | — |
| | | (569, 31.1) | — |
| | | (519, 43.4) | — |
| | | (456, 67.2) | — |
| | | (366, 111.6) | 25.3 ms |
| Multiplication Tree of Most | (663, 31.0) | (508, 31.5) | 14.9 ms |
| Significant Bit (MSB) | | | |
| Derivation of Least | (456, 67.2) | (344, 45.9) | 3.1 ms |
| Significant Bit (LSB) | | | |
| Derivation of y | (366, 111.6) | (241, 120.5) | 1.1 ms |
| Derivation of C2S and w | (266, 66.0) | (68, 45.0) | 11.2 ms |
| Bit Extraction for w | (68, 45.0) | (663, 31.0) | 537.0 ms |
| Modular Reduction with | (663, 31.0) | (499, 22.9) | 28.8 ms |
| respect to q | | | |
| Bit BTS | (499, 22.9) | (516, 40.4) | 44.2 ms |
| Modular Reduction with | (516, 40.4) | (414, 23.5) | 106.0 ms |
| respect to (2 multiplied by | | | |
| gamma_2) | | | |
| Bit Cleaning and Combination | (413, 22.5) | (121, 110.8) | 119.3 ms |
| BTS of LowBits and LSB | (413, 22.5) | (661, 59.0) | 41.6 ms |
| Threshold Decryption | (121, 113.8) | — | — |
| Total | — | — | 1041.2 ms |

For all steps, a ciphertext modulus q and a scale factor Delta at start and end points of the step are provided in bits.
″MSB″ and ″LSB″ refer to the most significant bit of y and the least significant bit of y, respectively.

TABLE 3
Homomorphic Operations for PartSign2

| | Input (log q, | Output (log q, | |
|---|---|---|---|
| Step | log Delta) | log Delta) | Latency |
| Product of c and s_1, | (1287, 119.0) | (692, 119.0) | 12.8 ms |
| Product of c and s_2, | | | |
| and C2S | | | |
| Thrifty Comparison | (530, 42.0) | (414, 23.9) | 107.4 ms |
| Binary Gate 1 | (414, 23.9) | (248, 24.0) | 4.7 ms |
| Bit BTS | (248, 24.0) | (861, 33.0) | 42.1 ms |
| Binary Gate 2 | (857, 29.0) | (542, 28.5) | 21.9 ms |
| Bit Cleaning | (542, 28.5) | (241, 120.5) | 4.6 ms |
| Mask | (241, 120.5) | (103, 84.9) | 5.0 ms |
| Threshold Decryption | (103, 84.9) | — | — |
| Total | — | — | 198.4 ms |

For all steps, a ciphertext modulus q and a scale factor Delta at start and end points of the step are provided in bit units.

Meanwhile, the methods according to the various embodiments of the present disclosure described above may be implemented in the form of an application capable of being installed on a conventional electronic apparatus. Alternatively, the methods according to the various embodiments of the present disclosure described above may be performed using a deep learning-based trained neural network (or deep trained neural network), that is, the learning network model. In addition, the methods according to the various embodiments of the present disclosure described above may be implemented only by software upgrade or hardware upgrade of the conventional electronic apparatus. In addition, the various embodiments of the present disclosure described above may be performed through an embedded server included in the electronic apparatus, or an external server of the electronic apparatus.

Meanwhile, according to an embodiment of the present disclosure, the various embodiments described above may be implemented as software including instructions stored in a machine-readable storage medium (e.g., a computer-readable storage medium). A machine may be a device that calls the stored instructions from the storage medium, may operate according to the called instructions, and may include the electronic apparatus (e.g., electronic apparatus A) according to the disclosed embodiments. When the instructions are executed by the processor, the processor may directly perform a function corresponding to the instructions, or perform the function by using other components under control of the processor. The instructions may include code provided or executed by a compiler or an interpreter. The machine-readable storage medium may be provided in the form of a non-transitory storage medium. Here, the term “non-transitory” merely indicates that the storage medium does not include a signal and is tangible, and does not distinguish whether data is semi-permanently or temporarily stored in the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online through an application store (e.g., PlayStore™). In case of the online distribution, at least a part of the computer program product may be at least temporarily stored or temporarily provided on a storage medium such as the memory of a manufacturer server, an application store server, or a relay server.

In addition, each of the components according to the various embodiments described above (e.g., a module or a program) may include a single object or a plurality of objects, and some sub-components among the above-described corresponding sub-components may be omitted, or other sub-components may further be included in the various embodiments. Alternatively or additionally, some components (e.g., a module or a program) may be integrated into one object and may perform the same or similar functions performed by each corresponding component before integration. Operations performed by a module, a program, or another component according to the various embodiments may be executed in a sequential manner, a parallel manner, an iterative manner or a heuristic manner, or at least some operations may be executed in a different order, may be omitted, or another operation may be added.

Although the embodiments of the present disclosure are illustrated and described above, the present disclosure is not limited to the above-described specific embodiments, and various modifications may be made by those skilled in the art to which the present disclosure pertains without departing from the gist of the present disclosure as claimed in the claims, and the modified embodiments should not be individually understood apart from the spirit or scope of the present disclosure.

What is claimed is:

1. An electronic apparatus comprising:
a communication circuit configured to communicate with at least one external electronic apparatus;
processing circuitry; and
a memory storing instructions, homomorphically encrypted signature key information, and a partial decryption key,
wherein the instructions, when executed individually or collectively by the at least one processor, cause the electronic apparatus to:
acquire a first ciphertext corresponding to a commitment by performing a homomorphic operation using the homomorphically encrypted signature key information based on information related to a message to be signed;
restore the commitment into plaintext based on a first partial decryption result for the first ciphertext generated based on the partial decryption key and first other partial decryption results received from at least some of the at least one external electronic apparatus through the communication circuit;
determine a challenge in a plaintext state based on the restored commitment and the information related to the message;
acquire a second ciphertext corresponding to a response through a homomorphic operation based on the challenge determined in the plaintext state and the homomorphically encrypted signature key information;
restore the response into plaintext based on a second partial decryption result for the second ciphertext generated based on the partial decryption key and second other partial decryption results received from at least some of the at least one external electronic apparatus through the communication circuit; and
generate a signature for the message based on the restored response and the challenge determined in the plaintext state.

2. The apparatus as claimed in claim 1, wherein the homomorphically encrypted signature key information includes a homomorphically encrypted pseudo-random function (PRF) key and a homomorphically encrypted secret vector, and
the instructions, when executed individually or collectively by the at least one processor, cause the electronic apparatus to:
generate a homomorphically encrypted mask through the homomorphic operation based on the homomorphically encrypted PRF key and the information related to the message; and
acquire the first ciphertext corresponding to the commitment based on the homomorphically encrypted mask.

3. The apparatus as claimed in claim 2, wherein the memory further stores a public matrix, and
the instructions, when executed individually or collectively by the at least one processor, cause the electronic apparatus to:
acquire a homomorphically encrypted intermediate value through a homomorphic operation based on the homomorphically encrypted mask and the public matrix; and
acquire the first ciphertext corresponding to the commitment by performing a high-bits extraction operation on the homomorphically encrypted intermediate value.

4. The apparatus as claimed in claim 2, wherein the instructions, when executed individually or collectively by the at least one processor, cause the electronic apparatus to:
perform a homomorphic operation corresponding to a plaintext-ciphertext multiplication between the challenge determined in the plaintext state and the homomorphically encrypted secret vector; and
acquire the second ciphertext corresponding to the response based on a result of the homomorphic operation corresponding to the plaintext-ciphertext multiplication and the homomorphically encrypted mask.

5. The apparatus as claimed in claim 1, wherein the instructions, when executed individually or collectively by the at least one processor, cause the electronic apparatus to:
acquire homomorphically encrypted information corresponding to a plurality of response candidates by performing a plurality of signing attempts in parallel; and
acquire the second ciphertext corresponding to the response based on a response candidate satisfying a predetermined condition among the plurality of response candidates.

6. The apparatus as claimed in claim 1, wherein the instructions, when executed individually or collectively by the at least one processor, cause the electronic apparatus to:
perform an operation corresponding to modular arithmetic by performing a homomorphic operation based on a first homomorphic encryption scheme on the homomorphically encrypted signature key information; and
acquire the first ciphertext corresponding to the commitment by converting a result of the homomorphic operation based on the first homomorphic encryption scheme into a form corresponding to a second homomorphic encryption scheme.

7. The apparatus as claimed in claim 1, wherein the partial decryption key corresponds to one of a plurality of partial decryption keys,
the plurality of partial decryption keys are distributed according to a secret sharing scheme to restore a decryption key for homomorphic encryption based on partial decryption keys equal to or greater than a threshold, and
the instructions, when executed individually or collectively by the at least one processor, cause the electronic apparatus to:
restore the commitment or the response into plaintext based on partial decryption results equal to or greater than the threshold.

8. The apparatus as claimed in claim 1, wherein the instructions, when executed individually or collectively by the at least one processor, cause the electronic apparatus to:
generate at least one of the first partial decryption result and the second partial decryption result based on the partial decryption key and flooding noise.

9. The apparatus as claimed in claim 1, wherein the instructions, when executed individually or collectively by the at least one processor, cause the electronic apparatus to:
determine the information related to the message before acquiring the message; and
acquire the first ciphertext and the first partial decryption result based on the determined information related to the message before acquiring the message.

10. The apparatus as claimed in claim 1, wherein the instructions, when executed individually or collectively by the at least one processor, cause the electronic apparatus to:
transmit the first partial decryption result to at least some of the at least one external electronic apparatus through the communication circuit; and
transmit the second partial decryption result to at least some of the at least one external electronic apparatus through the communication circuit.

11. A method of operating an electronic apparatus, the method comprising:
acquiring a first ciphertext corresponding to a commitment by performing a homomorphic operation using homomorphically encrypted signature key information based on information related to a message to be signed;
restoring the commitment into plaintext based on a first partial decryption result for the first ciphertext generated based on a partial decryption key and first other partial decryption results received from at least some of at least one external electronic apparatus;
determining a challenge in a plaintext state based on the restored commitment and the information related to the message;
acquiring a second ciphertext corresponding to a response through a homomorphic operation based on the challenge determined in the plaintext state and the homomorphically encrypted signature key information;
restoring the response into plaintext based on a second partial decryption result for the second ciphertext generated based on the partial decryption key and second other partial decryption results received from at least some of the at least one external electronic apparatus; and
generating a signature for the message based on the restored response and the challenge determined in the plaintext state.

12. The method as claimed in claim 11, wherein the homomorphically encrypted signature key information includes a homomorphically encrypted pseudo-random function (PRF) key and a homomorphically encrypted secret vector, and
the acquiring of the first ciphertext corresponding to the commitment includes:
generating a homomorphically encrypted mask through the homomorphic operation based on the homomorphically encrypted PRF key and the information related to the message; and
acquiring the first ciphertext corresponding to the commitment based on the homomorphically encrypted mask.

13. The method as claimed in claim 12, wherein the acquiring of the first ciphertext corresponding to the commitment includes:
acquiring a homomorphically encrypted intermediate value through a homomorphic operation based on the homomorphically encrypted mask and a public matrix; and
acquiring the first ciphertext corresponding to the commitment by performing a high-bits extraction operation on the homomorphically encrypted intermediate value.

14. The method as claimed in claim 12, wherein the acquiring of the second ciphertext corresponding to the response includes:
performing a homomorphic operation corresponding to a plaintext-ciphertext multiplication between the challenge determined in the plaintext state and the homomorphically encrypted secret vector; and
acquiring the second ciphertext corresponding to the response based on a result of the homomorphic operation corresponding to the plaintext-ciphertext multiplication and the homomorphically encrypted mask.

15. The method as claimed in claim 11, wherein the acquiring of the second ciphertext corresponding to the response includes:
acquiring homomorphically encrypted information corresponding to a plurality of response candidates by performing a plurality of signing attempts in parallel; and
acquiring the second ciphertext corresponding to the response based on a response candidate satisfying a predetermined condition among the plurality of response candidates.
